(19) United States
(12) Patent Application Publication
(10) Pub. No.: US 2019/0217268 A1
(43) Pub. Date: Jul. 18, 2019

(54) CHEMICAL REACTION DEVICE, AND METHOD FOR PRODUCING SAME

(71) Applicant: NEC Corporation, Tokyo (JP)

(72) Inventor: Hidefumi HIURA, Tokyo (JP)

(73) Assignee: NEC Corporation, Tokyo (JP)

(21) Appl. No.: 16/327,509

(22) PCT Filed: Aug. 23, 2017
(86) PCT No.: PCT/JP2017/030028

§ 371 Date: Feb. 22, 2019

(30) Foreign Application Priority Data
Aug. 26, 2016 (JP) 2016-165849

(51) Int. Cl. B01J 19/08; C03C 17/00; C03B 23/047

(52) U.S. Cl. CPC B01J 19/087; C03C 17/003; C03B 23/047; B01J 2219/0869; B01J 2219/0803; B01J 2219/0877; B01J 2219/00018

(57) ABSTRACT

Provided are a chemical reaction device able to promote a chemical reaction, and a method for producing same. The chemical reaction device has an optical electric field confinement/chemical reaction container structure obtained by integrating an optical electric field confinement structure for forming an optical mode having a frequency identical to or close to a vibrational mode of a chemical substance involved in a chemical reaction, and a chemical reaction container structure having a space for storing a fluid required for the chemical reaction and containing the chemical reaction, the optical mode and the vibrational mode being vibrationally coupled to promote the chemical reaction.

### CROSS REFERENCE TO RELATED APPLICATIONS

This application is a National Stage of International Application No. PCT/JP2017/030028 filed Aug. 23, 2017, claiming priority based on Japanese Patent Application No. 2016-165849 filed Aug. 26, 2016, the disclosures of which are incorporated herein in their entirety by reference.

### TECHNICAL FIELD

The present invention relates to a device and a system that promote a chemical reaction, and a method for producing the device and the system, and relates particularly to a device and a system that are capable of improving a reaction rate, and a method for producing the device and the system.

### BACKGROUND ART

Every chemical material is composed through a chemical bond, and another material is newly produced by cleavage and formation of a bond, that is, a chemical reaction, and then processed. Rate of a chemical reaction is governed by activation energy, and as a background art, there are only two means capable of increasing a reaction rate: inputting heat overcoming activation energy and using a catalyst reducing activation energy by changing a reaction path. However, heat input increases an energy cost, and also inadvertent heating generates some unnecessary and hazardous by-products, and therefore there is a limit to use of this means. Further, use of a catalyst requires rare metals and expensive chemical and also in most cases, a specific catalyst is effective only to a specific chemical reaction and therefore there is an issue in terms of versatility. Accordingly, in view of realization of a sustainable growth society in the future, a new means promoting a chemical reaction is sought.

As a new method of controlling a chemical reaction, for example, Patent Literature 1 (PTL1) discloses a method of using a coupling between an electromagnetic wave and a matter. Specifically, the method mainly includes a process of bringing a reflective or photonic structure including an electromagnetic mode resonant with a transition in a molecule, a biomolecule, or a material, and a process of arranging the molecule, biomolecule, or the material inside or on the aforementioned type of structure, the method further including controlling a chemical reaction by affecting at least one of criteria or parameters of the reaction (reactivity of a material to be involved in the reaction, kinetics of the reaction, a rate and/or a yield of the reaction, and thermodynamics of the reaction) through use of coupling of the molecule, the biomolecule, or the material with a local electromagnetic-vacuum field, and then resulting rearrangement of an energy level of the molecule, the biomolecule, or the material.

### CITATION LIST

### Patent Literature

[PTL1] Japanese Translation of PCT International Application Publication No. 2014-513304

### SUMMARY OF INVENTION

### Technical Problem

However, the aforementioned method of controlling a chemical reaction has an issue as follows.

As described above, the issue with the background art is that there are only two means available for promoting a chemical reaction, the means wastefully using a large amount of energy in order to overcome activation energy and consuming scarce resources by using a catalyst decreasing activation energy by changing a reaction path. The reason is that, within a framework of a chemical reaction theory in the background art, a means of quantitatively reducing magnitude of activation energy is not known, and therefore the two means are selected as a logical conclusion under the present conditions.

On the other hand, aforementioned PTL1 discloses a method of using a coupling between an electromagnetic wave and a matter as a means of overcoming the issue with the background art. However, PTL1 does not indicate a theory of connecting a physical phenomenon being a coupling between an electromagnetic wave and a matter to a chemical phenomenon being a reaction, and therefore it is impossible to quantitatively evaluate an effect of a coupling between an electromagnetic wave and a matter on a chemical reaction. Accordingly, a degree of an effect of a coupling between an electromagnetic wave and a matter when being actually used in a chemical reaction is totally unknown, and it is even unknown whether the coupling promotes or suppresses the reaction. Consequently, it is impossible to design a specific device, and therefore an industrial use is hindered.

An object of the present invention is to provide a chemical reaction device capable of promoting a chemical reaction, and a method for producing the device.

### Solution to Problem

To achieve the above-mentioned object, a chemical reaction device according to the present invention comprises an opto-electrical field confinement chemical reaction container structure integrating an opto-electrical field confinement structure forming an optical mode having a frequency identical to or close to a vibrational mode of a chemical material related to a chemical reaction with a chemical reaction container structure including a space for storing fluid required for the chemical reaction including the chemical material, wherein

a chemical reaction is promoted by vibrationally coupling the optical mode with the vibrational mode.

A method for producing a chemical reaction device comprises:

producing a structure including a mirror plane/substrate by fort a mirror plane on a substrate;

producing a structure including a protective film/mirror plane/substrate by forming a protective film on the mirror plane;

producing a structure including a spacer/protective film/mirror plane/substrate by arranging a spacer defining a cavity length on the protective film;

producing a Fabry-Pérot cavity structure including a substrate/mirror plane/protective film/spacer/protective filet/mirror plane/substrate by laying a structure including the protective film/mirror plane/substrate on top of a structure including the spacer/protective film/mirror plane/substrate; and

producing the chemical reaction device by housing the Fabry-Pérot cavity structure in an enclosure including an inlet, an outlet, and a chamber for storing the Fabry-Pérot cavity structure.

### Advantageous Effect of Invention

The present invention can promote a chemical reaction by reducing activation energy of the aforementioned chemical reaction.

### BRIEF DESCRIPTION OF DRAWINGS

FIG. 1 (A) and (B) in FIG. 1 are schematic diagrams illustrating an interaction between light and matter.

FIG. 2 (A) and (B) in FIG. 2 are schematic diagrams illustrating a relation between vibration of a matter and a chemical reaction.

FIG. 3 (A) and (B) in FIG. 3 are schematic diagrams illustrating a principle of reducing activation energy by a vibrational coupling.

FIG. 4 (A) to (D) in FIG. 4 are diagrams quantitatively illustrating promotion of a chemical reaction by a vibrational coupling.

FIG. 5 (A) to (C) in FIG. 5 are schematic diagrams illustrating a relation between a cavity and an optical mode.

FIG. 6 (A) and (B) in FIG. 6 are diagrams quantitatively illustrating a decay length and a propagating length of an optical mode.

FIG. 7 (A) and (B) in FIG. 7 are schematic diagrams of a vibrational coupling chemical reaction device according to an example embodiment of the present invention.

FIG. 8 (A) to (C) in FIG. 8 are cross-sectional views of vibrational coupling chemical reaction devices according to another example embodiment of the present invention.

FIG. 9 (A) to (F) in FIG. 9 are schematic diagrams of vibrational coupling chemical reaction device units and a system composed of the units, according to the example embodiment of the present invention.

FIG. 10 (A) to (E) in FIG. 10 are schematic diagrams illustrating processes of a method for producing the vibrational coupling chemical reaction device according to the example embodiment of the present invention.

FIG. 11 (A) to (G) in FIG. 11 are cross-sectional views illustrating processes of a method for producing the vibrational coupling chemical reaction device according to the other example embodiment of the present invention.

FIG. 12 (A) to (I) in FIG. 12 are diagrams quantitatively illustrating temperature dependence of a relation between activation energy and a coupling strength.

FIG. 13 (A) to (I) in FIG. 13 are diagrams quantitatively to illustrating activation energy dependence of a relation between temperature and a coupling strength.

FIG. 14 (A) to (I) in FIG. 14 are diagrams quantitatively illustrating coupling strength dependence of a relation between activation energy and temperature.

FIG. 15 (A) to (D) in FIG. 15 are diagrams illustrating infrared absorption spectra demonstrating a vibrational coupling between an optical mode and a vibrational mode.

FIG. 16 (A) and (B) in FIG. 16 are diagrams illustrating concentration dependence of a coupling strength acquired from experiments.

FIG. 17 is a diagram quantitatively illustrating a relation between a relative reaction rate constant and a relative concentration.

FIG. 18 (A) and (B) in FIG. 18 are diagrams illustrating optical mode number dependence of a coupling strength acquired from experiments.

FIG. 19 (A) to (C) in FIG. 19 are diagrams demonstrating production of a chemical material by use of the vibrational coupling chemical reaction device according to the example embodiment of the present invention (in a case of a reaction between [triphenylphosphoranylidene] ketene and acetone).

FIG. 20 (A) to (C) in FIG. 20 are diagrams demonstrating production of a chemical material by use of the vibrational coupling chemical reaction device according to the example embodiment of the present invention (a case of a reaction between phenyl isocyanate and methanol).

FIG. 21 (A) to (C) in FIG. 21 are diagrams demonstrating production of a chemical material by use of the vibrational coupling chemical reaction device according to the example embodiment of the present invention (in a case of a reaction between [triphenylphosphoranylidene] ketene and carbon disulfide).

FIG. 22 (A) to (C) in FIG. 22 are diagrams demonstrating production of a chemical material by use of the vibrational coupling chemical reaction device according to the example embodiment of the present invention (a case of a reaction between [triphenylphosphoranylidene] ketene and methanol).

### EXAMPLE EMBODIMENT

Before describing specific example embodiments and examples of the present invention, the present invention will be surveyed.

A device as an example of the present invention is a chemical reaction device including

an opto-electrical field confinement chemical reaction container structure integrating

an opto-electrical field confinement structure forming an optical mode having a frequency identical to or close to a vibrational mode of a chemical material related to a chemical reaction with

a chemical reaction container structure including a space for storing; fluid required for the chemical reaction including the chemical material, wherein

the chemical reaction is promoted by causing a vibrational coupling between the optical mode and the vibrational mode and reducing activation energy of the chemical reaction.

A method for producing a chemical reaction device as an example of the present invention includes:

a process of producing a structure including a mirror plane/substrate by forming a mirror plane on a substrate;

a process of producing a structure including a protective film/mirror plane/substrate by forming a protective film on the mirror plane;

a process of producing a structure including a spacer/protective film/mirror plane/substrate by arranging a spacer defining a cavity length on the protective film; and

a process of producing a structure including a substrate/mirror plane/protective film/spacer/protective film/mirror plane/substrate by laying the structure including the protective film/mirror plane/substrate on top of the structure including the spacer/protective film/mirror plane/substrate.

Another method for producing a chemical reaction device as an example of the present invention includes;

a process of producing an acid-soluble-glass-filled glass tube by filling acid-soluble glass into a glass tube,

a process of producing a thinned acid-soluble-glass-filled glass tube by drawing the acid-soluble-glass-filled glass tube in a tube-axis direction by heating;

a process of producing a thinned acid-soluble-glass-filled glass tube accumulation by aligning one or more of the thinned acid-soluble-glass-filled glass tubes in such a way that tube axes are parallel to one another, and fusion-bonding the glass tubes by heating;

a process of producing a re-thinned acid-soluble-glass-filled glass tube accumulation by drawing the thinned acid-soluble-glass-filled glass tube accumulation in a tube-axis direction by heating, and applying pressure in a direction perpendicular to the tube axis as needed;

a process of producing a re-thinned glass tube accumulation by causing the acid-soluble glass to dissolve from the re-thinned acid-soluble-glass-filled glass tube accumulation by acid;

a process of producing a linear cavity accumulation by forming a mirror plane inside each re-thinned glass tube constituting the re-thinned glass tube accumulation, and forming a protective film on the mirror plane as needed; and

a process of producing a chemical reaction device by housing the linear cavity aggregate in an enclosure including an inlet, an outlet, and a chamber for storing the linear cavity aggregate.

The aforementioned chemical reaction device and methods for producing a chemical reaction device as examples of the present invention bring the following effects.

The first advantageous effect is that, by vibrationally coupling an optical mode formed by an opto-electrical field confinement structure with a vibrational mode of a chemical material related to a chemical reaction, the vibrational energy of the chemical material can be decreased and the activation energy of the chemical reaction can be reduced, and therefore a chemical reaction device enabling remarkable promotion of a chemical reaction can be provided.

The second advantageous effect is that, by using a vibrational coupling as a means of decreasing activation energy, a chemical reaction device enabling promotion of every type of chemical reaction, independent of chemical properties of materials that make up the device, can be provided.

The third advantageous effect is that, by using vibrational coupling as a means of decreasing activation energy, a chemical reaction device enabling a chemical reaction requiring a reaction temperature of 1000° C. to be performed at room temperature can be provided.

The fourth advantageous effect is that, by using vibrational coupling as a means of decreasing activation energy, a chemical reaction device enabling tremendous acceleration of a reaction rate by a million times with activation energy of 0.5 eV and by a trillion times with activation energy of 1.0 eV can be provided.

The fifth advantageous effect is that, by using a vibrational coupling as a means of decreasing activation energy, a chemical reaction device enabling a catalytic effect to be maintained up to the submillimeter order being a distance longer than that by a normal catalyst by a million times can be provided.

As the sixth advantageous effect, by modularizing, unitizing, and systematizing a device, taking advantage of a characteristic of a vibrational coupling being dependent only on a structure, a chemical reaction device useful for greatly reducing production/processing costs and greatly improving productivity can be provided.

An example embodiment of the present invention will be discussed in detail below with reference to drawings.

### EXAMPLE EMBODIMENT

In this section, an example embodiment of the present invention will be discussed.

### [Configuration of Example Embodiment]

The example embodiment of the present invention will be described in sequence from a principle of the invention to materialization of the invention in three Items (1) to (3) discussed below:

(1) a process of quantifying a chemical reaction using a vibrational coupling,
(2) a process of materializing a structure satisfying a requirement necessary for a vibrational coupling, and
(3) a process of materializing a vibrational coupling chemical reaction device, and producing and processing a desired chemical material.

[(1) Process of Quantifying Chemical Reaction Using Vibrational Coupling]

First, with regard to Item (1), skillful fusion of a quantum-mechanical phenomenon being a vibrational coupling and a physicochemical phenomenon being a chemical reaction enables tremendous scientific and technical progress that nearly every type of chemical reaction can be phenomenally promoted, and analytical and quantitative evaluation of promotion of a chemical reaction by a vibrational coupling will be discussed according to Items (1)-A, (1)-B, and (1)-C described below:

(1)-A: interaction between light and matter,
(1)-B: a method of describing a general chemical reaction by an equation, and
(1)-C: a method of deriving an equation quantitatively describing a reaction rate constant under a vibrational coupling.

[(1)-A: Interaction Between Light and Matter]

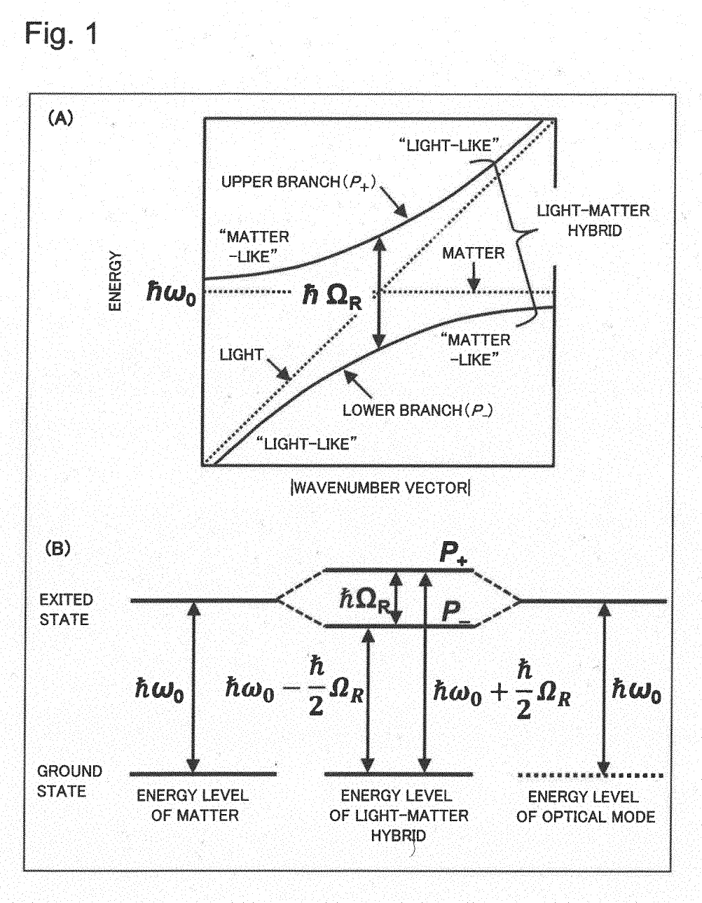

With regard to Item (1)-A, interaction between light and matter will be discussed. When a matter is placed in a structure in which a local opto-electrical field can exist, such as a cavity or a surface plasmon-polariton structure, light and the matter start to have a new dispersion relation with respect to energy/momentum, as illustrated in (A) in FIG. 1. This applies to every matter, independent of a phase such as a gas phase, a liquid phase, or a solid phase. The new dispersion constitutes curves composed of an upper branch (P₊) and a lower branch (P₋) anticrossing optical dispersion (a steadily increasing straight line) and dispersion of the matter (a horizontal straight line). In other words, when an electric field of light is confined in a local space with a matter, light and the matter are intermixed and move back and forth between an upper branch state and a lower branch state at a Rabi angular frequency Ω_{R}. This state is referred to as a light-matter hybrid and is a macroscopic coherent state. As illustrated in (A) in FIG. 1, a matter and light are mixed hybridized in any ratio in a light-matter hybrid depending on an energy/momentum dispersion relation: “matter-like” in a region close to the matter dispersion, “light-like” in a region close to the light dispersion, and exactly half each at an intersection of the both types of dispersion. An energy difference between the upper branch state and the lower branch state is referred to as Rabi splitting energy

ℏΩ_{R} [Math. 1]

and is proportional to a strength of interaction between light and matter. Note that

ℏ [Math. 2]

is the Dirac constant acquired by dividing the Planck constant h by 2π. For convenience of expression, the Rabi splitting energy may be hereinafter described as hΩ_{R}. (B) in FIG. 1 illustrates an energy level diagram of the aforementioned light-matter hybrid. Transition energy between a ground state and an excited state of the matter matches energy of an optical mode, that is, in a resonance state, the excited state of the matter-like Rabi-splits into two states with a splitting width being

ℏΩ_{R} [Math. 3]

and energy of the states being

ℏω₀−½·ℏΩ_{R} [Math. 4]

and

ℏω₀+½·ℏΩ_{R} [Math. 5]

According to a JaynesCummings model rotating-wave-approximating the aforementioned Rabi model, Rabi splitting energy hΩ_{R} is expressed by Equation 1.

$$[ Math . 6 ]$$

$${ℏΩ}_{R} = 2 \sqrt{N} Ed = 2 \sqrt{N} \sqrt{\frac{{ℏω}_{0}}{2 {ɛ}_{0} V}} d \sqrt{{n}_{ph} + 1} \qquad ( Equation 1 )$$

where, as described above,

ℏ [Math. 7]

denotes the Dirac constant (acquired by dividing the Planck constant h by 2π), and Ω_{R} denotes a Rabi angular frequency, N denotes a number of the matter, E denotes an amplitude of the electric field of light, d denotes a transition dipole moment of the matter, nₚₕ denotes a number of photons, ω₀ denotes an angular frequency of a matter transition, ε₀ denotes a vacuum dielectric constant, and V denotes a mode volume. The mode volume V approximately has magnitude of a cube of a light wavelength. Important physical conclusions implied by Equation 1 are listed as (1) to (3) below.

(1) Rabi splitting energy hΩ_{R} is proportional to the square root of the number of the matter N. In other words, unlike a normal physical quantity, Rabi splitting energy hΩ_{R} is dependent on N and increases as N increases. The dependence on the square root of N is derived from interaction between light and a matter being a macroscopic coherent phenomenon.

(2) Rabi splitting energy hΩ_{R} is proportional to the product of an amplitude of the electric field of light E and a transition dipole moment d. In other words, interaction between light and matter increases as a structure has a stronger degree of opto-electrical field confinement, and as the matter has a stronger degree of light absorption.

(3) Rabi splitting energy hΩ_{R} has a finite value even when a number of photons nₚₕ is zero. In other words, a light-matter hybrid exists even in a dark state in which light does not exist at all. The light-matter interaction is derived from being based on quantum fluctuations in a vacuum field. In other words, from a quantum-mechanical view, a photon repeats generation and annihilation in a microscopic space, and a light-matter hybrid can be generated without providing light externally.

A ratio Ω_{R}/ω₀ between Rabi splitting energy hΩ_{R} and transition energy of a matter

ℏω₀ [Math. 8]

is referred to as a coupling strength. A coupling strength Ω_{R}/ω₀ is an indicator representing a degree of how much a transition energy is Rabi-split by light-matter interaction. Further, a coupling strength Ω_{R}/ω₀ is normalized by transition energy of a matter in an original system, and therefore diverse light-matter systems with different energies can be objectively compared. Roughly speaking, a case of a coupling strength Ω_{R}/ω₀ being less than 0.01 is referred to as a weak coupling (Equation 2), a case of a coupling strength being greater than or equal to 0.01 and less than 0.1 is referred to as a strong coupling (Equation 3), a case of a coupling strength being greater than or equal to 0.1 and less than 1 is referred to as an ultra strong coupling (Equation 4), and a case of a coupling strength exceeding 1 is referred to as a deep strong coupling (Equation 5). An observed value of a coupling strength reported to date is 0.73. In other words, a deep strong coupling exists only theoretically under the present conditions, and an actual system includes up to an ultra strong coupling.

$$[ Math . 9 ]$$

$$( Weak coupling condition )$$

$$\begin{matrix}\frac{{Ω}_{R}}{{ω}_{0}} < 0.01 \\ [ Math . 10 ] \\ ( Strong coupling condition ) & ( Equation 2 ) \\ 0.01 \leq \frac{{Ω}_{R}}{{ω}_{0}} < 0.1 \\ [ Math . 11 ] \\ ( Ultra strong coupling condition ) & ( Equation 3 ) \\ 0.1 \leq \frac{{Ω}_{R}}{{ω}_{0}} \leq 1 \\ [ Math . 12 ] \\ ( Deep strong coupling condition ) & ( Equation 4 ) \\ 1 < \frac{{Ω}_{R}}{{ω}_{0}} & ( Equation 5 )\end{matrix}$$

[(1)-B: Method of Describing General Chemical Reaction by Equation]

With regard to Item (1)-B, a general chemical reaction will be discussed. In brief, a chemical reaction is cleavage and formation of a chemical bond. For example, a chemical reaction by which a molecule AB is cleaved and a molecule BC is newly generated, where A, B, and C denote atoms, is expressed by Equation 6 below.

AB+C→A+BC (Equation 6)

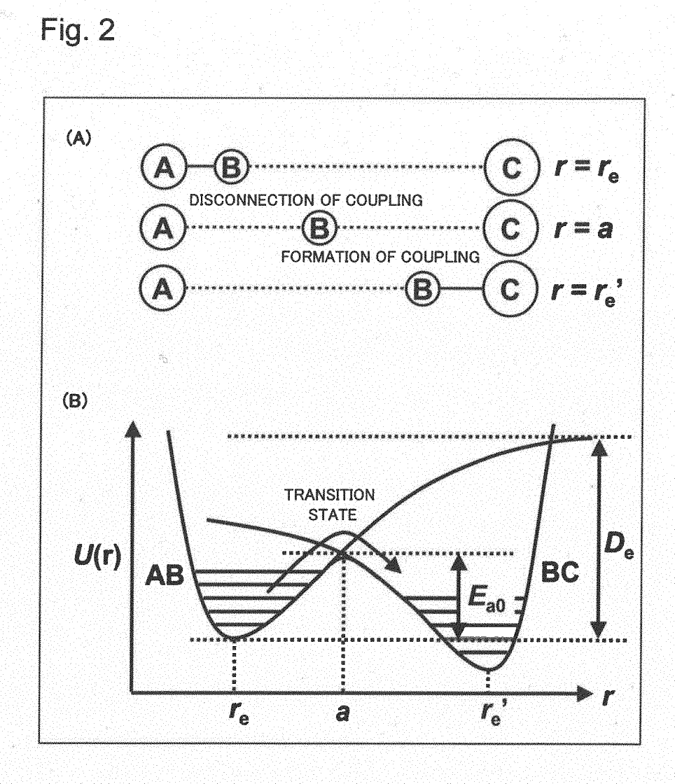

(A) in FIG. 2 schematically illustrates Equation 6 as a molecular motion, and (B) in FIG. 2 illustrates Equation 6 as a reaction potential being an overlap of vibration potentials U(r) of the molecule AB and the molecule BC. Describing FIG. 2 in detail, the atom A and the atom B are bonded through a certain chemical bond to form the molecule AB, and the molecule AB performs molecular vibration with an interatomic distance r in the neighborhood of an equilibrium internuclear distance rₑ. Activation energy Eₐ₀ of a forward reaction of the system is defined by Equation 7 below as a difference between potential energy U(a) at an interatomic distance a in a transition state and potential energy U(rₑ) at the equilibrium internuclear distance rₑ, in a vibration potential of the molecule AB. When a vibration potential U(r) of the molecule AB is defined to be zero when an interatomic distance r is infinite, −U(rₑ) is equivalent to a dissociation energy Dₑ (constant) of the molecule AB. Accordingly, the following holds.

Eₐ₀=U(a)−U(rₑ)=U(a)+Dₑ (Equation 7)

When thermal energy sufficiently matching the activation energy Eₐ₀ is applied, classically, the molecule AB increases an amplitude of the molecular vibration, and quantum-mechanically, it jumps up the vibrational energy levels accompanying the reaction potential AB in a step-by-step manner. Consequently, the chemical bond of the molecule AB is cleaved, followed by the movement to a reaction potential BC passing through a transition state located at an internuclear distance r=a, and a bond is newly generated between the atom B and the atom C. Through the series of processes, the chemical reaction in Equation 6 is completed. Vibration energy Eᵥ of a molecule is described by Equation 8 below.

$$[ Math . 13 ]$$

$${E}_{v} = ( v + \frac{1}{2} ) ℏω = ( v + \frac{1}{2} ) ℏ \sqrt{\frac{κ}{m}} \qquad ( Equation 8 )$$

Note that v denotes a vibrational quantum number,

ℏ [Math. 14]

denotes the aforementioned Dirac constant, ω denotes an angular frequency, k denotes a force constant, and at denotes a reduced mass. A force constant k is also referred to as a spring constant and is an indicator of a strength of a chemical bond. Specifically, when a value of a force constant k is small, vibrational energy Eᵥ is small and a chemical bond is weak. On the contrary, when a value of a force constant k is large, vibrational energy Eᵥ is large and a bond is strong. In addition, under harmonic oscillator approximation, a force constant k is a second differential coefficient at r=rₑ in a vibration potential. Accordingly, a bottom of a vibration potential U(r) becomes shallow when a value of a force constant k is small, and the bottom becomes deep when the force constant k is large.

Next, we will show that the activation energy Eₐ₀ can be expressed as a function of a force constant k as follows: as indicated by Equation 7, the activation energy Eₐ₀ is a function of U(a). When U(a) undergoes a Taylor expansion around rₑ, Equation 9 below is acquired.

$$[ Math . 15 ]$$

$$\begin{matrix}U ( a ) = & U ( {r}_{e} ) + {U}^{( 1 )} ( {r}_{e} ) ( a - {r}_{e} ) + \\ & \frac{{U}^{( 2 )} ( {r}_{e} )}{2 !} {( a - {r}_{e} )}^{2} + \frac{{U}^{( 3 )} ( {r}_{e} )}{3 !} {( a - {r}_{e} )}^{3} + ⋯ \\ = & - {D}_{e} + \frac{1}{2} {k ( a - {r}_{e} )}^{2} + \\ & \frac{{U}^{( 3 )} ( {r}_{e} )}{3 !} {( a - {r}_{e} )}^{3} + ⋯\end{matrix} \qquad ( Equation 9 )$$

where U⁽ⁿ⁾(r) denotes an n-th derivative of U(r). Note that the above modification of Equation 9 uses the following three facts: first, −U(rₑ) is equivalent to dissociation energy Dₑ, as described above, and therefore U(rₑ)=−Dₑ. Second, the first derivative of a vibration potential is force and a value thereof is zero at the equilibrium internuclear distance rₑ and therefore U⁽¹⁾(rₑ)=0. Third, the second derivative of the vibration potential at the equilibrium internuclear distance rₑ is the force constant k, as described above. Combining Equation 7 with Equation 9 and neglecting the third-order term and beyond by harmonic oscillator approximation yields Equation 10 below.

$$[ Math . 16 ]$$

$${E}_{a 0} = \frac{1}{2} {k ( a - {r}_{e} )}^{2} \qquad ( Equation 10 )$$

In general, a force constant k is determined by an electronic state of a molecule and therefore is a constant inherent to the molecule and cannot be changed once an elementary composition and a structure are determined. Further, once an electronic state is determined, both an interatomic distance in a transition state a and an equilibrium internuclear distance rₑ are also constant. Accordingly, activation energy Eₐ₀ cannot be changed unless a reaction potential or a vibration potential being a component thereof is changed. However, as will be discussed in the next item, the force constant may be decreased by using a vibrational coupling being a kind of interaction between light and matter. Thus, the vibrational coupling can reduce the activation energy Eₐ₀ according to the relation in Equation 10.

[(1)-C: Method of Deriving Equation Quantitatively Describing Reaction Rate Constant Under Vibrational Coupling]

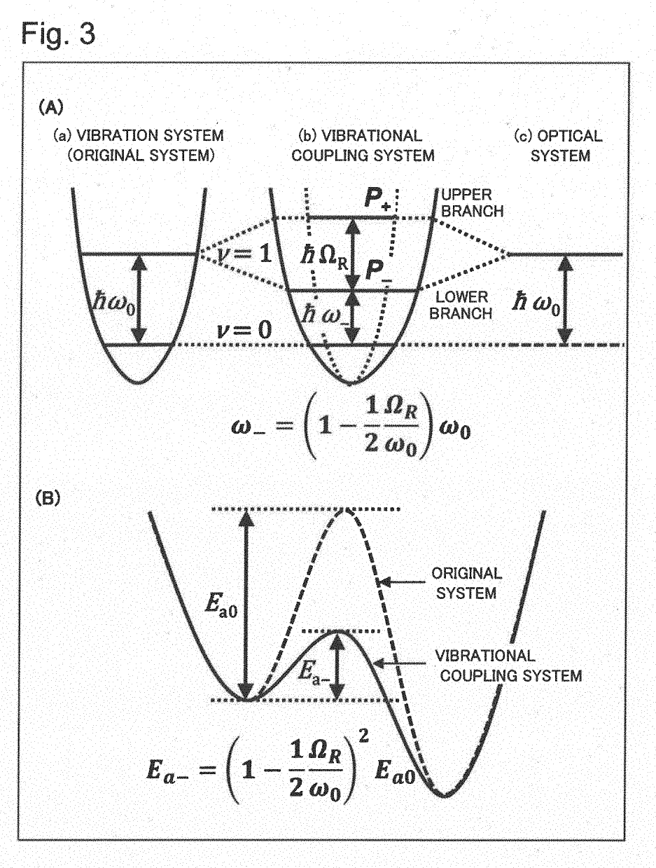

With regard to Item (1)-C, a vibrational coupling and chemical reaction promotion by a vibrational coupling will be discussed. A vibrational coupling is a kind of the aforementioned interaction between light and matter and refers to a phenomenon of an optical mode formed by a cavity capable of confining an electromagnetic wave in an infrared region (wavelength: 1 to 100 μm) or a surface plasmon-polariton structure being coupled with a vibrational mode of a chemical material such as a molecule or a crystal. In (A) in FIG. 3, (a) illustrates an energy level (a harmonic oscillator approximation) of a vibration system (original system), (b) illustrates an energy level (harmonic oscillator approximation) of a vibrational coupling system, and (c) illustrates an energy level of an optical system. Vibration energy of the vibration system (a) and energy of the optical system (c) match at

ℏω₀ [Math. 17]

In other words, when the vibration system (a) resonates with the optical system (c) at an angular frequency ω₀, a vibrational coupling system (b) in which light (the optical system) and matter (the vibration system) are mixed is generated. In the vibrational coupling system (b), a vibrational level v=0 is equivalent to that in the vibration system being an original system; however, a vibrational level v=1 splits into energy levels being an upper branch and a lower branch.

Next, vibrational energy of the vibrational coupling system will be determined. By use of vibrational energy of the vibration system being an original system

ℏω₀ [Math. 18]

and Rabi splitting energy hΩ_{R}, vibrational energy of the lower branch of the vibrational coupling system is expressed by Equation 11a below.

$$[ Math . 19 ]$$

$${ℏω}_{-} = ( 1 - \frac{1}{2} \frac{{Ω}_{R}}{{ω}_{0}} ) {ℏω}_{0} \qquad ( Equation 11 a )$$

In a similar manner, vibrational energy of the upper branch is expressed by

$$[ Math . 20 ]$$

$${ℏω}_{+} = ( 1 + \frac{1}{2} \frac{{Ω}_{R}}{{ω}_{0}} ) {ℏω}_{0} , \qquad ( Equation 11 b )$$

however, as will be discussed later, a vibrational level of the upper branch of the vibrational coupling system does not contribute to promotion of a chemical reaction and therefore is not hereinafter mentioned. As indicated by Equation 11a, the vibrational energy of the vibrational coupling system decreases from the vibrational energy of the original system

$$[ Math . 21 ]$$

$${ℏω}_{0} \\ [ Math . 22 ]$$

$$by$$

$$\frac{1}{2} \frac{{Ω}_{R}}{{ω}_{0}} {ℏω}_{0} .$$

As indicated in (b) in (A) in FIG. 3, the above corresponds to a bottom of the vibration potential of the vibrational coupling system being shallower than that of the original system. Recollecting that the second derivative of the very bottom of the vibration potential is a force constant, it is understood that a force constant k₋ of the vibrational coupling system is smaller than a force constant k₀ of the original system. The above can be quantitatively expressed as Equation 12 below by use of Equations 8 and 11a.

$$[ Math . 23 ]$$

$${k}_{-} = {( 1 - \frac{1}{2} \frac{{Ω}_{R}}{{ω}_{0}} )}^{2} {k}_{0} \qquad ( Equation 12 )$$

Next, activation energy of the vibrational coupling system will be determined. When activation energy of the original system is denoted as Eₐ₀, activation energy of the vibrational coupling system is denoted as Eₐ₋, Equation 13 below is acquired from Equation 10 and Equation 12.

$$[ Math . 24 ]$$

$${E}_{a -} = {( 1 - \frac{1}{2} \frac{{Ω}_{R}}{{ω}_{0}} )}^{2} {E}_{a 0} \qquad ( Equation 13 )$$

Note that, in Equation 13, we used an approximation that a difference between an equilibrium internuclear distance and an interatomic distance in the transition state is nearly the same between the original system and the vibrational coupling system. Referring to (B) in FIG. 3, Equation 13 clearly states that activation energy is reduced in the vibrational coupling system compared with the original system. For example, activation energy decreases by approximately 1 to 10% in the strong coupling condition expressed by Equation 3 and by approximately 10 to 75% in the ultra strong coupling condition expressed by Equation 4. In other words, it is anticipated that substantial promotion of a chemical reaction can be acquired by use of a vibrational strong coupling or further a vibrational ultra strong coupling.

As a supplement to this section, the reason for existence of the upper branch of the vibrational coupling system being neglected in the discussion will be discussed. Referring to Equation 13, activation energy Eₐ₊ corresponding to vibrational energy of the upper branch becomes

$$[ Math . 25 ]$$

$${E}_{a +} = {( 1 + \frac{1}{2} \frac{{Ω}_{R}}{{ω}_{0}} )}^{2} {E}_{a 0}$$

The activation energy Eₐ₊ of the upper branch is greater than the activation energy Eₐ₀ of the original system, and therefore remaining at the upper branch level slows a reaction compared with the original system. However, a vibrational state of a reactant molecule actually transitions back and forth between the upper branch and the lower branch Ω_{R} times per second (typically 10⁶ to 10⁷ times) in the vibrational coupling system, which is sufficiently faster than a typical reaction rate. In other words, even though the vibrational state hangs around the upper branch level with relatively high activation energy at a certain moment and thereby a reaction is not likely to occur, the vibration state can transition to the lower branch with relatively low activation energy at the next moment, therefore, a reaction is likely to occur. Accordingly, it is concluded that existence of the upper branch can be neglected in considering a chemical reaction in the vibrational coupling system.

Next, a chemical reaction promoting action by a vibrational coupling will be quantitatively evaluated by use of a ratio of a reaction rate constant between the vibrational coupling system and the original system, that is, a relative reaction rate constant. A reaction rate constant is a physical quantity easier to measure compared with activation energy and is also highly practical. Further, as will be discussed later, an expression by a relative reaction rate constant provides various implications in using a vibrational coupling in chemical reaction promotion.

Assuming that, for example, the reaction indicated in Equation 6 is a first-order reaction with respect to the molecule AB and the atom C, respectively, a reaction rate formula of a chemical reaction can be discussed by Equation 14 below.

R=κ[AB][C] (Equation 14)

where R denotes a reaction rate, κ (kappa) denotes a reaction rate constant, [AB] and [C] denote concentrations of the molecule AB and the atom C, respectively. One hand, a reaction rate is defined as a change in a concentration per unit time and has a dimension of concentration/time. On the other hand, the unit of a reaction rate constant varies by an order of reaction, and when second (s) is taken as the unit of time and molarity (M where M=mol·L⁻¹, L: liter) is taken as the unit of a concentration, for example, the unit of a zero-order reaction is M·s⁻¹ having the same dimension as a reaction rate, the unit of a first-order reaction is s⁻¹, and the unit of a second-order reaction is M⁻¹·s⁻¹. A reaction rate constant is expressed by Equation 15 below as a function of a frequency factor A, activation energy Eₐ₀, and temperature T.

$$[ Math . 26 ]$$

$$κ = A exp ( - \frac{{E}_{a 0}}{{k}_{B} T} ) \qquad ( Equation 15 )$$

where k_{B} denotes the Boltzmann constant. Equation 15 is an empirical formula known as the Arrhenius equation. On the other hand, Equation 16 below is the Eyring equation being one of theoretical formulae deduced from the transition state theory.

$$[ Math . 27 ]$$

$$κ = ( \frac{a}{{r}_{e}} ) \frac{ω}{2 π} exp ( - \frac{{E}_{a 0}}{{k}_{B} T} ) \qquad ( Equation 16 )$$

While the Eyring equation has various expressions, an equation used in a most basic chemical reaction (a dissociation reaction) is used here. Note that a denotes an interatomic distance in the aforementioned transition state, and similarly, r denotes the aforementioned equilibrium internuclear distance. Next, a ratio between a reaction rate constant in the presence of a vibrational coupling and a reaction rate constant in the absence of a vibrational coupling, that is, a relative reaction rate constant, will be determined. First, by substituting Equation 13 indicating activation energy of the vibrational coupling system determined in the previous section into Equations 15 and 16, respectively, equations of a reaction rate constant in the presence of a vibrational coupling is derived, respectively. Next, by respectively determining ratios to the equations of a reaction rate constant expressed by Equations 15 and 16 for the original system, that is, the case in the absence of a vibrational coupling, Equations 17 and 18 below being equations of a relative reaction rate constant are finally acquired, respectively.

$$[ Math . 28 ]$$

$$\begin{matrix}( Arrhenius type ) \frac{{κ}_{-}}{{κ}_{0}} = exp [ ( - \frac{{E}_{a 0}}{{k}_{B} T} ) \{ {( 1 - \frac{1}{2} \frac{{Ω}_{R}}{{ω}_{0}} )}^{2} - 1 \} ] & ( Equation 17 ) \\ ( Eyring type ) \frac{{κ}_{-}}{{κ}_{0}} = ( 1 - \frac{1}{2} \frac{{Ω}_{R}}{{ω}_{0}} ) exp [ ( - \frac{{E}_{a 0}}{{k}_{B} T} ) \{ {( 1 - \frac{1}{2} \frac{{Ω}_{R}}{{ω}_{0}} )}^{2} - 1 \} ] & ( Equation 18 )\end{matrix}$$

However, in derivation of Equation 17, because a vibrational coupling does not affect a collision frequency of molecules, it is assumed that a frequency factor A takes an identical value between the case in the presence of a vibrational coupling and the case in the absence of a vibrational coupling. Since a ratio of A to A is one, the term of the frequency factor A disappears in Equation 17. Further, in derivation of Equation 18, it is approximated that a ratio between an interatomic distance in a transition state a and an equilibrium internuclear distance rₑ is nearly identical between the case in the presence of a vibrational coupling and the case in the absence of a vibrational coupling. Since a ratio is determined to be one similarly to the above, the term of ((a/rₑ) in Equation 18 is canceled. It is worthy to note that Equations 17 and 18 are equations derived before anyone else in the world as a result of concentrated examinations by the present inventor and are disclosed for the first time by the present invention.

By the theoretical considerations discussed above, we are not only freed from various physical quantities, such as a frequency factor A, an interatomic distance a in a transition state, and an equilibrium internuclear distance rₑ, all of which are difficult to be experimentally measured or difficult to be theoretically estimated, but also can acquire a simple and clear equation expressing a relative reaction rate constant (a ratio κ₋/κ₀ between a reaction rate constant of an original system and a reaction rate constant of a vibrational coupling system) with merely three physical quantities as parameters, that is, activation energy Eₐ₀ and temperature T being experimentally and theoretically familiar physical quantities, and a coupling strength Ω_{R}/ω₀ being the most important indicator of a vibrational coupling. By derivation of Equations 17 and 18, an effect of a vibrational coupling on a chemical reaction can be quantitatively evaluated. In other words, for example, when a vibrational coupling is applied to a chemical reaction, a degree of reaction promotion expected in the target chemical reaction, an effect of temperature, effectiveness of magnitude of activation energy, a type of chemical reaction advantageous to a vibrational coupling, and the like can be previously predicted as objective numerical values. A further advantage of Equations 17 and 18 is that the equations are applicable regardless of a type of chemical reaction. For example, Equations 17 and 18 hold regardless of a phase, such as a gas phase, a liquid phase, or a solid phase, in which a chemical reaction occurs. The reason is that Equations 17 and 18 do not include a parameter limiting a phase. Further, reaction promotion by a vibrational coupling can be accurately evaluated by use of Equations 17 and 18 with respect to a chemical reaction with any order including a first-order reaction, a second-order reaction, a third-order reaction, and any other reaction with a complicated order such as a 1.5-th reaction. The versatility is derived from employment of a relative reaction rate constant κ₋/κ₀ being a ratio between reaction rate constants of an original system and a vibrational coupling system in the expressions in Equations 17 and 18; and since κ₋/κ₀ is an abstract number, any reaction can be quantitatively analyzed regardless of a unit. From the above, it can be concluded that Equations 17 and 18 are an exceptionally powerful weapon in designing a chemical reaction device using a vibrational coupling.

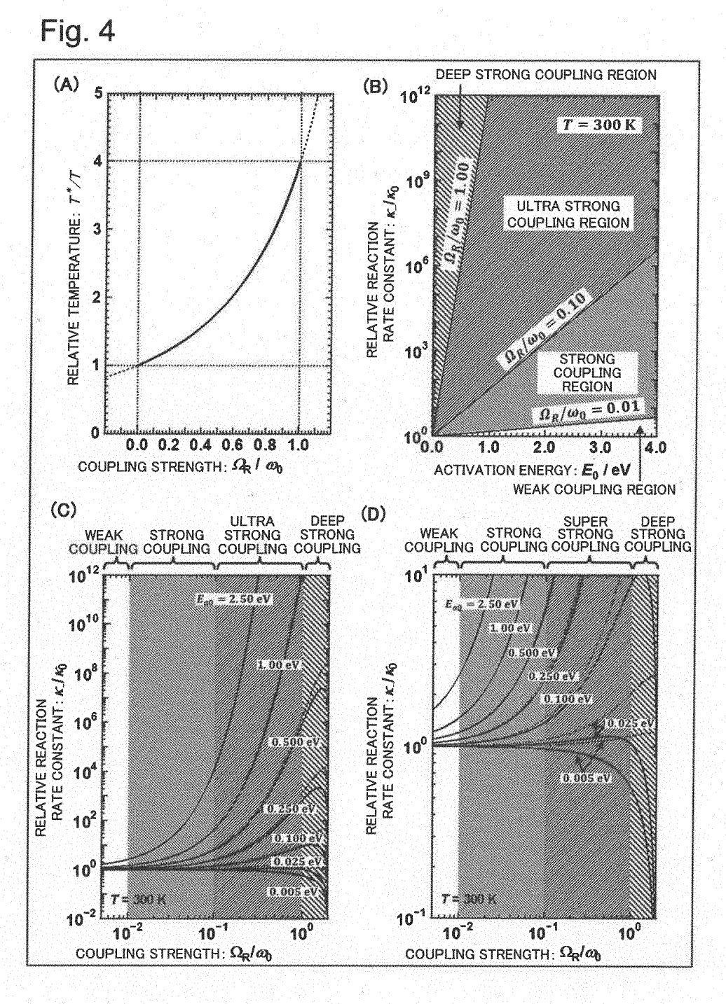

Referring to FIG. 4, it is indicated that many findings are obtained from Equations 17 and 18 in quantitative understanding of promotion of a chemical reaction by a vibrational coupling. As a first example, a way how to convert a coupling strength Ω_{R}/ω₀ to reaction temperature will be discussed. When a reaction rate constant at a certain temperature T is denoted as κ₀ and a reaction rate constant at another temperature T* is denoted as κ* in a certain chemical reaction, a ratio between κ₀ and κ* is described by Equation 19 below by referring to the Arrhenius equation in Equation 15.

$$[ Math . 29 ]$$

$$\frac{{κ}^{*}}{{κ}_{0}} = exp [ ( - \frac{{E}_{a 0}}{{k}_{B} T} ) ( \frac{T}{{T}^{*}} - 1 ) ] \qquad ( Equation 19 )$$

Assuming that an effect of vibrational coupling on a reaction rate constant is the same as an effect of temperature, that is, κ₋=κ*, since Equations 17 and 19 are exponential functions of the same type, Equation 20 below is acquired by comparing exponent parts.

$$[ Math . 30 ]$$

$$\frac{{T}^{*}}{T} = {( 1 - \frac{1}{2} \frac{{Ω}_{R}}{{ω}_{0}} )}^{- 2} \qquad ( Equation 20 )$$

Equation 2.0 is an equation indicating how to convert a coupling strength ω_{R}/ω₀ to reaction temperature, implying that an effect of a vibrational coupling with a coupling strength Ω_{R}/ω₀ is equivalent to an effect of reaction temperature with a multiplying factor T*/T.

(A) in FIG. 4 is a diagram illustrating the conversion of a coupling strength Ω_{R}/ω₀ to reaction temperature discussed in Equation 20. For example, T*=332.4 K is acquired when Ω_{R}/ω₀=0.1 and T=300.0 K. In other words, a vibrational coupling with a coupling strength 0.1 is equivalent to raising a system temperature from room temperature by 32 K. In a similar conversion way, vibrational couplings with respective coupling strength of 0.3 and 0.5 are equivalent to raising the system temperature from room temperature by 115.2. K and 233.3 K, respectively. Furthermore, T*=1200 K is obtained when Ω_{R}/ω₀=1.0 and T=300.0 K, meaning that a vibrational coupling with a coupling strength of 1.0 can cause a chemical reaction normally requiring a reaction temperature as high as 1200 K to progress at room temperature (300 K) with the same reaction rate. This is an example of a remarkable effect of a vibrational coupling on a chemical reaction clearly stated by Equation 20 derived from Equation 17. Further, Equation 17 is useful in visualizing, with quantitative accuracy, an effect of a vibrational coupling on a chemical reaction as shown next.

Referring to (B) in FIG. 4, the figure is a diagram visualizing a region occupied by each condition for a weak coupling, a strong coupling, an ultra strong coupling, and a deep strong coupling expressed by Equations 2 to 5 and an accelerating performance of a chemical reaction provided in each region, on a two-dimensional map with respect to a relative reaction rate constant κ₋/κ₀ and activation energy Eₐ₀ when a chemical reaction proceeds at room temperature (T=300 K). A boundary between the respective regions in (B) in FIG. 4 is a straight line satisfying respective conditions of Ω_{R}/ω₀=0.01, 0.10, and 1.00. While it is difficult for a relative reaction rate constant κ₋/κ₀ to exceed 10 under the vibrational weak coupling regime, the relative reaction rate constant κ₋/κ₀ becomes 10 or greater when Eₐ₀=1.0 eV and 1.0² or greater when Eₐ₀=2.0 eV around the middle of the vibrational strong coupling regime. The relative reaction rate constant: κ₋/κ₀ becomes 10³ or greater when Eₐ₀=1.0 eV, and 10⁶ or greater when Eₐ₀=2.0 eV around the middle of the vibrational ultra strong coupling regime, and when entering the vibrational deep strong coupling to regime, the relative reaction rate constant κ₋/κ₀ becomes 10 or greater when Eₐ₀≥1.0 eV. Namely, while a remarkable accelerating effect on a chemical reaction is not likely to be obtained with a vibrational weak coupling, a remarkable effect is likely to be acquired with a vibrational strong coupling, a vibrational ultra strong coupling, and a vibrational deep strong coupling. In addition, the accelerating effect increases exponentially in ascending order of a vibrational strong coupling, a vibrational ultra strong coupling, and a vibrational deep strong coupling. However, as discussed above, since a deep strong coupling has not yet been discovered in an actual system, it is substantially essential to realize a vibrational strong coupling and a vibrational ultra strong coupling when promoting a chemical reaction by several orders of magnitude.

(C) in FIG. 4 is a graph depicting activation energy dependence of a relative reaction rate constant curve illustrated on a two-dimensional map with respect to a relative reaction rate constant κ₋/κ₀ and a coupling strength Ω_{R}/ω₀ and superimposing thereon the weak coupling, strong coupling, ultra strong coupling, and deep strong coupling regions at the same time. A solid line represents an Eyring-type relative reaction rate constant κ₋/κ₀ curve based on Equation 18, and a dotted line represents an Arrhenius-type relative reaction rate constant κ₋/κ₀ curve based on Equation 17. (D) in FIG. 4 is a diagram enlarging (C) in FIG. 4 in a vertical axis direction.

The first characteristic of (C) and (D) in FIG. 4 is that a relative reaction rate constant κ₋/κ₀ exponentially increases as a coupling strength Ω_{R}/ω₀ increases. The tendency toward exponential increase in a relative reaction rate constant κ₋/κ₀ becomes more remarkable as an amount of activation energy Eₐ₀ increases.

The second characteristic is that a relative reaction rate constant κ₋/κ₀ does not reach 3.0 even when Eₐ₀=2.50 eV where the increasing tendency is largest in the weak coupling region. On the other hand, a relative reaction rate constant κ₋/κ₀ reaches a maximum of 10⁴ in the strong coupling region. Furthermore, in the ultra strong coupling region, a relative reaction rate constant reaches κ₋/κ₀=10¹² at Eₐ₀=2.50 eV even when Ω_{R}/ω₀=0.3 and reaches 10³ at Eₐ₀=0.250 eV, κ₋/κ₀≈10⁶ at Eₐ₀=0.500 eV, and κ₋/κ₀≈10¹² at Eₐ₀=1.00 eV when Ω_{R}/ω₀=1.0.

The third characteristic is that a discrepancy is generated between an Arrhenius-type curve (a dotted line) based on Equation 17 and an Eyring-type curve (a solid line) based on Equation 18, as a coupling strength Ω_{R}/ω₀ increases. In particular, in the deep strong coupling region, a discrepancy between the both curves increases as activation energy Eₐ₀ decreases, and finally, when activation energy Eₐ₀ becomes less than 0.025 eV, a relative reaction rate constant κ₋/κ₀ falls below one. The reason for this phenomenon is that, one hand, a relative reaction rate constant κ₋/κ₀ monotonically increases as a coupling strength Ω_{R}/ω₀ increases due to absence of a pre-exponent term (a term added in front of an exponential function) in Equation 17 being Arrhenius-type, on the other hand, a pre-exponent term (1−½·Ω_{R}/ω₀) suppresses increase of a relative reaction rate constant κ₋/κ₀ in Equation 18 being Eyring-type. However, considering that a deep strong coupling has not been realized and therefore does not need to be considered under the present conditions, and a discrepancy between Equations 17 and 18 is relatively small and therefore the two draw nearly identical curves in the weak coupling, strong coupling, and ultra strong coupling regions, whether to use Equation 17 or 18 makes no big difference in evaluation of promotion of a chemical reaction by a vibrational coupling.

Furthermore, results of quantitatively evaluating an effect of a vibrational coupling on a chemical reaction, based on Equations 17 and 18, under a wide range of parameter conditions, that is, activation energy Eₐ₀ in a range of 0.005 to 2.000 eV, a coupling strength Ω_{R}/ω₀ in a range of 0.0005 to 2.000, and temperature T in a range of 10 to 1000 K, will be discussed in detail in [Example 1] to [Example 3]. Examples 1 to 3 provide findings covering nearly every chemical reaction condition and vibrational coupling condition with regard to promotion of a chemical reaction by a vibrational coupling.

[(2) Process of Materializing Structure Satisfying Requirement Necessary for Vibrational Coupling]

Next, with regard to Item (2), a process of materializing a structure satisfying a requirement necessary for a vibrational coupling will be discussed based on Item (1), according to Items (2)-A, (2)-B, and (2)-C described below. Specific productions of the structure will be discussed later in the Description of Production Method section.

(2)-A: an opto-electrical field confinement structure for forming an optical mode and a requirement of the structure
(2)-B: a vibrational mode possessed by a chemical material used in a chemical reaction and a requirement of the vibrational mode
(2)-C: a vibrational coupling between an optical mode and a vibrational mode, and a requirement of the vibrational coupling

[(2)-A: Opto-Electrical Field Confinement Structure for Forming Optical Mode and Requirement of Structure]

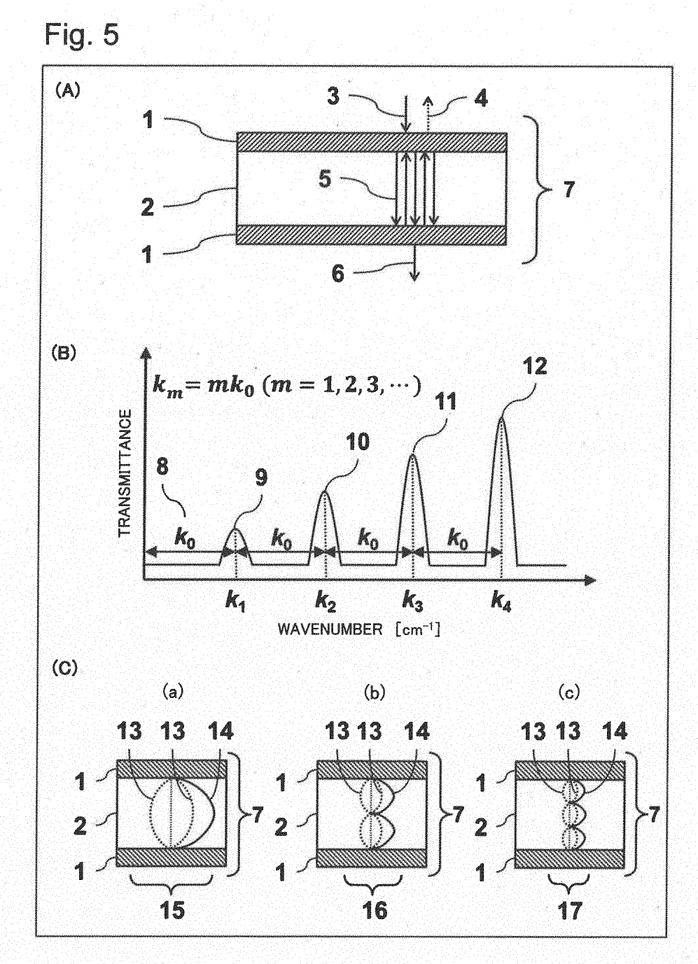

With regard to item (2)-A, an opto-electrical field confinement structure for forming an optical mode and a requirement of the structure will be discussed. The first structure to be listed as a structure capable of confining an opto-electrical field is a Fabry-Pérot cavity. As illustrated in (A) in FIG. 5, a Fabry-Pérot cavity 7 is a most basic cavity configured with a set of two mirror planes 1 parallel to one another. When incident light 3 enters the Fabry-Pérot cavity 7, part of the light is reflected as reflected light 4, whereas light at a specific wavelength becomes resonant light 5 repeatedly reflected inside the Fabry-Pérot cavity 7, and part of the resonant light 5 is transmitted as transmitted light 6. This image is expressed by a mathematical expression as follows. Specifically, assuming a cavity length being a distance between two mirror planes is taken as t [μm], when a dielectric 2 with a refractive index n is sandwiched between the mirror planes 1, an optical mode expressed by a relation in Equation 21 below develops between the two mirror planes 1.

$$[ Math . 31 ]$$

$${k}_{m} = {mk}_{0} = m \frac{{10}^{4}}{2 nt} ( m = 1 , 2 , 3 , ⋯ ) \qquad ( Equation 21 )$$

where kₘ denotes a wavenumber (unit: cm⁻¹) of the m-th optical mode, and m denotes an optical mode number and is a natural number. For example, when a cavity length t is nearly equal to an infrared wavelength, that is, t=1 to 100 μm, an optical mode of the Fabry-Pérot cavity 7 can be measured by a Fourier transform infrared spectrophotometer (FT-IR) or the like. (B) in FIG. 5 is a schematic diagram of a transmitted spectrum of an optical mode conforming to Equation 21. While the first optical mode 9, the second optical mode 10, the third optical mode 11, the fourth optical mode 12, and the like appear at equal free spectral range 8 (k₀) from a lower wavenumber to a higher wavenumber, infrared light is transmitted between optical modes. The reason is that only infrared light having a node on an end face of the mirror plane 1 generates resonance between the mirror planes 1 and the infrared light gains a strength to be transmitted but other infrared light is immediately attenuated. In other words, the Fabry-Pérot cavity 7 transmits light at a specific wavelength while causing resonance, the cavity works as a bandpass filter intercepting light at a wavelength other than the specific wavelength. For example, in (C) in FIG. 5, (a) illustrates a case corresponding to the first optical mode 15 where a half wavelength of a specific wavelength is t μm, that is, the specific wavelength is 2t μm. Further, (b) corresponds to the second optical mode 16 where a half wavelength of a specific wavelength is t/2 μm, that is, the specific wavelength is t μm. Furthermore, (c) corresponds to the third optical mode 17 where a half wavelength of a specific wavelength is t/3 μm, that is, the specific wavelength is 2t/3 μm. Each has distributions of an amplitude of electric field of light 13 and a strength of electric field of light 14.

In the m-th optical mode, a ratio between a half-value width Δkₘ and a wavenumber of the optical mode kₘ is referred to as a quality factor (Q factor) and is defined by Equation 22 below.

$$[ Math . 32 ]$$

$${Q}_{m} = \frac{{k}_{m}}{Δ {k}_{m}} ( m = 1 , 2 , 3 , ⋯ ) \qquad ( Equation 22 )$$

A Q factor is one of performance indices of an opto-electrical field confinement structure and the reciprocal thereof is proportional to a decay of the m-th optical mode. Accordingly, as a Q factor increases, a confinement time of an opto-electrical field becomes longer, and performance as a cavity becomes better. Further, since a Q factor and a coupling strength: Ω_{R}/ω₀ are in a proportional relation, referring to Equation 17 or 18, as a Q factor takes a larger value, a relative reaction rate constant κ₋/κ₀ increases. However, based on experimental results, a Q factor with magnitude of at most 20 can provide a practical effect on promotion of a chemical reaction by a vibrational coupling. A mode volume can be cited as another performance index of a cavity. As indicated in Equation 1, Rabi splitting energy hΩ_{R} is inversely proportional to the square root of a mode volume V. Accordingly, in order to increase a coupling strength Ω_{R}/ω₀ for a purpose of increasing a relative reaction rate constant κ₋/κ₀, the smaller the mode volume V, the more favorable. However, while the mode volume V depends on a cavity length t defining a wavenumber of an optical mode kₘ with regard to the Fabry-Pérot cavity 7, the wavenumber of an optical mode kₘ needs to match a wavenumber of the vibrational mode with regard to a vibrational coupling. As such, when the Fabry-Pérot cavity 7 is used for a vibrational coupling, a mode volume V is naturally determined to be a certain value and therefore is handled as an invariant instead of an adjustable variable.

In addition, a surface plasmon-polariton structure can be cited as another structure capable of confining an electric field of light. In general, a surface plasmon-polariton structure refers to a structure on which many materials, typically metal, with a dielectric function the real part of which is negative and has a large absolute value, and the imaginary part of which has a small absolute value, are cyclically arranged on a dielectric surface as a microstructure with a size and a pitch both around a wavelength of target light. When the metal microstructure is used for vibrational coupling, a size and a pitch of the structure is around a wavelength of infrared light, that is, 1 to 100 μm.

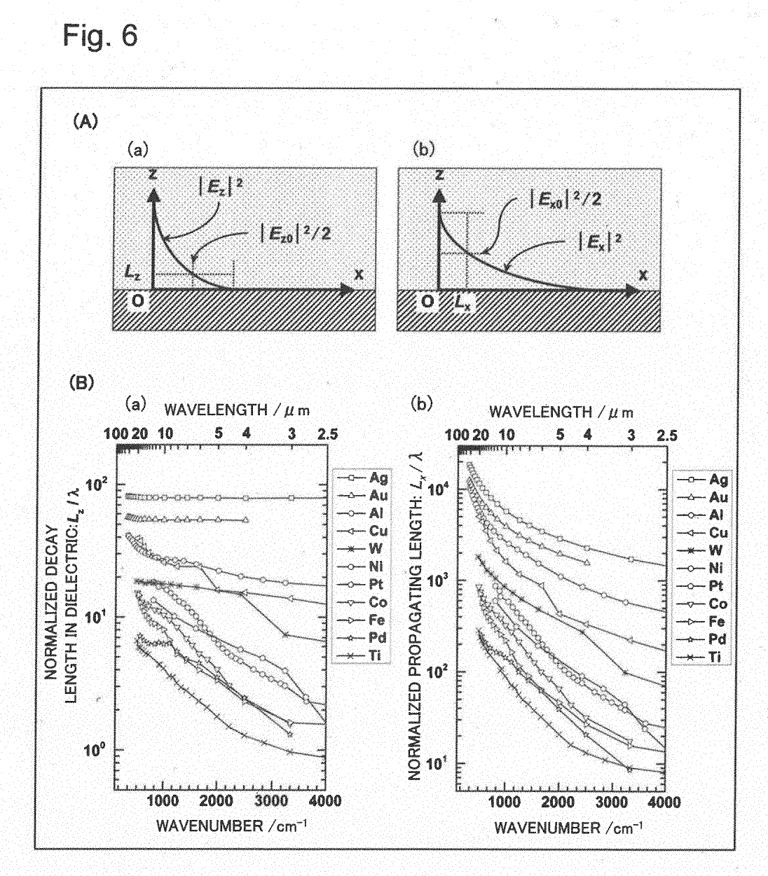

Next, propagation and decay of an optical mode will be discussed. An interface between a dielectric (a dotted part) and metal (a shaded part) to is considered as illustrated in (A) in FIG. 6, and the origin O is taken on the interface, the z-axis is taken in a direction perpendicular to the interface, and the x-axis is taken in a direction parallel to the interface. As illustrated in (a), a distance L_{z} from the origin in the z-axis direction on the dielectric side at which a strength |E_{z}|² of an electric field. E_{z} in the z-axis direction becomes half is referred to as a decay length (in the dielectric) of an optical mode. Further, as illustrated in (b), a distance Lₓ from the origin where a strength |Eₓ|² of an electric field E_{z} in the x-axis direction becomes half is referred to as a propagating length of an optical mode. By use of a dielectric constant of the dielectric ε_{D}, and a dielectric constant of the metal ε_{M}, the decay length L_{z} and the propagating Lₓ are expressed by Equations 23 and 24 below, respectively.

$$[ Math . 33 ]$$

$$\begin{matrix}{L}_{Z} = \frac{λ}{4 π} \frac{1}{Im ( \frac{{ɛ}_{D}}{\sqrt{{ɛ}_{M} + {ɛ}_{D}}} )} & ( Equation 23 ) \\ {L}_{X} = \frac{λ}{4 π} \frac{1}{Im ( \frac{\sqrt{{ɛ}_{M} {ɛ}_{D}}}{\sqrt{{ɛ}_{M} + {ɛ}_{D}}} )} & ( Equation 24 )\end{matrix}$$

where λ denotes a wavelength (λ=2πc/ω, where c: speed of light) and Im(C) denotes an operator for taking the imaginary part of a complex number C. In general, a dielectric constant of a material is a complex dielectric function including an imaginary part and a real part, and the complex dielectric function is wavelength-dependent. Accordingly, the decay length L_{z} and the propagating length Lₓ have wavelength dependence. Referring to (B) in FIG. 6, (a) illustrates wavenumber (wavelength) dependence of the decay length L_{z} calculated based on Equation 23, and (h) illustrates a wavenumber (wavelength) dependence of the propagating length Lₓ calculated based on Equation 24. The calculations have been performed for typical metals being silver (Ag), gold (Au), aluminum (Al), copper (Cu), tungsten (W), nickel (Ni), platinum (Pt), cobalt (Co), iron (Fe), palladium (Pd), and titanium (Ti), using experimental values of the complex dielectric function in an infrared region, and also under a condition that only the real part of the dielectric function of the dielectric is taken and, for the sake of simplicity, ε_{D}=1. Note that, in each diagram, the vertical axis is normalized by a wavelength λ(L_{z}/λ and Lₓ/λ). Accordingly, a value on the vertical axis at a certain wavelength λ in (B) in FIG. 6 indicates a multiplication factor with respect to the wavelength λ.

First, taking a close look at wavenumber (wavelength) dependence of the decay length L in (a) illustrated in (B) in FIG. 6, several characteristics can be listed as follows: the first characteristic is that magnitude of a decay L_{z} changes from around a wavelength to several tens of wavelengths in the infrared region. On the other hand, a decay length L_{z} is generally around half of a wavelength in a visible region. A decay length L_{z} indicates a range in which an optical mode can exist in a vertical direction and therefore can be considered as a range affected by a vibrational coupling. Thus, it is desirable that a decay length L_{z} be as long as possible for promotion of a chemical reaction by a vibrational coupling. A decay length L_{z} being 10 times a wavelength or longer in a wavenumber range of 400 to 4000 cm⁻¹ (wavelength: 25 to 2.5 μm) is observed for silver, gold, aluminum, and copper, and in the cases of silver and gold in particular, the decay length L_{z} becomes approximately 80 times and approximately 55 times the wavelength, respectively. Specifically, in the case of silver, an existence region of an optical mode extends up to approximately 0.8 mm from the interface between the metal and the dielectric in the vertical (z-axis) direction at a wavenumber 1000 cm⁻¹ (wavelength: 10 μm). Under the same condition, an existence region of the optical mode in the vertical direction is approximately 0.5 mm for gold, approximately 0.25 mm for aluminum and copper, approximately 0.2 mm for tungsten and nickel, and approximately 0.1 mm for platinum and cobalt. In other words, for many of the metals, an effect of a vibrational coupling extends to the submillimeter order from the interface in the vertical direction. The catalyst in Background Art cannot exert a catalytic action unless a reactant source material is physically or chemically bonded with an active center of the catalyst or an interface, that is, unless the catalyst and the reactant source material get close to one another down to the subnanometer order, regardless of whether the catalyst is a homogeneous catalyst or a heterogeneous catalyst. On the other hand, according to a reaction promotion mechanism by a vibrational coupling presented by the example embodiment of the present invention, once a reactant source material enters a range of the submillimeter order from the interface, the reactant source material can enjoy a reaction promoting action, that is, a catalytic action. In other words, the reaction promotion mechanism by a vibrational coupling presented by the example embodiment of the present invention can be considered as a catalyst with a totally new concept that mediates without touching. The second characteristic is that a decay length L_{z} varies by a type of metal. For example, silver with a maximum decay length L_{z} and titanium with a minimum differ by a single- or double-digit. The third characteristic is that, for silver, gold, aluminum, copper, and tungsten, a decay length L_{z} variation by a wavenumber (wavelength) is twice at most, which is relatively small, and in the cases of silver and gold in particular, a decay length L_{z} hardly has wavenumber (wavelength) dependence and takes a constant value. On the other hand, for nickel, platinum, cobalt, iron, palladium, and titanium, a decay length L_{z} variation by a wavenumber (wavelength) is around a single digit, which is relatively larger.

Classifying the metals suited to the purpose of chemical reaction promotion by a vibrational coupling, based on the aforementioned three characteristics related to wavenumber (wavelength) dependence of the decay length L_{z} silver and gold are most excellent, then aluminum, copper, tungsten are desirable, and nickel, platinum, cobalt, iron, palladium, and titanium are fair. Another material may be used as long as the real part of a dielectric function of the material is negative and has a large absolute value, and the imaginary part of the dielectric function has a small absolute value; and single-element metal, an alloy, metallic oxide, graphene, graphite, or the like that are not taken up here are also applicable.

Next, referring to a propagating length L_{z} in (13) illustrated in (B) in FIG. 6, wavenumber (wavelength) dependence of a propagating length L_{z} has several characteristics as follows: the first characteristic is that a propagating length L_{z} increases by 10 to 10⁴ times in the infrared region. On the other hand, in the visible region, a propagating length Lₓ is at most 10 times a wavelength (several micrometers). Specifically, in the case of silver in the infrared region, an optical mode can maintain coherence in a very wide range of approximately 60 mm on every side in a horizontal direction at a wavenumber 1000 cm⁻¹ (wavelength: 10 μm). Under the same condition, an expansion of coherence is approximately 40 mm on every side for gold, approximately 25 mm on every side for aluminum, approximately 15 mm on every side for copper, approximately 8.5 mm on every side for tungsten, approximately 7 mm on every side for nickel, approximately 4.5 mm on every side for platinum, approximately 3 mm on every side for cobalt, approximately 2.5 mm on every side for iron, approximately 1.5 mm on every side for palladium, and approximately 1 mm on every side for titanium. Note that a propagating length can be considered as an expansion in a horizontal direction in which an optical mode can maintain coherence. Therefore, a literal macroscopic coherent state literally having an expansion of the order of millimeters to centimeters can be realized. On the other hand, as indicated in Equation 1, Rabi splitting energy h Ω_{R} is proportional to the square root of a number N. Thus, a coupling strength Ω_{R}/ω₀ increases as a propagating length Lₓ increases, because a number of matter N under light-matter interaction increases with an increase of propagating length Lₓ. In addition, according to Equation 17 or 18, a relative reaction rate constant κ₋/κ₀ exponentially increases with an increase of a coupling strength ω_{R}/ω₀, and thereby eventually, the relative reaction rate constant κ₋/κ₀ increases as a length Lₓ increases. As a result, a longer length Lₓ is better suited to the purpose of chemical reaction promotion by a vibrational coupling. The second characteristic is that a propagating length Lₓ varies with a wavenumber (wavelength) by about one order of magnitude, which is rather large, for any metal. The third characteristic is that a variation by a metal type is approximately double-digit, which is also large.

Classifying the metals in terms of suitability for the purpose of chemical reaction promotion by a vibrational coupling, based on the aforementioned three characteristics related to wavenumber (wavelength) dependence of a propagating length Lₓ, silver, gold, aluminum, copper, tungsten, nickel, platinum, cobalt, iron, palladium, and titanium can be listed in descending order of suitability. Another material may be used as long as the real part of a dielectric function of the material is negative and has a large absolute value, and the imaginary part of the dielectric function has a small absolute value; and single-element metal, an alloy, metallic oxide, grapheme, graphite, or the like that are not taken up here are also applicable.

[(2)-B: Vibrational Mode Possessed by Chemical Material Used in Chemical Reaction and Requirement of Vibrational Mode]

With regard to Item (2)-B, a vibrational mode possessed by a chemical material used in a chemical reaction and a requirement of the vibrational mode will be discussed. A molecule composed of N atoms has 3N−6 vibrational modes excluding degrees of freedom of translation and rotation (3N−5 for a linear molecule). Among such vibrational modes, a vibrational mode usable for a vibrational coupling is limited to dipole allowance. The reason is that, as indicated in Equation 1, when a transition dipole moment d is zero, Rabi splitting energy hΩ_{R} becomes zero, and consequently, a coupling strength Ω_{R}/ω₀ also becomes zero. Actually, substituting Ω_{R}/ω₀=0 into Equation 17 or 18 yields κ₋/κ₀=1, therefore chemical reaction promotion by a vibrational coupling is not provided. Dipole allowance refers to infrared activity, meaning that there is a certain infrared absorption in a molecule. An infrared-active vibrational mode includes anti-symmetric stretching vibration, anti-symmetric deformation vibration, or the like when the molecule has a center of symmetry, whereas, in the absence of a center of symmetry, symmetric stretching vibration, symmetric deformation vibration, or the like are also included in addition to the anti-symmetric stretching vibration, the anti-symmetric deformation vibration, or the like. According to Equation 1, Rabi splitting energy hΩ_{R} is proportional to a transition dipole moment d. In other words, as a transition dipole moment d increases, a coupling strength Ω_{R}/ω₀ increases, and a relative reaction rate constant κ₋/κ₀ also increases, based on Equation 17 or 18. Namely, a vibrational coupling promotes a chemical reaction more rapidly when a vibrational mode has a larger transition dipole moment d.

TABLE 1
Comparison on transition dipole moments of various
vibrational modes

| | | Transition dipole |
|---|---|---|
| | | moment |
| Molecule | Vibration type | [D: Debye] |
| Ethane thiol | S—H stretching | 0.018 |
| | vibration | |
| Ammonia | N—H stretching | 0.026 |
| | vibration | |
| Benzene | C—H stretching | 0.034 |
| | vibration | |
| Methanol | O—H stretching | 0.050 |
| | vibration | |
| Acetic acid | O—H stretching | 0.065 |
| | vibration | |
| Methane | C—H stretching | 0.100 |
| | vibration | |
| Ozone | O═O═O stretching | 0.187 |
| | vibration | |
| Acetone | C═O stretching | 0.224 |
| | vibration | |
| Methanol | C—O stretching | 0.242 |
| | vibration | |
| Nitrogen dioxide | O═N═O stretching | 0.297 |
| | vibration | |
| Carbon dioxide | O═C═O stretching | 0.326 |
| | vibration | |
| Carbon disulfide | S═C═S stretching | 0.333 |
| | vibration | |
| Isocyanate | N═C═O stretching | 0.555 |
| | vibration | |
| Ketene | C═C═O stretching | 0.611 |
| | vibration | |

Table 1 lists literature values or experimental values of transition dipole moments d of various vibrational modes. The unit of a transition dipole moment d is expressed by debye (D, where 1 D=3.336×10⁻³° Referring to Table 1, a general tendency is that a transition dipole moment d has a relatively larger value in a vibrational mode between different atoms rather than between the same atoms, in a vibrational mode between atoms with a small mass difference rather than between atoms with a large difference, a vibrational mode with a multiple bond rather than a single bond, and a vibrational mode with a long conjugated system rather than a short conjugated system. This tendency is also inherited to a degree of promotion of a chemical reaction by a vibrational coupling. In other words, a chemical material including a vibrational mode of a multiple bond between atoms with a relatively small mass difference, such as a vibrational mode of each of C═N, C═O, C═P, C═S, N═O, N═P, N═S, and O═S is expected to further enjoy an effect of chemical reaction promotion by a vibrational coupling.

On one hand, a transition dipole moment d is vibrational mode inherent, that is, chemical material inherent, and therefore cannot be changed once a reaction system is determined. On the other hand, according to a theory indicated by Equation 1, Rabi splitting energy hΩ_{R} is proportional to the square root of a concentration of a matter C (C=N/V, where N is a number of a matter and V is a mode volume and further according to an experiment discussed in [Example 5], the Rabi splitting energy hΩ_{R} is proportional to the 0.4-th power of the concentration of the matter C. That is, theoretically Ω_{R} ∝C^{0.5} holds, and experimentally Ω_{R} ∝C^{0.4} holds. Consequently, in either case, as a means of raising a degree of promotion of a chemical reaction by a vibrational coupling, increasing a relative reaction rate constant κ₋/κ₀ by increasing a coupling strength Ω_{R}/ω₀ through increasing a concentration C is a versatile method. By use of Equation 17, an effect of magnitude of a concentration C on a relative reaction rate constant KJK₀ can be quantitatively estimated. While the concentration dependence of a relative reaction rate constant κ₋/κ₀ will be discussed in detail in [Example 6], the conclusion is as follows: raising a concentration of a chemical material is effective as a means of increasing a reaction rate constant under a vibrational coupling unless a coupling strength enters the deep strong coupling region expressed by Equation 5. In particular, a concentration increase brings about a remarkable effect to a vibrational strong coupling and a vibrational ultra strong coupling.

[(2)-C: Vibrational Coupling Between Optical Mode and Vibrational Mode, and Requirement of Vibrational Coupling]

With regard to Item (2)-C, a vibrational coupling between an optical mode and a vibrational mode, and a requirement of the vibrational coupling will be discussed. A condition for achieving a vibrational coupling by use of the Fabry-Pérot cavity 7 is expressed by Equation 25 below using a wavenumber of an optical mode kₘ and a wavenumber of a vibrational mode ω₀.

[Math. 34]

ω₀=kₘ=mk₀(m=1, 2, 3, . . . ) (Equation 25)

where k₀ denotes a free spectral range, as discussed above. As defined in Item (1)-A, ω₀ denotes an angular frequency (unit: s⁻¹); however, since a physical quantity acquired by an experiment is a wavenumber (unit: cm⁻¹), ω₀ is hereinafter referred to as a wavenumber. In addition, since (energy)=(Planck constant)×(frequency)=(Dirac constant)×(angular frequency)=(Planck constant)×(speed of light)×(wavenumber) holds, energy, a frequency, an angular frequency, and a wavenumber are interchangeable.

As illustrated in (A) in FIG. 3, when Equation 25 is satisfied, a vibrational coupling system in (h) is generated through mixing of a vibration system in (a) and an optical system in (c). Referring to (B) in FIG. 3, in a chemical reaction, activation energy in a vibrational coupling system is reduced from Eₐ₀ to Eₐ₋ as compared with an original system, as indicated by Equation 13. Consequently, as indicated by Equation 17 or 18, a reaction rate constant of the vibrational coupling system κ₋ increases as compared with a reaction rate constant of the original system κ₀. In particular, under the strong coupling condition expressed by Equation 3 and the ultra strong coupling condition expressed by Equation 4, the relative reaction rate constant κ₋/κ₀ takes a value ranging from several digits to several tens of digits, and an effect of chemical reaction promotion by a vibrational coupling can be most significantly enjoyed. It is known by experiment that an equivalent advantageous effect of chemical reaction promotion can be realized even when a wavenumber kₘ of an optical mode and a wavenumber ω₀ of a vibrational mode do not strictly match in Equation 25. In other words, ω₀=k₀ (where in =1, 2, 3, . . . ) holds experimentally.

In Equation 25, ω₀ denotes a wavenumber of a vibrational mode of a chemical bond constituting a reactant material in a desired chemical reaction. In other words, a wavenumber of a vibrational mode in an original system ω₀ is a constant value inherent to a chemical material in the original system, and therefore there is no degree of freedom for adjustment. Thus, when a vibrational coupling is used for promotion of a chemical reaction, a wavenumber of an optical mode kₘ is to be adjusted to match a wavenumber of a vibrational mode ω₀. As discussed in Item (2)-A, an optical mode is composed of the first optical mode, the second optical mode, the third optical mode, . . . , the m-th optical mode, and therefore there are in choices, which satisfy to the condition in Equation 25. An optical mode best suited for chemical reaction promotion by a vibrational coupling is not obvious. As illustrated in aforementioned (A) to (D) in FIG. 4, as a coupling strength Ω_{R}/ω₀ increases, a relative reaction rate constant κ₋/κ₀ increases, according to Equation 17 or 18. Namely, which optical mode is best suited for increasing a relative reaction rate constant κ₋/κ₀ can be reduced to a discussion of which optical mode increases a coupling strength Ω_{R}/ω₀. While optical mode number dependence of a coupling strength Ω_{R}/ω₀ will be discussed in detail in [Example 7], the conclusion is as follows: Rabi splitting energy hΩ_{R} takes a nearly constant value regardless of which of the optical modes from the first optical mode to at least the twentieth optical mode is used. Therefore, for a purpose of use in chemical reaction promotion by a vibrational coupling, the same effect can be practically expected regardless of the ordinal number of the optical mode to be used.

[(3) Process of Materializing Vibrational Coupling Chemical Reaction Device and Producing and Processing Desired Chemical Material]

Finally, with regard to Item (3), a process of materializing a vibrational coupling chemical reaction device in which a purpose of performing a vibrational coupling is compatible with a purpose of performing a chemical reaction, and producing and processing a desired chemical material by use of the device will be discussed on the basis of Item (2), according to Items (3)-A, (3)-B, and (3)-C described below:

(3)-A: Capacity increase of a vibrational coupling chemical reaction device by a linear cavity,
(3)-B: Mode number increase in a vibrational coupling chemical reaction device by a linear cavity, and
(3)-C: Modularization, unitization, and systematization of a vibrational coupling chemical reaction device.

[(3)-A: Capacity increase of Vibrational Coupling Chemical Reaction Device by Linear Cavity]

First, with regard to item (3)-A, a concept of a linear cavity and capacity increase of a vibrational coupling chemical reaction device by a linear cavity will be discussed. One hand, the Fabry-Pérot cavity 7 in FIG. 5 has an advantage of having a simple structure and being easy to produce, on the other hand, because a confinement space of light is defined by a cavity length t, the Fabry-Pérot cavity 7 has a disadvantage of having relatively small capacity as a chemical reaction container for a vibrational coupling. For example, referring to FIG. 5, when a vibrational mode of a chemical material with a wavenumber of 1000 cm⁻¹ is vibrationally coupled with an optical mode of the Fabry-Pérot cavity 7, assuming a refractive index of the chemical material filling the cavity to be 1.5, a cavity length t is approximately 3.33 μm, and a volume of a fillable chemical material is merely approximately 3.33 cm³ even using a mirror plane 1 with one meter square. Expansion from a two-dimensional structure to a three-dimensional structure is effective for expanding capacity; however, simply laminating several Fabry-Pérot cavities 7 makes production very difficult. For a purpose of overcoming the disadvantages of the Fabry-Pérot cavity 7, that is, for a purpose of making opto-electrical field confinement compatible with capacity increase as a chemical reaction container while simplifying production, a scheme of accumulating linear cavities as discussed below has been devised as a result of concentrated researches.

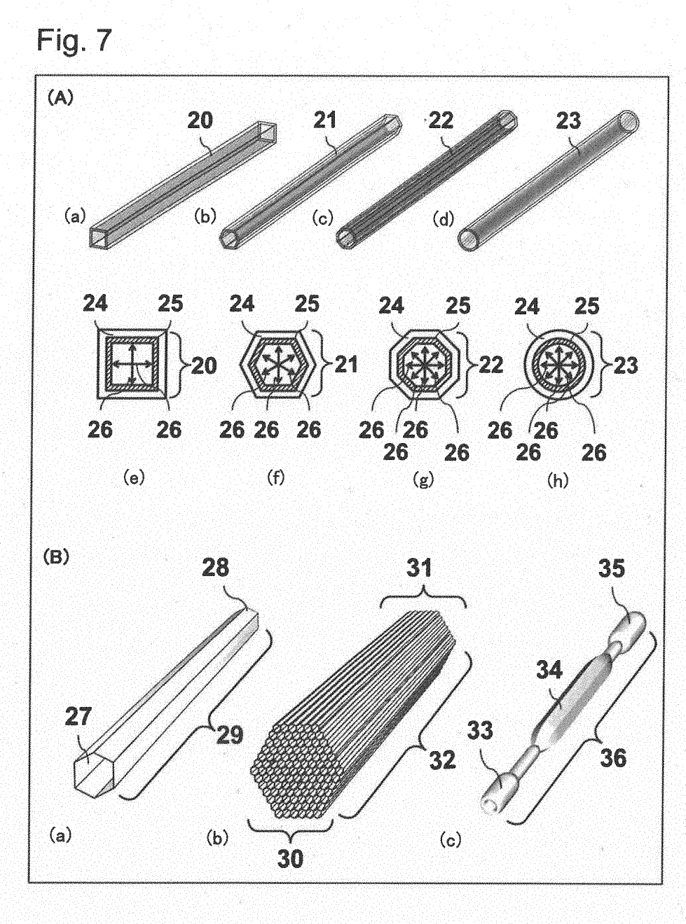

Referring to FIG. 7, a cross-section of a linear cavity is a convex 2p-sided polygon (where p is an integer greater than or equal to 2) including p sets of two sides parallel to one another and the linear cavity has a sufficiently long prismatic shape in a direction perpendicular to the cross-section (a long-axis direction). In other words, a linear cavity is a sufficiently long 2p-sided prism having p sets of two mirror planes parallel to one another as sides. A shape of the cross-section defines a configuration of an optical mode such as a number of optical modes and a frequency of the optical mode. Further, the long axis defines a capacity of a reactant material and further defines a reaction time when a flow reaction, to be discussed later, is performed. Specifically, a reactant capacity or a reaction time is proportional to the length of the long axis. For example, (a) to (d) in (A) in FIG. 7 are schematic diagrams of various single linear cavities, and (e) to (h) are cross-sectional views of the respective cavities. Specifically, (a) and (e) correspond to a parallelogrammatical linear cavity 20 at p=2, (b) and (f) correspond to a parallelo-hexagonal linear cavity 21 at p=3, (c) and (g) correspond to a parallelo-octagonal linear cavity 22 at p=4, and (d) and (h) correspond to an elliptical linear cavity 23 at p=00. As illustrated in the cross-sectional views in (e) to (h) in FIG. 7, each single linear cavity includes inner mirror planes 25 and an outer linear cavity enclosure 24, and has an optical mode 26 resonating between parallel mirror planes facing one another.

(B) in FIG. 7 is a schematic diagram illustrating accumulating linear cavities. First, (a) shows a single linear cavity 29 including a raw material inlet 27 of the single linear cavity and a product outlet 28 of the single linear cavity. Then, (b) depicts a linear cavity accumulation 32 in which single linear cavities 29 are aggregated, and a raw material inlet of the linear cavity accumulation 30 and a product outlet of the linear cavity accumulation 31 are similarly included. Finally, (c) represents a vibrational coupling chemical reaction device module 36 in which a linear cavity accumulation 32 is housed in a chamber of the linear cavity accumulation 34, and a raw material inlet of the vibrational coupling chemical reaction device module 33 and a product outlet of the vibrational coupling chemical reaction device module 35 are included. Capacity increase as a chemical reaction container is intended by three-dimensionally bundling single linear cavities 29 into a linear cavity accumulation 32. When a single linear cavity 29 has a cross-sectional shape of a parallelogram or a parallelo-hexagon, the single linear cavities 29 can be closely accumulated, and therefore capacity can be increased without a dead space. As will be discussed later in the Description of Method for Production section, the linear cavity accumulation 32 is also easy to produce.

[(3)-B: Mode Number Increase in Vibrational Coupling Chemical Reaction Device by Linear Cavity]

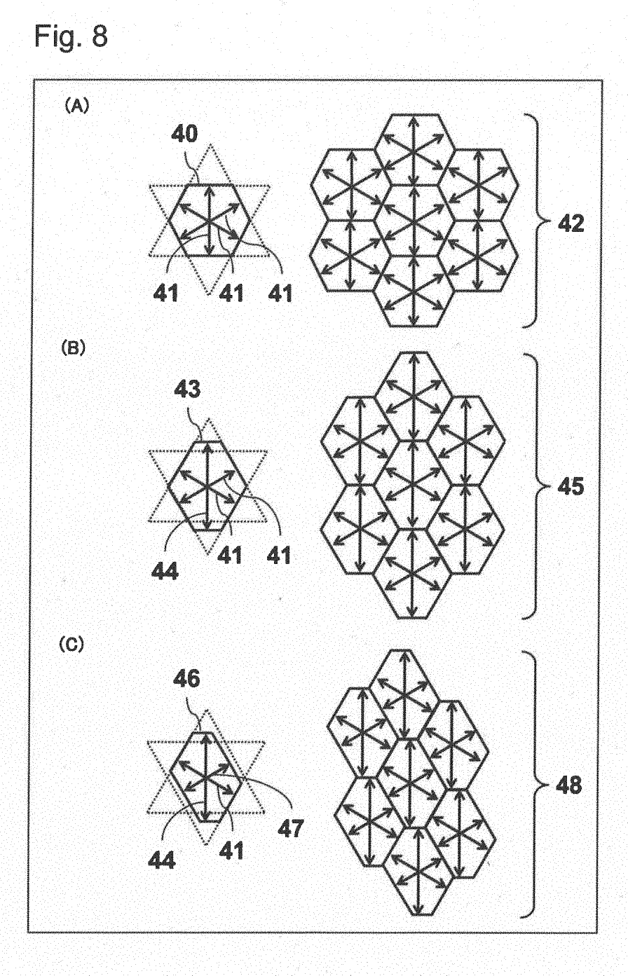

Next, with regard to Item (3)-B, mode number increase in a vibrational coupling chemical reaction device by a linear cavity will be discussed. A number of configurable optical modes in a linear cavity depends on a cross-sectional shape of the cavity. In other words, a linear cavity makes it possible to multiply a number of vibrationally coupled vibrational modes, thereby enabling a multimode operation for a vibrational coupling. A specific example is shown in FIG. 8. FIG. 8 illustrates cross-sectional views of various single parallelo-hexagonal linear cavities and cross-sectional views of parallelo-hexagonal linear cavity accumulations.

(A) in FIG. 8 illustrates a case that a cross-sectional shape is a regular hexagon, and each of a single regular-hexagonal linear cavity 40 and a regular-hexagonal linear cavity accumulation 42 has an optical mode 41 including spatially independent three modes energetically degenerating to one mode. Thereby, in the case of (A) in FIG. 8, each of the single regular-hexagonal linear cavity 40 and the regular-hexagonal linear cavity accumulation 42 can vibrationally couple with only one vibrational mode possessed by a chemical material.

(B) in FIG. 8 illustrates a case that a cross-sectional shape is an isosceles parallelo-hexagon in which two sets out of six sides facing one another have the same length but the remaining set has a length different from the other two sets, and each of a single isosceles-parallelo-hexagonal linear cavity 43 and an isosceles-parallelo-hexagonal linear cavity accumulation 45 has an optical mode 41 including two of three spatially independent modes energetically degenerating to one, and an optical mode 44 energetically different from the optical mode 41. Accordingly, in the case of (B) in FIG. 8, each of the single isosceles-parallel-hexagonal linear cavity 43 and the isosceles-parallel-hexagonal linear cavity accumulation 45 can vibrationally couple simultaneously with two different vibrational modes possessed by a chemical material.

(C) in FIG. 8 illustrates a case that a cross-sectional shape is an inequilateral parallelo-hexagon in which all three sets out of six sides facing one another have different lengths, and each of a single inequilateral-parallelo-hexagonal linear cavity 46 and an inequilateral-parallelo-hexagonal linear cavity accumulation 48 has three spatially and energetically independent modes, an optical mode 41, an optical mode 44, and an optical mode 47. Accordingly, in the case of (C) in FIG. 8, each of the single inequilateral-parallelo-hexagonal linear cavity 46 and the inequilateral-parallelo-hexagonal linear cavity accumulation 48 can vibrationally coupling simultaneously with three different vibrational modes possessed by a chemical material.

In general, when a cross-sectional shape is a parallelo-2p-sided polygon (where p is an integer greater than or equal to 2), a number of spatially independent optical modes is p, and therefore, for example, a number of spatially independent optical modes is two in the parallelogrammatical linear cavity 20, three in the parallelo-hexagonal linear cavity 21, four in the parallelo-octagonal linear cavity 22, and theoretically infinite in the elliptical linear cavity 23, assuming that a number of sides is infinite. When a cross-sectional shape is a regular 2p-sided polygon, and all p sets of parallel sides have the same length, a number of spatially independent optical modes is p; however, because all modes degenerate energetically and have the same frequency, practically, there is only one optical mode in the cavity. Accordingly, a regular 2p-sided polygonal linear cavity can vibrationally couple with only one vibrational mode possessed by a chemical material. Further, when a cross-sectional shape is an inequilateral parallelo-2p-sided polygon and all p sets of parallel sides have different lengths, there are p spatially and energetically independent optical modes in the cavity. Thus, an inequilateral parallelo-2p-sided polygonal linear cavity can vibrationally couple simultaneously with p different vibrational modes possessed by a chemical material. Furthermore, when a cross-sectional shape is a general 2p-sided polygon and lengths of p sets of parallel sides can be classified into q, a number of spatially independent optical modes is p, whereas a number of energetically different optical modes is q. As a result, a general 2p-sided-polygonal linear cavity can vibrationally couple simultaneously with q different vibrational modes possessed by a chemical material.

As discussed above, by defining a cross-sectional shape of a linear cavity, the linear cavity can vibrationally couple with a single to a multiple of vibrational modes possessed by a chemical material, that is, can realize a multi-mode operation, thereby enabling to handle diverse chemical reactions. In particular, when a chemical reaction proceeds with a multiple raw materials, a linear cavity can simultaneously activate vibrational modes related to a chemical reaction in each raw material, thereby exhibiting outstanding performance in synergistically accelerating a reaction rate of the entire chemical reaction.

[(3)-C: Modularization, Unitization, and Systematization of Vibrational Coupling Chemical Reaction Device]

Finally, with regard to Item (3)-C, modularization, unitization, and systematization of a vibrational coupling chemical reaction device will be discussed.

The reason why the example embodiment of the present invention can provide modularization of a chemical reaction device is derived from the following two facts: first, the principle of chemical reaction promotion does not require preparation of a specific elementary composition and surface state for each chemical reaction as is the case with a normal catalytic action. Second, it is only necessary to prepare an optical mode, which is determined solely by a structure and is coupled specifically with a vibrational mode related to a chemical reaction. Thus, according to the example embodiment of the present invention, because a frequency of an optical mode is determined solely by a cavity length, it is very easy to standardize module products. For example, referring to FIG. 7, just preparing a series of sets of vibrational coupling chemical reaction device modules 36 with slightly different cavity lengths, it is possible to handle reaction promotion of every chemical reaction. Further, just standardizing the raw material inlet of a vibrational coupling chemical reaction device module 33 and the product outlet of the vibrational coupling chemical reaction device module 35, unitization and systematization can be freely achieved as will be discussed later. Furthermore, scale-up or scale-down of the vibrational coupling chemical reaction device module 36 may be performed on the basis of a production amount/throughput of a product.

In addition to an advantage of being capable of capacity increase by accumulation described in the previous item, the vibrational coupling chemical reaction device module 36 illustrated in FIG. 7 has another advantage as follows: it is capable of continuously performing a series of processes including taking in a raw material, causing a reaction, and taking to out a product. This advantage is derived from a characteristic that the linear cavity accumulation 32 has a tubular shape and includes raw material inlet of single linear cavity 27 and the product outlet of the single linear cavity 28. These characteristics enable a flow-type chemical reaction. The vibrational coupling chemical reaction device module 36 is adaptable for a flowing chemical material as follows: any fluid regardless of whether the fluid is gas, liquid, or solid is applicable, and single-chemical-material gas, mixed gas containing a chemical material and carrier gas, an undiluted solution or melt of a single-chemical-material, a solution containing a chemical material, emulsion, suspension, supercritical flow, and powder. The advantage that the vibrational coupling chemical reaction device module 36 is capable of a flow-type chemical reaction contributes to unitization and systematization of the device. Further, by connecting a modularized vibrational coupling chemical reaction device to a container housing a raw material and a container storing a product through a proper channel, a chemical reaction unit, which constitutes every individual element for an entire process of a chemical reaction, can be constructed. Furthermore, a large-scale and complicated chemical reaction system, in which chemical reaction units are connected to one another through a proper channel, can be constructed. Namely, each process of a chemical reaction can be unitized as a result of modularization of the vibrational coupling chemical reaction device, and the entire process of the chemical reaction can be systematized as a result of unitization of each process of the chemical reaction.

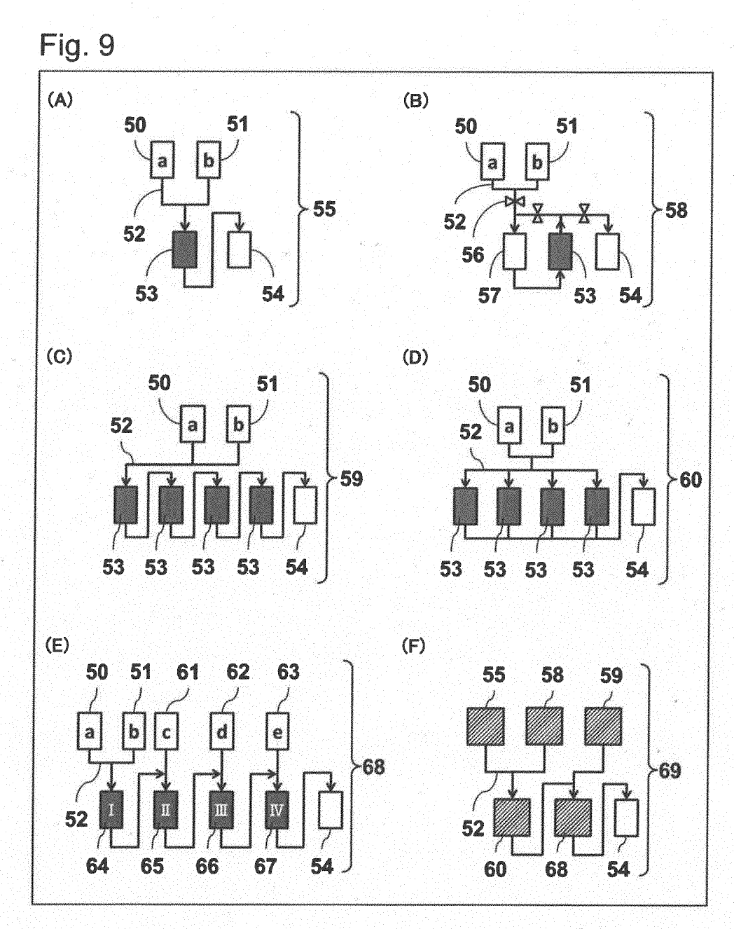

FIG. 9 illustrates chemical reaction units and a chemical reaction system that are introduced by modularization of the vibrational coupling chemical reaction device. (A) in FIG. 9 depicts a basic-type vibrational coupling chemical reaction device unit 55, (B) in FIG. 9 shows a circulation-type vibrational coupling chemical reaction device unit 58, (C) in FIG. 9 represents a serial-type vibrational coupling chemical reaction device unit 59, (D) in FIG. 9 elucidates a parallel-type vibrational coupling chemical reaction device unit 60, (E) in FIG. 9 exemplifies a sequential-type vibrational coupling chemical reaction device unit 68, and (F) in FIG. 9 illustrates a vibrational coupling chemical reaction device system 69.

(A) in FIG. 9 illustrates a most basic chemical reaction unit according to the example embodiment of the present invention that promotes a chemical reaction between a raw material a housed in a raw material container a 50 and a raw material b housed in a raw material container h 51, by use of a vibrational coupling chemical reaction device module 53, and subsequently to the chemical reaction, performs a process of storing a product in a product container 54. Transfer of raw materials between the raw material container a 50 and the raw material container h 51, and the vibrational coupling chemical reaction device module 53, and transfer of a product between the vibrational coupling chemical reaction device module 53 and the product container 54 are performed by use of a channel 52.

(B) in FIG. 9 illustrates a chemical reaction unit circulating a reactant into a vibrational coupling chemical reaction device module 53, and the unit is suited for a reaction of a large amount of reactant and lengthening of a reaction time. A process of first storing a raw material a housed in a raw material container a 50 and a raw material b housed in a raw material container 1) 51 into a reactant container 57, circulating the raw materials between the reactant container 57 and the vibrational coupling chemical reaction device module 53 by properly operating a valve 56 and the like, and subsequently to promoting the chemical reaction, storing a product into a product container 54 is performed.

(C) in FIG. 9 illustrates a chemical reaction unit in which vibrational coupling chemical reaction device modules 53 are connected in series, and the unit is suited for lengthening a reaction time. A process of promoting a chemical reaction between a raw material a housed in a raw material container a 50 and a raw material b housed in a raw material container b 51 by use of a set of the vibrational coupling chemical reaction device modules 53 connected in series, and subsequently to the chemical reaction, storing a product into a product container 54 is performed.

(D) in FIG. 9 illustrates a chemical reaction unit in which vibrational coupling chemical reaction device modules 53 are connected in parallel, and the unit is suited for a reaction of a large amount of reactant. A process of promoting a chemical reaction between a raw material a housed in a raw material container a 50 and a raw material b housed in a raw material container b 51 by use of a set of the vibrational coupling chemical reaction device modules 53 connected in parallel, and subsequently to the chemical reaction, storing a product into a product container 54 is performed.

(E) in FIG. 9 illustrates a chemical reaction unit sequentially performing a plurality of chemical reactions, and the unit is suited for a multistage reaction. A process as described below is performed. A chemical reaction between a raw material a housed in a raw material container a 50 and a raw material b housed in a raw material container b 51 is promoted by use of a vibrational coupling chemical reaction device module I 64. Subsequently to the chemical reaction, a chemical reaction between a product of the previous chemical reaction and a raw material c housed in a raw material container c 61 is promoted by use of a vibrational coupling chemical reaction device module II 65. Subsequently to the chemical reaction, a chemical reaction between a product of the previous chemical reaction and a raw material d housed in a raw material container d 62 is promoted by use of a vibrational coupling chemical reaction device module III 66. Subsequently to the chemical reaction, a chemical reaction between a product of the previous chemical reaction and a raw material e housed in a raw material container e 63 is promoted by use of a vibrational coupling chemical reaction device module IV 67, and subsequently to the chemical reaction, a product of the chemical reaction is stored into a product container 54.

(F) in FIG. 9 illustrates a reaction device system combining the chemical reaction units shown in (A) to (E) in FIG. 9, and the system is suited for performing an entire process of a complicated chemical reaction at once. In this example, a process of performing a chemical reaction between a product produced by the basic-type vibrational coupling chemical reaction device unit 55 and a product produced by the circulation-type vibrational coupling chemical reaction device unit 58 by use of the parallel-type vibrational coupling chemical reaction device unit 60, then performing a chemical reaction between a product of the previous chemical reaction and a product produced by the serial-type vibrational coupling chemical reaction device nit 59 by use of the sequential-type vibrational coupling chemical reaction device unit 68, and finally, storing a product of the chemical reaction into a product container 54. This is an example, and combination of various chemical reaction units can be performed.

As described above, modularization, unitization, and systematization according to the example embodiment of the present invention can handle diverse production/processing scales ranging from small-scale fewer-item production to mass production and enables easy recombination, rearrangement, and exchange as needed, and therefore is useful in greatly reducing production/processing costs and greatly improving productivity.

Production of a chemical material by use of a vibrational coupling chemical reaction device will be discussed in detail in [Example 8] to [Example 11].

### Description of Advantageous Effects

As described above, the vibrational coupling chemical reaction device according to the example embodiment of the present invention can decrease vibrational energy and reduce activation energy of a chemical reaction, by vibrationally coupling an optical mode formed by an opto-electrical field confinement structure with a vibrational mode of a chemical material related to the chemical reaction, and therefore can promote the chemical reaction. Thus, the vibrational coupling chemical reaction device according to the example embodiment of the present invention includes a catalytic action; however, while a normal catalyst depends on a chemical property of a component, the vibrational coupling chemical reaction device according to the example embodiment of the present invention is component independent and depends solely on a structural parameter of an opto-electrical field confinement structure. Accordingly, every type of chemical reaction can be accelerated merely by adjusting the structural parameter. Further, when a coupling strength Ω_{R}/ω₀ being an indicator of a vibrational coupling is in the ultra strong coupling region, the vibrational coupling chemical reaction device according to the example embodiment of the present invention can perform a chemical reaction requiring a reaction temperature of 1000° C. at room temperature. In addition, the vibrational coupling chemical reaction device according to the example embodiment of the present invention can further promote a chemical reaction as activation energy of a chemical reaction increases. For example, on condition of Ω_{R}/ω₀=1, the vibrational coupling chemical reaction device according to the example embodiment of the present invention can tremendously accelerate a reaction rate by a million times when activation energy is 0.5 eV and by a trillion times when activation energy is 1.0 eV. Furthermore, a normal catalyst cannot exert a catalytic action unless the catalyst and a raw material get close to one another down to the subnanometer order in such a way as to contact through chemisorption or physisorption, whereas the vibrational coupling chemical reaction device according to the example embodiment of the present invention can exert a catalytic action on a raw material, once the raw material enters a range of the submillimeter order where an optical mode can exist. Specifically, the vibrational coupling chemical reaction device according to the example embodiment of the present invention can maintain the catalytic effect up to a million times the distance of a normal catalyst. Moreover, according to the example embodiment of the present invention, efficient production and processing of a chemical material accommodating diverse scales ranging from small-scale fewer-item production to mass production/processing can be achieved by modularizing, unitizing, and systematizing the vibrational coupling chemical reaction device, and easy recombination, rearrangement, and exchange can be performed as needed, all of which are useful for greatly reducing production/processing costs and greatly improving productivity.

### Description of Production Method

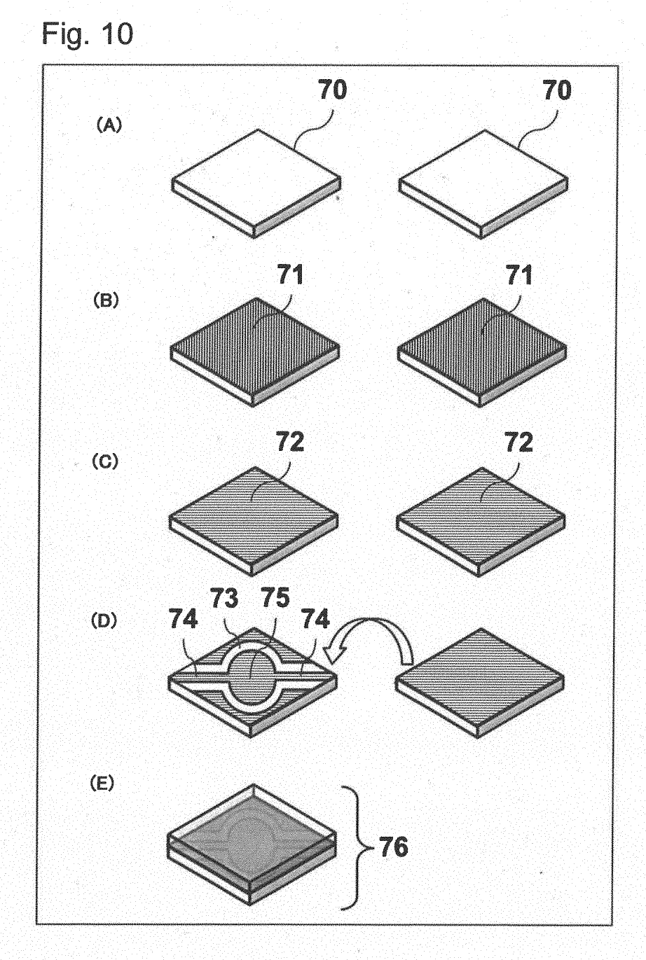

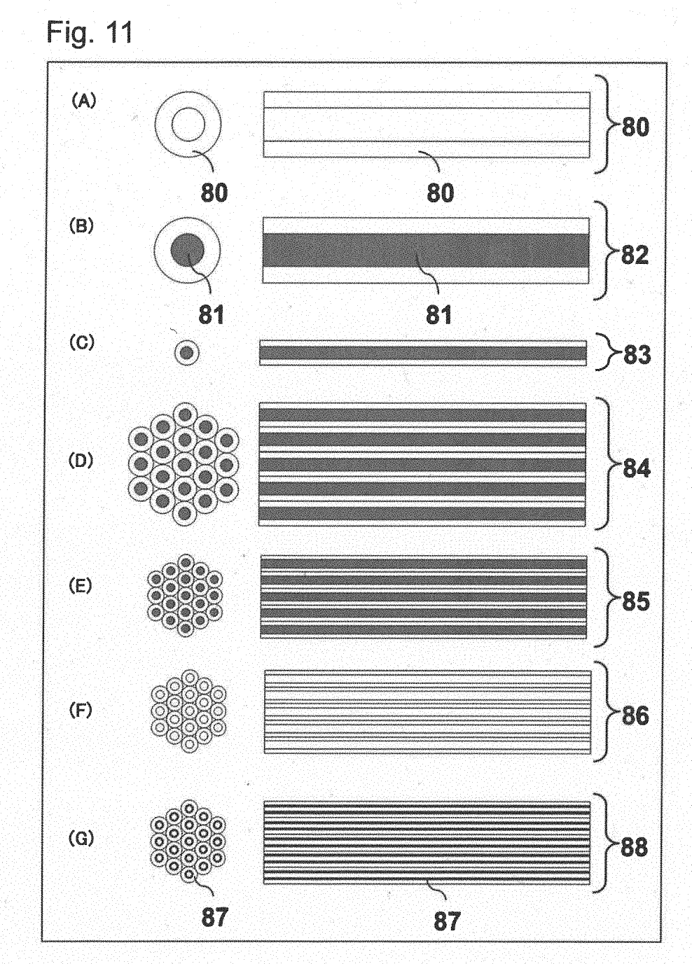

A production method according to the example embodiment will be discussed with reference to FIGS. 10 and 11.

FIG. 10 is a schematic diagram illustrating a process of producing a Fabry-Pérot-cavity-type vibrational coupling chemical reaction device according to the example embodiment of the present invention.

(A) in FIG. 10 illustrates a process of preparing a substrate 70 being an enclosure of a cavity. A surface of the substrate 70 is required to be smooth, and is desirably optically polished with an accuracy of a half-wavelength in an infrared region (1 to 100 μm). While a material of the substrate 70 may be selected from a wide range of materials such as metal, a semiconductor, and an insulator, on condition that a sufficient enclosure strength is secured, it is desirable to use germanium (Ge), zinc selenide (ZnSe), zinc sulfide (ZnS), gallium arsenide (GaAs), or the like which is relatively transparent in the infrared region, when evaluated by an infrared absorption spectroscopy method or the like. A thickness of the substrate 70 has only to be sufficient for maintaining the enclosure strength.

(B) in FIG. 10 illustrates a process of forming a mirror plane 71 of the cavity on the substrate 70. As for a material of the mirror plane 71, silver and gold are most excellent, then aluminum, copper, and tungsten are desirable, and nickel, platinum, cobalt, iron, palladium, and TITANIUM are fair, as described in Item (2)-A. Another material may be used as long as the real part of a dielectric function of the material is negative and has a large absolute value, and the imaginary part of the dielectric function has a small absolute value; and single-element metal, an alloy, metallic oxide, graphene, graphite, or the like are also applicable. While a thickness of around 5 nm is sufficient for the mirror plane 71, it is desirable that the thickness be less than or equal to 25 nm from a viewpoint of infrared light transmission, when evaluated by an infrared absorption spectroscopy method or the like. As the formation method of the mirror plane 71, a common film deposition method like dry deposition such as sputter deposition, resistive heat evaporation, or electron beam evaporation, or like wet deposition such as electrolytic plating or electroless plating may be used.

(C) in FIG. 10 illustrates a process of forming a protective film 72 on the mirror plane 71. The protective film 72 is formed for a purpose of preventing the mirror plane 71 from contacting chemical materials. A thickness of around 100 nm is sufficient for the protective film 72. While a material of the protective film 72 depends on a chemical reaction being used, silicon oxide (SiO₂) being chemically inert is generally used. As the formation method of the protective film 72, a dry method such as sputter deposition or the like, or a wet method such as vitrifying deposition by perhydropolysilazane [(—SiH₂—NH—)ₙ] may be used.

(D) in FIG. 10 illustrates a process of arranging a spacer 73 and a channel 74 for forming a chemical material storage 75, on one of the substrates 70 on which a protective film 72 and a mirror plane 71 are formed, and laying the other substrate 70 on which a protective film 72 and a mirror plane 71 are formed on top of the former substrate 70. A pair of spacers 73, part of which is a rib curving outward in a U-shape, is arranged on one substrate 70 at a certain distance away to each other. As a result, a space between the pair of spacers 73 facing one another becomes a channel 74, and a region surrounded by the U-shape part of the pair of spacers 73 becomes a chemical material storage 75. The thickness of the spacer 73 defines a cavity length. Accordingly, the thickness of the spacer 73 needs to be adjusted in accordance with Equation 2.1 for each frequency of a vibrational mode of a chemical material used in a chemical reaction, and roughly has length of a wavelength of infrared light (1 to 100 μm). It is here assumed that the channel 74 and the spacer 73 have the same thickness. As a material of the spacer 73, a plastic resin thin film a thickness of which can be adjusted to some extent, such as Teflon (Registered Trademark) or Mylar (Registered Trademark), is suited. In particular, since Teflon and Mylar are chemically inert, they have a high utility value as the spacer 73. However, it is difficult to form a thin film with a thickness of less than or equal to 6 μm by using a plastic resin, and therefore when the thickness of the spacer 73 is less than 6 μm, ductile metal, such as titanium, steel, gold, and copper, may be selected as a material of the spacer 73. When a metallic spacer 73 is used, a surface of the spacer 73 may be inactivated by a plastic resin such as Teflon, an oxide film such as silicon oxide, or the like, if necessary.

(E) in FIG. 10 illustrates a final diagram of the Fabry-Pérot-cavity-type vibrational coupling chemical reaction device 76. Practically, the device is used as a device for promoting a chemical reaction by housing the device in a proper holder including a loading mechanism for cavity length adjustment, and introducing a raw material or discharging a product, through the channel 74.

FIG. 11 is a cross-sectional view Illustrating a process of producing a linear-cavity-type vibrational coupling chemical reaction device according to the example embodiment of the present invention.

(A) in FIG. 11 illustrates a process of preparing a glass tube 80 being an enclosure of a linear cavity. As for a size of the glass tube 80, a diameter of around 1 cm and a length of around 10 cm are sufficient for a small-scale linear cavity. For a large-scale linear cavity, the size is enlarged according to a necessary scale. While soda-lime glass, lead glass, borosilicate glass, quartz glass, sapphire glass, or the like may be used as a material of the glass tube 80, soda-lime glass, lead glass, or borosilicate glass is suited from a viewpoint of ease of melt processing.

(B) in FIG. 11 illustrates a process of filling acid-soluble glass 81 into the glass tube 80. The acid-soluble glass 81 is special glass soluble in hydrochloric acid, nitric acid, sulfuric acid, or the like, and plays a role of preventing the glass tube 80 from internal fusion-bonding in a downstream thinning process. The glass tube 80 is preheated, and then an acid-soluble-glass-filled glass tube 82 is obtained by pouring the melted acid-soluble glass 81 into the glass tube 80.

(C) in FIG. 11 illustrates a process of thinning the acid-soluble-glass-filled glass tube 82. The acid-soluble-glass-filled glass tube 82 is heated at a proper temperature and then drawn in a tube-axis direction, and a thinned acid-soluble-glass-filled glass tube 83 with a diameter of around 100 μm is consequently acquired. The thinned acid-soluble-glass-filled glass tube 83 is cut at certain intervals to be used in a downstream process.

(D) in FIG. 11 illustrates a process of aligning and fusion-bonding the thinned acid-soluble-glass-filled glass tubes 83. The thinned acid-soluble-glass-filled glass tubes 83 are aligned and bundled in such a way that tube axes can be parallel to one another, the thinned to acid-soluble-glass-filled glass tubes 83 can be fusion-bonded with one another by heating at a proper temperature, as a result, a thinned acid-soluble-glass-filled glass tube accumulation 84 is obtained. A thinned acid-soluble-glass-filled glass tube accumulation 84 having a uniform pitch can be acquired by using a glass tube for molding and aligning and fusion-bonding the thinned acid-soluble-glass-filled glass tubes 83 in the tube. Further, a cross-sectional shape of each thinned acid-soluble-glass-filled glass tube constituting the thinned acid-soluble-glass-filled glass tube accumulation 84 is controlled by an alignment method when fusion-bonding is performed. For example, when aligning and fusion-bonding are performed, the sectional shape becomes a regular hexagon when the glass tubes are aligned to be trigonal-lattice-like, and the surface shape becomes a square when the glass tubes are aligned to be tetragonal-lattice-like.

(E) in FIG. 11 illustrates a process of further thinning the thinned acid-soluble-glass-filled glass tube accumulation 84. The thinned acid-soluble-glass-filled glass tube accumulation 84 is drawn in a tube-axis direction by heating at a proper temperature, and a re-thinned acid-soluble-glass-filled glass tube accumulation 85 is consequently acquired. An inside diameter of a re-thinned acid-soluble-glass-filled glass tube constituting the re-thinned acid-soluble-glass-filled glass tube accumulation 85 defines a cavity length. Accordingly, the inside diameter is adjusted in accordance with Equation 21 for each frequency of a vibrational mode of a chemical material used in a chemical reaction. The inside diameter roughly falls within a wavelength range in the infrared region (1 to 100 μm). A cross-sectional shape of a re-thinned acid-soluble-glass-filled glass tube constituting the re-thinned acid-soluble-glass-filled glass tube accumulation 85 can be controlled to performing compression processing from the side in addition to the drawing processing when the heating processing is performed. For example, when a sectional shape of each thinned acid-soluble-glass-filled glass tube constituting the thinned acid-soluble-glass-filled glass tube accumulation 84 undergoing the heating processing is a regular hexagon and only the drawing processing is performed, a cross-sectional shape of a re-thinned acid-soluble-glass-filled glass tube constituting the re-thinned acid-soluble-glass-filled glass tube accumulation 85 inherits a regular hexagon, whereas when compression processing from the side is added to the drawing processing, the cross-sectional shape can be transformed into an isosceles parallelo-hexagon or an inequilateral parallelo-hexagon illustrated in FIG. 8.

(F) in FIG. 11 illustrates a process of coring acid-soluble glass from the re-thinned acid-soluble-glass-filled glass tube accumulation 85. A re-thinned glass tube accumulation 86 is obtained by dipping the re-thinned acid-soluble-glass-filled glass tube accumulation 85 in proper acid such as hydrochloric acid, nitric acid, or sulfuric acid, and dissolving acid-soluble glass into the acid.

(G) in FIG. 11 illustrates a process of forming a mirror plane 87 inside the re-thinned glass tube accumulation 86. Electroless plating is suited for the mirror plane formation. Subsequently to being washed with a proper solvent and undergoing proper preprocessing, the re-thinned glass tube accumulation 86 is dipped into an electroless plating solution. A thickness of the mirror plane 87 is adjusted by a dipping time, and a metal film with a thickness of 5 nm or more is formed. On the other hand, when a material of the glass tube 80 is lead glass, a metal lead thin film can be grown on the inner surface of the re-thinned glass tube accumulation 86 by hydrogen-reducing the tube accumulation in a vacuum, and then the mirror plane 87 can be formed by electroless plating or electrolytic plating with the lead thin film as a foothold. In this case, excellent adhesion between the mirror plane 87 and the inner surface of the glass as well as a uniform mirror plane 87 can be achieved. Additionally, a graphene film or a graphite film may be formed as the mirror plane 87 by liquid phase epitaxy. In this case, liquid metal, such as gallium (Ga), containing carbon is impregnated inside the tube of the re-thinned glass tube accumulation 86 when heating is performed, and a graphene film is grown when cooling is performed. A graphene film and a graphite film excellently adhere to the inner surface of the glass, and a very uniform mirror plane 87 can be acquired. In addition, a protective film is formed on the mirror plane 87, if necessary. A thickness of around 100 μm is sufficient for the protective film. While a material of the protective film depends on a chemical reaction, silicon oxide (SiO₂) being chemically inert is generally used. As the forming method of the protective film, a dry method such as sputter deposition or a wet method such as vitrifying deposition by perhydropolysilazane [(SiH₂—NH—)ₙ] may be used. However, when a graphene film or a graphite film is employed as the mirror plane 87, the graphene film or the graphite film itself is inert to a chemical reaction except for oxidation, and therefore the protective film forming process is unnecessary unless the chemical reaction being used is oxidation. By the processes described above, a linear cavity accumulation 88 is acquired.

As illustrated in (c) in (B) in FIG. 7, by housing the linear cavity accumulation 88 in a proper holder or enclosure including a chamber for mounting the linear cavity accumulation 88, a raw material inlet, and a product outlet, a linear-cavity-type vibrational coupling chemical reaction device is completed.

### EXAMPLES

Examples of the present invention are listed below. [Example 1] to [Example 3] are related to Item (1) described above and describe results of quantitative evaluations of an effect of vibrational coupling on a chemical reaction under a wide range of chemical reaction conditions, based on Equation 17 or 18 being an equation expressing a relative reaction rate constant κ₋/κ₀ under a vibrational coupling.

### Example 1

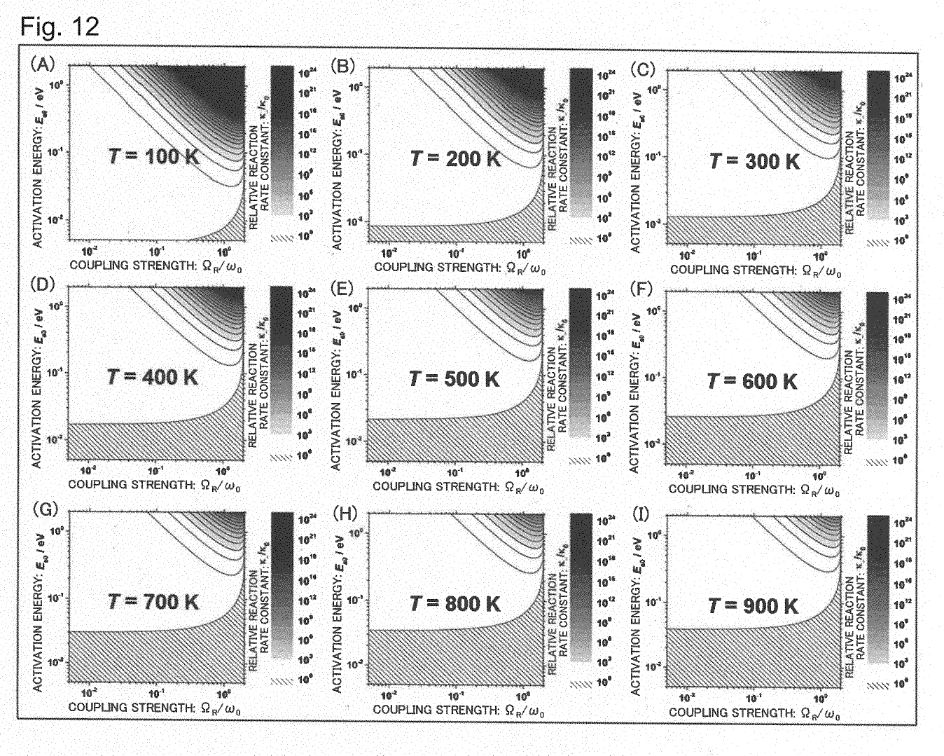

FIG. 12 is a gradation plot of a relative reaction rate constant κ₋/κ₀ under a vibrational coupling based on Equation 18, the plot being drawn with temperature T as a constant, and activation energy Eₐ₀ and a coupling strength Ω_{R}/ω₀ of a vibrational coupling as variables. Temperature T is set in each plot as follows: 100 Kelvin (K) for (A) in FIG. 12, 200 K for (B) in FIG. 12, 300 K for (C) in FIG. 12, 400 K for (D) in FIG. 12, 500 K for (E) in FIG. 12, 600 K for (F) in FIG. 12, 700 K for (C) in FIG. 12, 800 K for (H) in FIG. 12, and 900 K for (I) in FIG. 12. In each plot, the vertical axis indicates activation energy Eₐ₀ and the horizontal axis indicates a coupling strength Ω_{R}/ω₀. Darker gradation represents a larger relative reaction rate constant κ₋/κ₀; and a relative reaction rate constant κ₋/κ₀ is greater than or equal to 10²⁴ in a region in black exhibiting the maximum, greater than or equal to 1 and less than 10 in a region in white, and less than 1 in a region with shaded lines.

From a glance at (A) to (I) in FIG. 12, it is understood that a relative reaction rate constant κ₋/κ₀ takes a larger value in the upper-right corner region. In other words, as activation energy Eₐ₀; increases and a coupling strength Ω_{R}/ω₀ of a vibrational coupling increases, the vibrational coupling further promotes a chemical reaction. Next, viewing in a reverse order from (I) in FIG. 12 to (A) in FIG. 12, a dark-gradated region in the upper-right corner spreads. In other words, it is understood that, as temperature decreases, a vibrational coupling further promotes a chemical reaction. Taking a closer look at FIG. 12, for example, in the case of (A) in FIG. 12. (T=300 K) around room temperature, under the weak coupling condition (Ω_{R}/ω₀<0.01) expressed by Equation 2, a relative reaction rate constant κ₋/κ₀ does not reach 10 at 4.00 electron volts (eV: 386 kJ/mol in SI units, hereinafter the same) being an upper limit of practical activation energy; in other words, significant chemical reaction promotion cannot be expected for a vibrational weak coupling. On the other hand, under the strong coupling condition (0.01≤Ω_{R}/ω₀<0.1) expressed by Equation 3, a relative reaction rate constant κ₋/κ₀ becomes 10² or greater at the same temperature, on condition that Ω_{R}/ω₀≥0.03 and Eₐ₀≥2.00 eV (193 kJ/mol). Furthermore, under the ultra strong coupling condition (0.1≤Ω_{R}/ω₀≤1) expressed by Equation 4, a relative reaction rate constant κ₋/κ₀ becomes 10² or greater at the same temperature at Ω_{R}/ω₀=0.1, even at Eₐ₀=0.700 eV (67.5 kJ/viol), and becomes 1.0³ or greater at Eₐ₀≥1.00 eV (96.5 kJ/mol). When Ω_{R}/ω₀=1 holds under the same condition, a relative reaction rate constant κ₋/ω₀ becomes 10² or greater even at Eₐ₀=0.100 eV (9.65 kJ/mol) being a very small amount of activation energy and becomes 10¹² (a trillion) at Eₐ₀≥1.00 eV (96.5 kJ/mol). That is, when a chemical reaction system is under a vibrational strong coupling or further under a vibrational ultra strong coupling, tremendous chemical reaction promotion can be expected. The remarkable reaction promotion is derived from the coupling strength Ω_{R}/ω₀ term being included in the exponential function part in Equation 17 or 18.

Finally, as a supplement to FIG. 12, when Eₐ₀≤0.04 eV (3.86 kJ/mol) or when roughly Ω_{R}/ω₀>1 holds, a relative reaction rate constant κ₋/κ₀, becomes less than 1. The reason for κ₋/κ₀<1 is that a pre-exponent term (1−½·Ω_{R}/ω₀) exists in Equation 18. Actually, when numerical calculation is performed with Equation 17, which does not have a pre-exponent term, a region in which a relative reaction rate constant κ₋/κ₀ is less than 1 does not appear. In other words, when activation energy Eₐ₀ is extremely small or a coupling strength Ω_{R}/ω₀ is extremely large, decrease by the pre-exponent term (1−½·Ω_{R}/ω₀) in Equation 18 is more than sufficient to cancel increase by the exponent term. Actually, the deep strong coupling system in which Ω_{R}/ω₀>1 holds has not been found, therefore this extreme condition does not need to be considered.

The above findings gained from FIG. 12 are summarized as follows. A vibrational coupling promotes a chemical reaction unless an amount of activation energy Eₐ₀ is extremely small. An effect of reaction promotion becomes more remarkable as activation energy Eₐ₀ increases and a coupling strength Ω_{R}/ω₀ increases. In particular, vibrational strong coupling and a vibrational ultra strong coupling tremendously promote a chemical reaction.

### Example 2

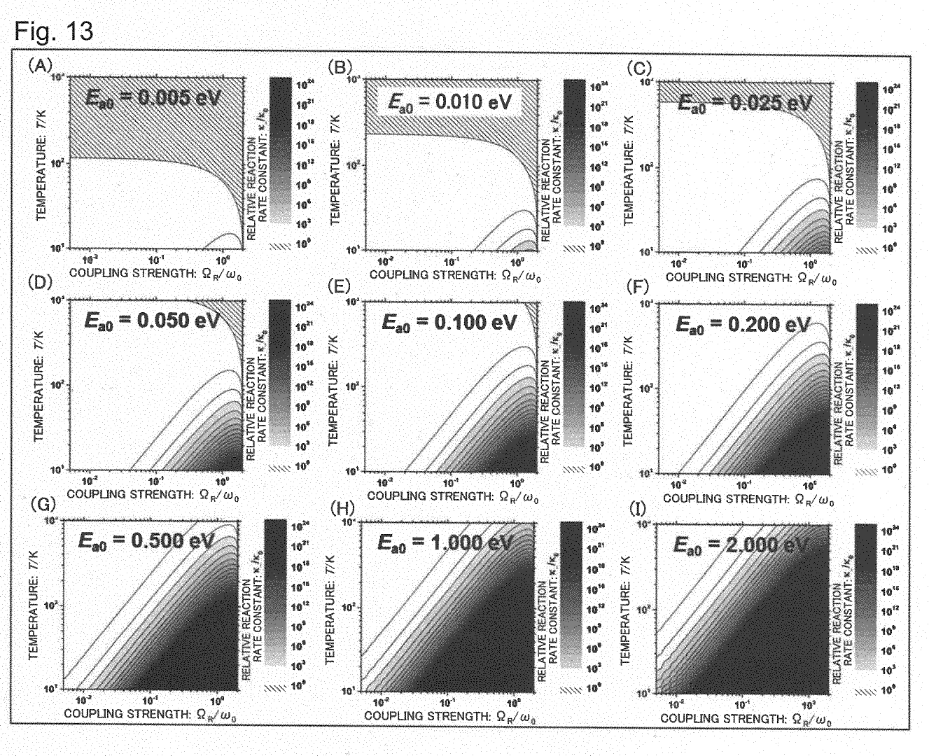

FIG. 13 is a gradation plot of a relative reaction rate constant κ₋/κ₀ under a vibrational coupling, the plot being drawn with activation energy Eₐ₀ as a constant, and temperature T and a coupling strength Ω_{R}/ω₀ of a vibrational coupling as variables. Activation energy Eₐ₀ is set in each plot as follows: 0.005 eV (0.482 kJ/mol) for (A) in FIG. 13, 0.010 eV (0.965 kJ/mol) for (B) in FIG. 13, 0.025 eV (2.41 kJ/mol) for (C) in FIG. 13, 0.050 eV (4.82 kJ/mop for (D) in FIG. 13, 0.100 eV (9.65 kJ/mol) for (E) in FIG. 13, 0.200 eV (19.3 kJ/mol) for (F) in FIG. 13, 0.500 eV (48.2 kJ/moi) for (G) in FIG. 13, 1.000 eV (96.5 kJ/mol) for (H) in FIG. 13, and 2.000 eV (193 kJ/mol) for (I) in FIG. 13. In each plot, the vertical axis indicates temperature T, and the horizontal axis indicates a coupling strength Ω_{R}/ω₀. Definition of shading is the same as FIG. 12.

Viewing (A) in FIG. 13 to (I) in FIG. 13 in this order, a relative reaction rate constant κ₋/κ₀ increases in the lower-right corner region. In other words, it can be understood that, as temperature T decreases and a coupling strength Ω_{R}/ω₀ of vibrational coupling increases, the vibrational coupling further promotes a chemical reaction. Further, viewing from (A) in FIG. 13 to (I) in FIG. 13, a dark-gradated region in the lower-right corner spreads. In other words, it can be understood that as activation energy Eₐ₀ increases, a vibrational coupling further promotes a chemical reaction. Taking a closer look at FIG. 13, when Eₐ₀≤0.025 eV holds in (A) to (C) in FIG. 13, a relative reaction rate constant κ₋/κ₀ becomes less than 1 in a relatively high-temperature region, that is, approximately 100 K or higher in (A) in FIG. 13, approximately 200 K or higher in (B) in FIG. 13, and approximately 550 K or higher in (C) in FIG. 13. Accordingly, when a vibrational coupling is used for chemical reaction promotion, whether or not activation energy Eₐ₀ is extremely small needs to be examined. However, when vibrational coupling is used for delaying a chemical reaction, an extremely small amount of activation energy Eₐ₀ may become an advantage. On the other hand, when Eₐ₀≥0.1.00 eV (9.65 kJ/mol) which is considered to be a common activation energy range of a chemical reaction holds, the region in which a relative reaction rate constant κ₋/κ₀ is less than 1 disappears except for a deep strong coupling region (1<Ω_{R}/ω₀), and chemical reaction promotion by a vibrational coupling is observed, as illustrated in (E) to (I) in FIG. 13. Then, a degree of promotion by a vibrational coupling becomes higher in a strong coupling region (0.01≤Ω_{R}/ω0<0.1) rather than in a weak coupling region (Ω_{R}/ω₀<0.01), in an ultra strong coupling region (0.1≤Ω_{R}/ω₀≤1) rather than in the strong coupling region, and in the deep strong coupling region rather than in the ultra strong coupling region. In particular, a chemical reaction is literally phenomenally likely to progress in the strong coupling region and the ultra strong coupling region.

The above findings acquired from FIG. 13 are summarized as follows. A vibrational coupling promotes a chemical reaction unless an amount of activation energy Eₐ₀ is extremely small. When an amount of activation energy Eₐ₀ is small, increasing a coupling strength Ω_{R}/ω₀ as much as possible may be cited as an operation guideline of chemical reaction promotion by a vibrational coupling. An effect of reaction promotion becomes more remarkable as an amount of activation energy Eₐ₀ increases and a coupling strength Ω_{R}/ω₀ increases. In particular, a vibrational strong coupling and a vibrational ultra strong coupling phenomenally promote a chemical reaction.

### Example 3

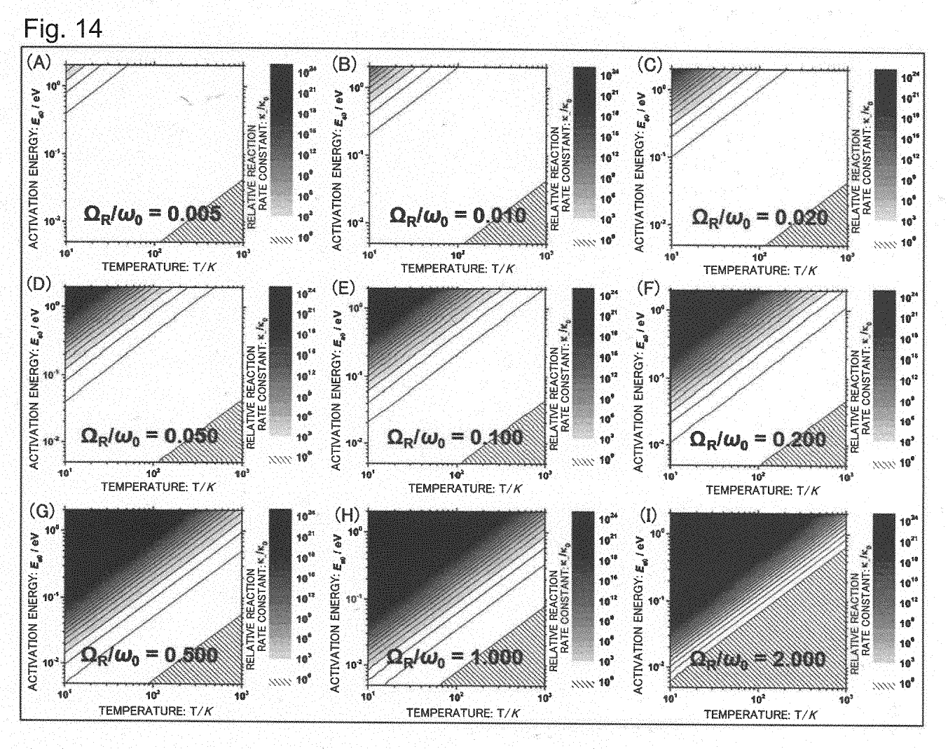

FIG. 14 is a gradation plot of a relative reaction rate constant κ₋/κ₀ under a vibrational coupling, the plot being drawn with a coupling strength Ω_{R}/ω₀ of a vibrational coupling as a constant, and activation energy Eₐ₀ and temperature T as variables. A coupling strength Ω_{R}/ω₀ of a vibrational coupling is set in each plot as follows: 0.005 for (A) in FIG. 14, 0.010 for (B) in FIG. 14, 0.020 for (C) in FIG. 14, 0.050 for (D) in FIG. 14, 0.100 for (E) in FIG. 14, 0.200 for (F) in FIG. 14, 0.500 for (G) in FIG. 14, 1.000 for (H) in FIG. 14, and 2.000 for (I) in FIG. 14. In each plot, the vertical axis indicates activation energy Eₐ₀, and the horizontal axis indicates temperature T. Definition of shading is the same as FIG. 12.

An overall tendency in (A) to (I) in FIG. 14 is that a region in which a relative reaction rate constant κ₋/κ₀ takes a larger value appears in the upper-left corner and a region in which a relative reaction rate constant κ₋/κ₀ is less than 1 appears in the lower-right corner. In other words, as activation energy Eₐ₀ increases and temperature T decreases, an effect of chemical reaction promotion by a vibrational coupling increases; and when an amount of activation energy Eₐ₀ is extremely small and temperature T is extremely high, a vibrational coupling delays a chemical reaction. Further, gradation in the upper-left corner in (A) to (I) in FIG. 14 becomes darker in this order. The above implies that as a coupling strength Ω_{R}/ω₀, of a vibrational coupling increases, a relative reaction rate constant κ₋/κ₀ increases, that is, chemical reaction promotion by the vibrational coupling increases. Taking a closer look at FIG. 14, under the weak coupling condition (Ω_{R}/ω₀<0.01), a relative reaction rate constant Kr/κ₀ becomes 10 or greater only at or below 100 K when E_{A}≤2 eV (193 kJ/mol) holds, as illustrated in (A) and (B) in FIG. 14. In other words, in the weak coupling region, an effect of a vibrational coupling can be expected only under a condition that temperature T is extremely low or an amount of activation energy Eₐ₀ is extremely high. On the other hand, under the strong coupling condition (0.01≤Ω_{R}/ω₀<0.1) and under a condition that T=300 K and Eₐ₀=1 eV (96.5 kJ/mol), a relative reaction rate constant κ₋/κ₀ becomes 10 or greater when, for example, Ω_{R}/ω₀=0.050 holds as indicated in (D) in FIG. 14. Namely, under the strong coupling condition, an effect of chemical reaction promotion by a vibrational coupling can be sufficiently observed. Furthermore, under the ultra strong coupling condition (0.1≤Ω_{R}/ω_{0≤}1) and under a condition of T=300 K and Eₐ₀=1 eV, a relative reaction rate constant κ₋/ω₀ becomes 10³ or greater when, for example, Ω_{R}/ω₀=0.200 holds as indicated in (F) in FIG. 14, a relative reaction rate constant κ₋/ω₀ becomes 10⁶ (a million) or greater when Ω_{R}/ω₀=0.500 holds as indicated in (H) in FIG. 14, a relative reaction rate constant κ₋/κ₀ becomes 10¹² (a trillion) or greater when Ω_{R}/ω₀=2.000 holds as indicated in (I) in FIG. 14. In other words, use of a vibrational coupling under the ultra strong coupling condition provides a remarkable effect on chemical reaction promotion.

The above findings obtained from FIG. 14 are summarized as follows. An effect of a vibrational weak coupling is limited when chemical reaction promotion is considered to be a purpose. On the other hand, a sufficient effect on chemical reaction promotion can be expected from vibrational strong coupling even around room temperature. In particular, vibrational ultra strong coupling provides an all the more remarkable effect.

[Example 4] to [Example 6] are related to Item (2) described above and describe production of a vibrational coupling chemical reaction device and results of basic performance evaluations of the device. Then, basic characteristics of a vibrational coupling required for production of a desired chemical material by the vibrational coupling chemical reaction device, that is, concentration dependence of a coupling strength, relative concentration dependence of a relative reaction rate constant under a vibrational coupling, optical mode number dependence of Rabi splitting energy, and the like will be discussed with a particular emphasis on results acquired by experiments using the vibrational coupling chemical reaction device.

### Example 4

A vibrational coupling chemical reaction device was produced by the means discussed in Description of Production Method. A brief description is as follows. Zinc selenide (ZnSe) being transparent in an infrared region was employed as a substrate in such a way that a finished product of the vibrational coupling chemical reaction device can be evaluated by a Fourier-transform infrared absorption spectroscopy (FT-IR) device. Two ZnSe substrates were prepared, and both were optically polished and washed by a proper method, and subsequently, gold was sputter-deposited in a vacuum with a thickness of 10 nm. Then, in order to prevent the gold thin film from contacting a chemical material, a 100 nm SiO₂ layer was formed on each of the two gold/ZnSe substrates. As the formation method of the SiO₂ protective film, a method of first applying a 5% xylene solution of perhydropolysilazane [(—SiH₂—NH—)ₙ] to the gold/ZnSe substrates, drying by 100° C. heating, then promoting a chemical reaction of (—SiH₂—NH—)ₙ+2nH₂O→(SiO₂)ₙ+nNH₃+2nH₂ by ultraviolet irradiation, and finally, completing transformation into quartz (transformation into SiO₂) by 250° C. heating was used. Finally, a Fabry Pérot cavity was formed by laying the two SiO₂/gold/ZnSe substrates on top of another, sandwiching a spacer made of plastic resin such as Teflon or Mylar. The completed Fabry-Pérot cavity, was housed in a holder including a mechanism capable of applying uniform pressure on the two SiO₂/gold/ZnSe substrates, and then a vibrational coupling chemical reaction device was completed. A cavity length was roughly defined by a thickness of the spacer, and fine adjustment was performed by the loading mechanism in the holder.

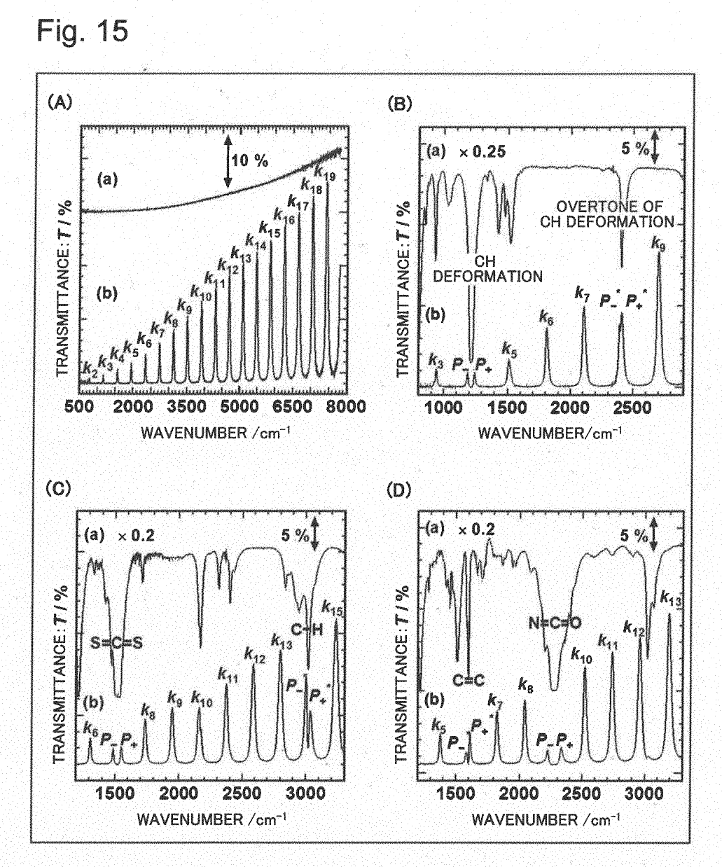

(A) in FIG. 15 illustrates a relation between a transmittance and a wavenumber of a vibrational coupling chemical reaction device in which a cavity is filled with air, the device being produced by the method described above. Note that (a) illustrates wavelength dependence of a net transmittance possessed by two SiO₂/gold/ZnSe substrates in a case that a resonance condition is not satisfied, whereas (b) illustrates a case that the resonance condition is satisfied, and tells that many optical modes ranging from the second optical mode to the nineteenth optical mode regularly stand side by side by confinement of an opto-electrical field. A peak height becomes higher from a lower wavenumber toward a higher wavenumber.

The reason for increase in a difference between transmission and absorption of light is that an opto-electrical field confinement effect increases on the higher wavenumber side, and this is a property inherent to a Fabry-Pérot cavity.

Table 2 lists optical characteristics related to the vibrational coupling chemical reaction device as a Fabry-Pérot cavity. Referring to Table 2, a free spectral range k₀ is nearly constant between respective optical modes and an average value thereof is 391.82 cm⁻¹. By substituting the value and the refractive index of air being 1 into Equation 21, a cavity length t becomes 12.76 μm. The thickness of the spacer used was 10 μm, and therefore t=12.76 μm is somewhat longer than the spacer thickness. When a loading mechanism of a holder was used in a separate experiment, the cavity length t was variable in a range of (spacer thickness+3.5 μm±2.5 μm, and fine adjustment could be performed on a target wavenumber at ±1 cm⁻¹ accuracy. Further, a Q factor gradually increased from Q=57.22 at the second optical mode, took a maximum value, Q=125.9, at the sixteenth optical mode, and then, gradually decreased; and an average value was 103.0. Since the value greatly exceeds a Q factor required for vibrational coupling being Q=20, the vibrational coupling chemical reaction device exhibits a sufficient capability of opto-electrical field confinement. Next, a performance test was done with the vibrational coupling chemical reaction device filled with a chemical material. The result will be discussed below.

TABLE 2
Optical characteristics related to the vibrational coupling chemical
reaction device as a Fabry-Perot cavity

| | Wavenumber | | | |
|---|---|---|---|---|
| Optical | of optical | Free spectral | Half width: | |
| mode | modes: kᵢ | range: kₒ | Δkᵢ | |
| number: i | [cm⁻¹] | [cm⁻¹] | [cm⁻¹] | Q factor |
| 2 | 783.855 | 391.49 | 13.70 | 57.22 |
| 3 | 1175.35 | 391.71 | 15.77 | 74.53 |
| 4 | 1567.05 | 391.87 | 18.28 | 85.72 |
| 5 | 1958.92 | 391.69 | 20.82 | 94.09 |
| 6 | 2350.61 | 391.77 | 23.08 | 101.8 |
| 7 | 2742.38 | 391.88 | 25.60 | 107.1 |
| 8 | 3134.26 | 391.77 | 28.13 | 111.4 |
| 9 | 3526.03 | 391.71 | 30.53 | 115.5 |
| 10 | 3917.74 | 391.90 | 33.00 | 118.7 |
| 11 | 4309.64 | 391.92 | 35.73 | 120.6 |
| 12 | 4701.56 | 392.23 | 38.35 | 122.6 |
| 13 | 5093.21 | 392.08 | 40.90 | 124.5 |
| 14 | 5485.44 | 392.08 | 43.90 | 125.0 |
| 15 | 5877.52 | 391.89 | 46.85 | 125.5 |
| 16 | 6269.41 | 392.18 | 49.78 | 125.9 |
| 17 | 6661.59 | 392.36 | 53.33 | 124.9 |
| 18 | 7053.95 | 392.38 | 57.01 | 123.7 |
| 19 | 7446.33 | — | 62.77 | 118.6 |
| Averaged | 4114.15 | 391.82 | 35.42 | 103.0 |

(B) to (D) in FIG. 15 illustrate a relation between a transmittance and a wavenumber of the vibrational coupling chemical reaction device to which a chemical material is introduced. (B) in FIG. 15 depicts a transmittance infrared spectrum when introducing pure chloroform, (C) in FIG. 15 shows a transmittance infrared spectrum when introducing a chloroform solution of 1.00 M-carbon disulfide (CS₂), and (D) in FIG. 15 represents a transmittance infrared spectrum when introducing a chloroform solution of 1.00 M-phenyl-isocyanate (Ph-N═C═O), respectively. Further, in each diagram in (B) to (D) in FIG. 15, while (a) represents a case that a resonance condition is not satisfied, (b) represents a case that the resonance condition is satisfied. Accordingly, while (a) exhibits an infrared absorption spectrum of a normal chemical material, (b) exhibits a superimposition of infrared absorption spectra of an optical mode of the Fabry-Pérot cavity, a chemical material, and a light-matter hybrid obtained by vibrationally coupling an optical mode with a vibrational mode of the chemical material. Each diagram in (B) to (D) in FIG. 15 will be discussed in detail below.

In the case of (b) in (B) in FIG. 15, by fine adjustment of a cavity length t, a fundamental tone (vibrational quantum number 0→1 transition) of a C—H deformation vibrational mode of chloroform observed at about 1216 cm⁻¹ was vibrationally coupled with the fourth optical mode. Consequently, the fundamental tone was Rabi-split into a lower branch P₋ state and an upper branch P₊ state. A discrepancy between wavenumbers of the vibrational mode and the optical mode was within ±1 cm⁻¹ and nearly perfect resonance was acquired. In addition, by coincidence, a o (vibrational quantum number 0→2 transition) of the C—H deformation vibration of chloroform observed near 2406 cm⁻¹ was vibrationally coupled with an eighth optical mode, consequently Rabi-splitting into a lower branch P₋* state and an upper branch P₊* state. A coupling strength Ω_{R}/ω₀ of the fort was 0.0451 and the latter was 0.0124, and referring to Equation 3, both were strong couplings (0.01≤Ω_{R}/ω₀<0.1). The reason why the value of the latter is significantly smaller than the value of the former is that, in general, a transition dipole moment d of an overtone mode is an order of magnitude less than that of a fundamental mode. An average value of a free spectral range k₀ was 299.3 cm⁻¹, and substituting this value and the refractive index of chloroform, n=1.434, into Equation 21, yields a cavity length t of 11.64 μm. Further, the Q factor was 75.02 at the seventh optical mode near 2108 cm⁻¹, and therefore a sufficient opto-electrical field confinement capability was exhibited. Furthermore, when an FT-IR measurement was performed 8 hours after introduction of chloroform, the infrared absorption spectrum measured 8 hours later was almost identical to that measured immediately after the introduction, meaning that the vibrational coupling chemical reaction device has not only optical rigidity for keeping a resonance condition constant for a long time, but also air-tightness for preventing transpiration of volatile chloroform.

In the case of (b) in (C) in FIG. 15, by fine adjustment of the cavity length t, a vibrational mode of S═C═S anti-symmetric stretching at about 1519 cm⁻¹ was vibrationally coupled with the seventh optical mode, consequently being caused to Rabi-split into a lower branch P₋ state and an upper branch P₊ state. A discrepancy between wavenumbers of the vibrational mode and the optical mode was within ±1 cm⁻¹ and nearly perfect resonance was achieved. In addition, by coincidence, a vibrational mode of CH stretching of chloroform near 3017 cm⁻¹ was vibrationally coupled with the fourteenth optical mode, consequently Rabi-splitting into a lower branch P₋* state and an upper branch P₊* state. A coupling strength Ω_{R}/ω₀ of the former was 0.0414 and the latter was 0.0111, and referring to Equation 3, both were strong couplings. The reason why a coupling strength (Ω_{R}/ω₀=0.110 of the chloroform-derived C—H stretching vibration is significantly smaller than a coupling strength (Ω_{R}/ω₀=0.414) of the carbon-disulfide-derived S═C═S stretching vibration, despite a chloroform concentration being 11.65 M, which is nearly 12 times denser than carbon disulfide, is that a transition dipole moment d of a single bond (C—H) is generally smaller by a single digit or more compared with a double bond (S═C═S), as indicated in Table 1. An average value of the free spectral range k₀ was 217.02 cm⁻¹ and substituting this value and the refractive index of chloroform, n=1.434, into Equation 21 yields a cavity length t of 16.07 μm. Further, the Q factor was 74.84 at a ninth optical mode near 1947 cm⁻¹, and therefore a sufficient opto-electrical field confinement capability was exhibited.

In the case of (b) in (D) in FIG. 15, by fine adjustment of the cavity length t, a vibrational mode of N═C═O anti-symmetric stretching of phenyl isocyanate observed near 2272 cm⁻¹ was vibrationally coupled with the ninth optical mode, consequently being caused to Rabi-split into a lower branch P₋ state and an upper branch P₊ state discrepancy between wavenumbers of the vibrational mode and the optical mode was within ±1 cm⁻¹ and nearly perfect resonance was acquired. In addition, by coincidence, a skeletal vibration (C═C) of a benzene ring in phenyl isocyanate observed near 1600 cm⁻¹ was vibrationally coupled with the sixth optical mode, consequently Rabi-splitting into a lower branch P₋* state and an upper branch P₊* state. A coupling strength Ω_{R}/ω₀ of the former was 0.0480 and the latter was 0.0168, and referring to Equation 3, both were strong couplings. The reason why the value of the latter is significantly smaller than the value of the former is that the vibrational mode of the N═C═O stretching has a huge transition dipole moment d, as indicated in Table 1. An average value of the free spectral range k₀ was 227.08 cm⁻¹ and substituting this value and the refractive index of chloroform, n=1.434, into Equation 21 yields a cavity length t of 15.35 μm. Further the Q factor was 96.27 at an eighth optical mode near 2043 cm⁻¹, and therefore a sufficient opto-electrical field confinement capability was achieved.

On the basis of the results discussed above, the vibrational coupling chemical reaction device in the examples of the present invention has been demonstrated to possess a function as a cavity with a precision level for adjusting a resonance condition required for a vibrational coupling with an accuracy of ±1 cm⁻¹, together with not only optical rigidity which lasts a minimum of 8 hours, but also a function as a chemical reaction container keeping a volatile chemical material air-tightly for a minimum of 8 hours.

### Example 5

In this example, examination results of concentration dependence of a coupling strength Ω_{R}/ω₀ by use of the vibrational coupling chemical reaction device acquired in [Example 4] will be discussed.

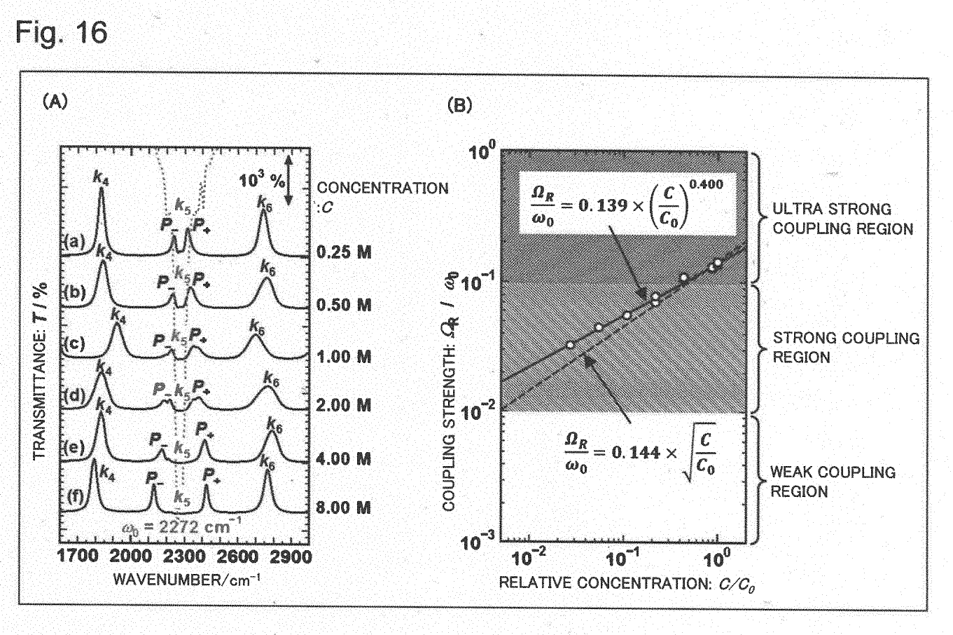

(A) in FIG. 16 illustrates infrared transmittance spectra when a vibrational mode (ω₀=2272 cm⁻¹) of N═C═O anti-symmetric stretching of phenyl isocyanate is vibrationally coupled with a fifth optical mode (k₅=5k₀=2272 cm⁻¹), consequently being caused to Rabi-split into a P₋ state and a P₊ state, with respect to chloroform solutions of phenyl isocyanate at various concentrations. A concentration C is set to 0.25 M in (a), 0.50 M in (b), 1.00 M in (c), 2.00 M in (d), 4.00 M in (e), and 8.00 M (f), respectively. As a concentration becomes higher, an energy difference between the P₋ state and the P₊ state, that is, Rabi splitting energy hΩ_{R}, gradually increases. Referring to the theoretical formula in Equation 1, Rabi splitting energy hΩ_{R} is anticipated to be proportional to the square root of the concentration C. When a coupling strength Ω_{R}/ω₀ is used in place of Rabi splitting energy hΩ_{R}, the theoretical anticipation is expressed as Ω_{R}/ω₀ ∝C^{0.5}. Concentration dependence of a coupling strength Ω_{R}/ω₀ illustrated in (B) in FIG. 16 is for examining whether or not the expression is experimentally reasonable. Note that a concentration on the horizontal axis is normalized by the molarity of pure phenyl isocyanate, C₀=9.17 M, and is expressed as a relative concentration C/C₀. When the measured values acquired from (A) in 16 are plotted, the theoretical anticipation Ω_{R}/ω₀ ∝C^{0.5} did not fit very well, and experimentally, Ω_{R}/ω₀ ∝C⁴ fitted well. The reason for the difference between the theory and the experiment is presumed to be related to the fact that, while a Jaynes-Cummings model giving Equation 1 employs rotating wave approximation, the rotating wave approximation gradually collapses from the strong coupling region (0.01≤Ω_{R}/ω₀<0.1) in Equation 3 toward the ultra strong coupling region (0.1≤Ω_{R}/ω₀≤1) in Equation 4. The experimental result is important in suggesting a need for a new physical law describing the vibrational strong coupling and the vibrational ultra strong coupling. Referring to (B) in FIG. 16 again, when the experimental equation Ω_{R}/ω₀ ∝C^{0.4} is extrapolated on the lower-concentration side, phenyl isocyanate transitions from the weak coupling region to the strong coupling region near C=10⁻³ M and reaches the ultra strong coupling region around C=4 M. This characteristic is derived from the vibrational mode of N═C═O of phenyl isocyanate having a huge dipole moment of d=0.555 D, as indicated in Table 1. Further, it is certain that a coupling strength Ω_{R}/ω₀ is an increasing function with a concentration C as a variable, and as will be discussed in detail in next [Example 6], increasing a concentration C is one of the most effective means of accelerating a chemical reaction by a vibrational coupling.

As discussed above, it has been clarified as a basic finding useful in producing a desired chemical material by the vibrational coupling chemical reaction device that, while concentration dependence of a coupling strength is theoretically expressed as Ω_{R}/ω₀ ∝C^{0.5}, the dependence is experimentally expressed as Ω_{R}/ω₀∝C^{0.4}.

### Example 6

In this example, results of analyzing concentration dependence of a relative reaction rate constant κ₋/κ₀, based on Equation 17, will be discussed.

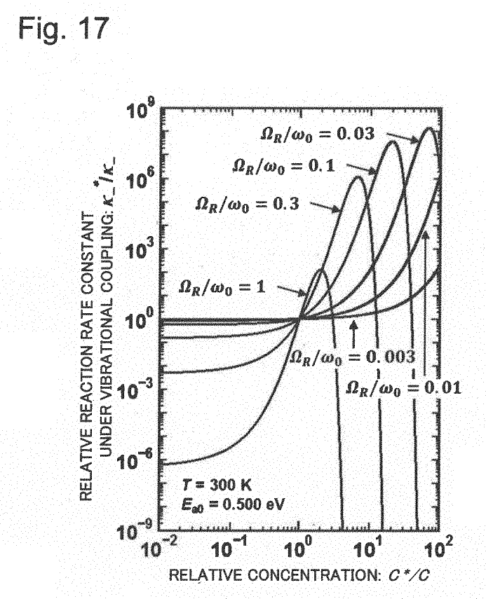

FIG. 17 illustrates a relation between a ratio between a reaction rate constant κ₋ under a vibrational coupling at a concentration C and a reaction rate constant κ₋* under a vibrational coupling at a concentration C*, and a relative concentration C*/C. Note that temperature T and activation energy Eₐ₀ were fixed at 300 K and 0.5 eV, respectively, and cases of a coupling strength Ω_{R}/ω₀ being 0.003, 0.01, 0.03, 0.1, 0.3, and 1 were calculated. In the case of Ω_{R}/ω₀=0.003 being the weak coupling condition (Ω_{R}/ω₀<0.01) expressed by Equation 2, one hand, a reaction rate constant hardly change even when a concentration is diluted 100 times, on the other hand, the reaction rate constant does not reach double the number even when the concentration is increased by 10 times, and the reaction rate constant finally increases by approximately 100 times when the concentration is increased by 100 times. In the case of the strong coupling condition (0.01≤Ω_{R}/ω₀<0.1) expressed by Equation 3, when a concentration is in a range of 10⁻²≤C*/C≤10⁰, that is, the concentration is diluted 100 times, κ₋*/κ₋ is mostly kept at 1, whereas when the concentration increases, a reaction rate constant increases exponentially. For example, for Ω_{R}/ω₀=0.01, κ₋*/κ₋≈10 when C*/C=10 and κ₋*/κ₋≈10⁶ when C*/C=10², and for Ω_{R}/ω₀=0.03, κ₋*/κ₋10³ when C*/C=10 and κ₋*/κ₋≈10⁶ when C*/C=10². In the case of Ω_{R}/ω₀=0.03, κ₋*/κ₋ turns from increase to decrease around a point where the relative concentration C*/C exceeds 60. The reason is that strong coupling turned to an ultra strong coupling and further to a deep strong coupling with increase of the concentration. When the ultra strong coupling condition (0.1≤Ω_{R}/ω₀≤1) expressed by Equation 4 is satisfied, decrease of starts to enter into a range of 10⁻²≤C*/C≤10⁰. For example, at C*/C=10⁻², κ₋*/κ₋≈0.2 when Ω_{R}/ω₀=0.1, κ₋*/κ₋≈5×10⁻² when Ω_{R}/ω₀=0.3, and κ₋*/κ₋≈10⁻⁶ when Ω_{R}/ω₀=1. On the other hand, when a concentration increases under the ultra strong coupling condition, a rising edge of increase, becomes steeper as the coupling strength Ω_{R}/ω₀ increases; however, a relative concentration C*/C at which increase turns to decrease lowers. The reason is that, as a coupling strength Ω_{R}/ω₀ increases, the deep strong coupling condition becomes more likely to be satisfied. However, under the ultra strong coupling condition, a reaction rate constant reaches a maximum of approximately 5×10⁷ times when Ω_{R}/ω₀=0.1, approximately 10⁶ times when Ω_{R}/ω₀=0.3, and approximately 10² times when Ω_{R}/ω₀=1. From the results discussed above, it is proven that increasing a concentration of a chemical material is effective as a means of increasing a reaction rate constant under a vibrational coupling, unless a deep strong coupling is entered. In particular, concentration increase brings about a remarkable effect on a vibrational strong coupling and a vibrational ultra strong coupling.

### Example 7

In this example, examination results of optical mode dependence of a coupling strength Ω_{R}/ω₀ by use of the vibrational coupling chemical reaction device acquired in [Example 4] will be discussed.

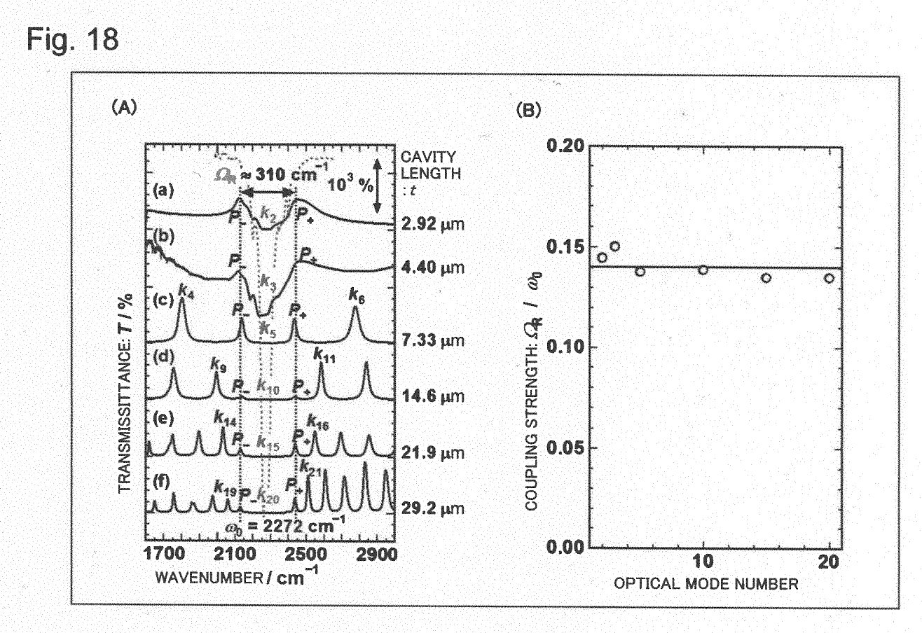

(A) in FIG. 18 illustrates infrared transmitted spectra when a vibrational mode (ω₀=2272 cm⁻¹) of N═C═O anti-symmetric stretching of pure phenyl isocyanate was vibrationally coupled with various optical modes, consequently being caused to Rabi-split into a P₋ state and a P₊ state. The spectra represent the vibrational coupling of the N═C═O vibrational mode and the following optical mode, respectively: (a) the second optical mode (k₂=2k₀=2272 cm⁻¹, a cavity length: t=2.92 μm), (b) the third optical mode (k₃=3k₀=2272 cm⁻¹, the cavity length: t=4.40 μm), (c) the fifth optical mode (k₅=5k₀=2272 cm⁻¹, the cavity length: t=7.33 μm), (d) the tenth optical mode (k₁₀=10k₀=2272 cm⁻¹, the cavity length: t=14.6 μm), (e) the fifteenth optical mode (k₁₅=15k₀=2272 cm⁻¹, the cavity length: t=21.9 μm), and (f) the twentieth optical mode (k₂₀=20k₀=2272 cm⁻¹, the cavity length: t=29.2 μm). Within a range of the examined optical modes, Rabi splitting energy Ω_{R} is constant at approximately 310 cm⁻¹ using a wavenumber as a unit, independent of an optical mode. (B) in FIG. 18 illustrates the independence as a relation between a coupling strength Ω_{R}/ω₀ and an optical mode number m. Within a range of 2≤m≤20, a coupling strength Ω_{R}/ω₀ takes a constant at Ω_{R}/ω₀=0.140, independent of an optical mode number m, as expected. As such, an optical mode required for performing vibrational coupling can be freely selected from at least up to the twentieth optical mode.

[Example 8] to [Example 11] are related to item (3) described above and describe results of actually producing a desired material by use of the vibrational coupling chemical reaction promotion device produced in [Example 4], on the basis of a chemical reaction under a vibrational coupling quantified in [Example 1] to [Example 3].

### Example 8

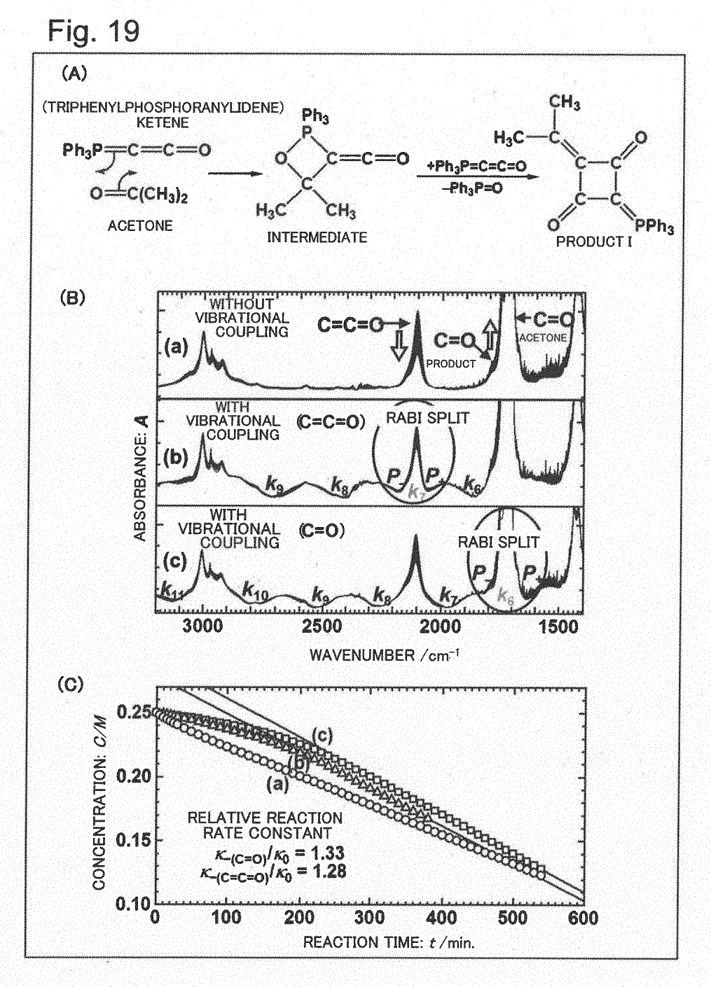

In this example, an experimental result proving that a product I [see (A) in FIG. 19 for a structure] being a target material can be produced with an accelerated reaction rate by using a vibrational coupling chemical reaction device produced by the means described in Description of Production Method, with respect to a chemical reaction with (triphenylphosphoranylidene) ketene (Ph₃P═C═C═O) and acetone [(CH₃)₂C═O] as raw materials, the chemical reaction being illustrated in (A) in FIG. 19, will be discussed.

Experimental conditions are as follows.

Every experiment was performed at room temperature (T=300 K) and (triphenylphosphoranylidene) ketene was metered to be an acetone solution with a concentration of 0.250 M. An acetone concentration was 13.6 M and is overly excessive against (triphenylphosphoranylidene) ketene. For the absence of a vibrational coupling, an experiment was performed in a non-resonant condition by use of a chemical reaction device without mirror planes produced by the means described in Description of Production Method. For the presence of a vibrational strong coupling, a chemical reaction device with mirror planes produced by the means described in Description of Production Method was used, and an optical mode was coupled with a vibrational mode by strictly adjusting a cavity length. Two kinds of vibrational couplings, a C═O resonance and an S═C═S resonance, were examined. For the vibrational coupling of the C═O resonance, when the sixth optical mode (k₆=6k₀=1712 cm⁻¹) of a cavity with a cavity, length of t=12.38 μm was resonantly coupled with a C═O stretching vibrational mode (vibrational quantum number 0→1 transition: 1712 cm⁻¹) of acetone, the coupling strength was Ω_{R}/ω₀=0.0644 and the Q factor was Q=13.37. For the vibrational coupling of the C═C═O resonance, when the seventh optical mode (k₇=7k₀=2100 cm⁻¹) of a cavity with a cavity length of t=11.58 pin was resonantly coupled with a C═C═O anti-symmetric stretching vibrational mode (vibrational quantum number 0→1 transition: 2100 cm⁻¹) of (triphenylphosphoranylidene) ketene, the coupling strength was Ω_{R}/ω₀=0.0614 and the Q factor was Q=13.79. Both vibrational couplings belong to the strong coupling (0.01≤Ω_{R}/ω₀<0.1) expressed by Equation 3. Since activation energy of the chemical reaction in (A) in FIG. 19 is in a range of Eₐ₀=0.10 to 0.20 eV, a relative reaction rate constant is predicted to be in a range of 1.2<κ₋/κ₀<1.6 using Equation 17 or 18.

In order to determine a reaction rate constant, infrared absorption spectra were measured at regular time intervals with an FT-IR instrument. For the absence of a vibrational coupling, a temporal change in concentration was directly determined from a temporal change in absorbance for the C═C═O infrared absorption band of (triphenylphosphoranylidene) ketene. Meanwhile, for the presence of a vibrational coupling, an absorbance of an infrared absorption band of (triphenylphosphoranylidene) ketene was extracted by performing waveform separation on the measured infrared spectrum consisting optical and vibrational modes using a suitable spectral function such as the Lorentz function or the inverse Lorentz function, and then the extracted temporal change in absorbance was used for determining a temporal change in concentration. When estimating a reaction rate constant, a reaction profile was analyzed by fitting to the zeroth-order rate equation, C=κt+C₀, where t: concentration, C₀: initial concentration, κ: reaction rate constant, and t: time. A reaction rate constant in the vibrational coupling of the C═O resonance is denoted as κ_{-(C═O)} and a reaction rate constant in the vibrational coupling of the C═C═O resonance is denoted as κ_{-(C═c═O)}, and respective ratios to a reaction rate constant κ₀ without a vibrational coupling were derived as relative reaction rates κ_{-(C═O)}/κ₀ and κ_{-(C═C═O)}/κ₀.

Experimental results are as follows.

(B) in FIG. 19 illustrates temporal changes of infrared absorption spectra in the chemical reaction illustrated in (A) in FIG. 19, and (a) represents a spectral change without a vibrational coupling, (b) represents a spectral change with a vibrational coupling of the C═C═O resonance, and (c) represents a spectral change with a vibrational coupling of the C═O resonance. In (a), normal infrared absorption spectra are observed since any optical modes do not exist, whereas in (b) and (c), spectral features are complicated since absorptions of optical modes (k₆, k₇, k₈, . . . , k₁₁, and the like) and vibrational modes (such as the C═C═O vibration, a C═O vibration of a product, and the C═O vibration of acetone) are superposed on one another. Taking a closer look, as a reaction progresses in (a), an absorption of the C═C═O vibration (2100 cm⁻¹) of (triphenylphosphoranylidene) ketene being a raw material decreases, while an absorption of the C═O vibration (near 1800 cm⁻¹) of the product I increases, as indicated by outlined arrows. As indicated by circles, it is observed in (b) that the C═O vibrational mode of acetone is vibrationally coupled with the sixth optical mode at 1712 cm⁻¹ in wavenumber, resulting in Rabi-splitting into an upper branch and a lower branch. On the other hand, it is observed in (c) that the C═C═O vibrational mode of (triphenylphosphoranylidene) ketene is vibrationally coupled with the seventh optical mode at 2100 cm⁻¹ in wavenumber, resulting in Rabi-splitting into an upper branch and a lower branch. Further, although superposition with optical and vibrational modes exists in both (b) and (c), their increases and decreases in absorption for vibrationally uncoupled modes are similar to that of (a) and their decreases in absorption for vibrationally coupled modes are also observed.

(C) in FIG. 19 illustrates relations between concentrations and reaction time determined from temporal changes in absorbance shown in (B) in FIG. 19, and (a), (b), and (c) represent a reaction profile without a vibrational coupling (plotted with circle marks, ∘), a reaction profile with a vibrational coupling of the C═C═O resonance (plotted with triangle marks, Δ), and a reaction profile with a vibrational coupling of the C═O resonance (plotted with square marks, □), respectively. Reaction rate constants are determined from slopes of respective fitting lines in (a), (b), and (c) as follows: κ₀=3.81×10d⁶ M·s⁻¹ for the absence of a vibrational coupling, κ_{-(C═C═O)}=4.86×10⁻¹ MΩs⁻¹ for the presence of the vibrational coupling of the C═C═O resonance, and κ_{-(C═O)}=5.04×10⁻⁶ M·s⁻¹ for the presence of the vibrational coupling of the C═O resonance. Relative reaction rate constants are determined from these values as follows: κ_{—(C═O)}/κ₀=1.33 for the vibrational coupling of the C═O resonance and k_{—(C═C═O)}/κ₀=1.28 for the vibrational coupling of the C═C═O resonance. As such, chemical reaction promotion is actually observed in both the vibrational coupling of the C═O resonance and the vibrational coupling of the C═C═O resonance, and both of the relative reaction rate constants are within the range (1.2<κ₋/κ₀<1.6) as predicted by use of Equation 1.7 or 18.

It is thus proven from the experimental results described above that a purpose of opto-electrical field confinement is compatible with a purpose of performing a chemical reaction in a chemical reaction device produced by the method described in Description of Production Method, a vibrational coupling promotes a chemical reaction as predicted by use of Equation 1.7 or 18, and the chemical reaction device produced by the method described in Description of Production Method can actually produce a target chemical material.

### Example 9

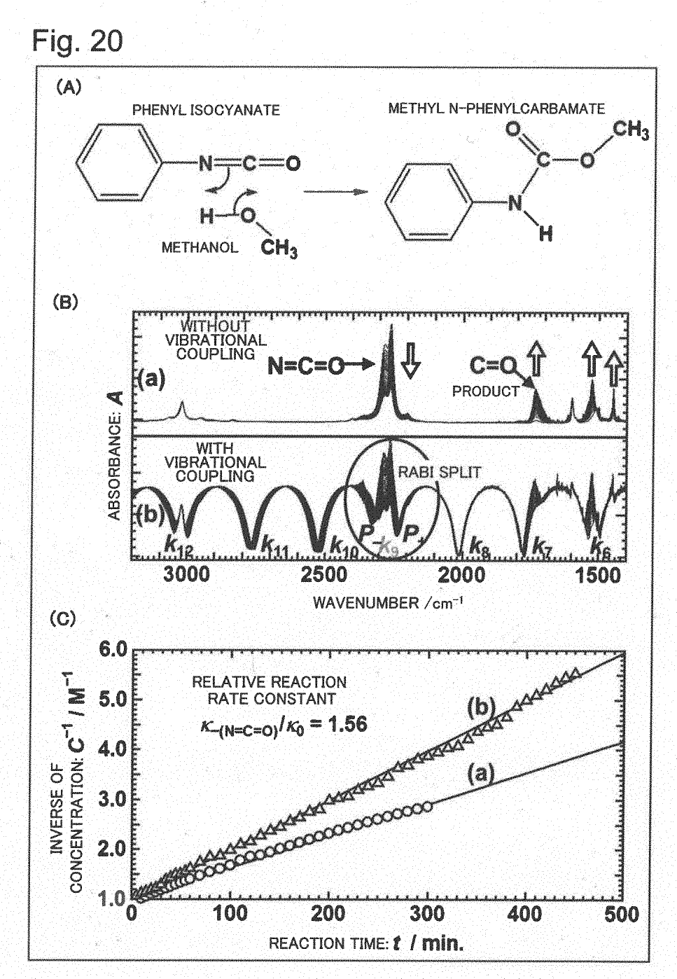

In this example, experimental results proving that methyl N-phenylcarbamate (Ph-NH—CO—O—CH₃) being a target material can be produced with an accelerated reaction rate by using a vibrational coupling to chemical reaction device produced by the means described in Description of Production Method, with respect to a chemical reaction with phenyl isocyanate (PhN═C═O) and methanol (CH₃OH) as raw materials, the chemical reaction being illustrated in (A) in FIG. 20, will be discussed.

Experimental conditions are as follows.

Every experiment was performed at room temperature (T=300 K), and each of phenyl isocyanate and methanol was metered to be a chloroform solution with a concentration of 1.00 M. For the absence of a vibrational coupling, an experiment was performed in a non-resonant condition by use of a chemical reaction device without mirror planes produced by the means described in Description of Production Method. For the presence of a vibrational strong coupling, a chemical reaction device with mirror planes produced by the means described in Description of Production Method was used, and an optical mode was coupled with a vibrational mode by strictly adjusting a cavity length. A vibrational coupling of a C═C═O resonance was examined. Specifically, when the ninth optical mode (k₉=9k₀=2:272 cm⁻¹) of a cavity with a cavity length of t=13.76 μm was resonantly coupled with an N═C═O anti-symmetric stretching vibrational mode (vibrational quantum number 0→1 transition: 2272 cm⁻¹) of phenyl isocyanate, the coupling strength was Ω_{R}/ω₀=0.0452 and the Q factor was Q=33.91. The vibrational coupling belongs to the strong coupling (0.01≤Ω_{R}/ω₀<0.1) expressed by Equation 3. Since activation energy of the reaction in (A) in FIG. 20 is Eₐ₀=0.30±0.10 eV, a relative reaction rate constant is predicted to be in a range of 1.4<κ₋/κ₀<2.0 using Equation 17 or 18.

In order to determine a reaction rate constant, infrared absorption spectra were measured at regular time intervals with an FT-1R instrument. For the absence of a vibrational coupling, a temporal change in concentration was directly determined from a temporal change in absorbance for the N═C═O infrared absorption band of phenyl isocyanate. Meanwhile, for the presence of a vibrational coupling, an absorbance of an infrared absorption band of phenyl isocyanate was extracted by performing waveform separation on the measured infrared spectrum consisting optical and vibrational modes using a suitable spectral function such as the Lorentz function or the inverse Lorentz function, and then the extracted temporal change in absorbance was used for determining a temporal change in concentration. When estimating a reaction rate constant, a bimolecular reaction was assumed, and a reaction profile was analyzed by fitting to the second-order rate equation C⁻¹=κt±C₀⁻¹, where C: concentration, C₀: initial concentration, κ: reaction rate constant, and t: time. A reaction rate constant in the vibrational coupling of the N═C═O resonance is denoted as κ_{-(C═C═O)} and a ratio κ_{-(N═C═O)}/κ₀ to the reaction rate constant κ₀ in the case of without a vibrational coupling was derived as a relative reaction rate.

Experimental results are as follows.

(B) in FIG. 20 illustrates temporal changes of infrared absorption spectra in the chemical reaction illustrated in (A) in FIG. 20, and (a) represents a spectral change without a vibrational coupling and (b) represents a spectral change with a vibrational coupling of the N═C═O resonance. In (a), normal infrared absorption spectra are observed since any optical modes do not exist, whereas in (b), a spectral feature is complicated since absorptions of optical modes (k₆, k₇, k₈, . . . , k₁₂) and vibrational modes (such as the C═C═O vibration and a C═O vibration of a product) are superposed on one another. Taking a closer look, as a reaction progresses in (a), an absorption of the C═C═O vibration (2272 cm⁻¹) of phenyl isocyanate being a raw material decreases, whereas an absorption of the C═O vibration (1734 cm⁻¹) of methyl N-phenylcarbamate being a product increases, as indicated by outlined arrows. As indicated by a circle, it is observed in (b) that the N═C═O vibrational mode is vibrationally coupled with the ninth optical mode at 2272 cm⁻¹ in wavenumber, resulting in Rabi-splitting into an upper branch and a lower branch. Further, although superposition with optical and vibrational modes exists in (b), its increase and decrease in absorption for vibrationally uncoupled modes is similar to that of (a) and its decrease in absorption for a vibrationally coupled mode is also observed.

FIG. 20(C) illustrates relations between the reciprocal of concentrations and reaction time determined from temporal changes in absorbance shown in (B) in FIG. 20, and (a) and (b) represent a reaction profile without a vibrational coupling (plotted with circle marks, ∘) and a reaction profile with the vibrational coupling of the N═C═O resonance (plotted with triangle marks, Δ), respectively. Reaction rate constants are determined from slopes of respective fitting lines in (a) and (b) as follows: κ₀=1.06×10⁻⁴ M⁻¹·s⁻¹ for the absence of a vibrational coupling and κ_{—(N═C═O)}=1.65×10⁻⁴ M⁻¹·s⁻¹ for the presence of the vibrational coupling of the N═C═O resonance. A relative reaction rate constant determined from these values κ_{-(C═C═O)}/κ⁰=1.56 for the vibrational coupling of the C═C═O resonance. As such, chemical reaction promotion by the vibrational coupling of the C═C═O resonance is actually observed, and the relative reaction rate constant is within the range (1.4<κ/κ₀<2.0) as predicted by use of Equation 17 or 18.

It is thus proven from the experimental results described above that the purpose of opto-electrical field confinement is compatible with the purpose of performing a chemical reaction n a chemical reaction device produced by the method described in [Description of Production Method], a vibrational coupling promotes a chemical reaction as predicted by use of Equation 17 or 18, and the chemical reaction device produced by the method described in Description of Production Method can actually produce a target chemical material.

### Example 10

In this example, experimental results proving that (triphenylphosphoranylidene) thioketene (Ph₃P═C═C═S) and carbonyl sulfide (S═C═O) being target materials can be produced with an accelerated reaction rate by using a vibrational coupling chemical reaction device produced by the means described in Description of Production Method, with respect to a chemical reaction with.

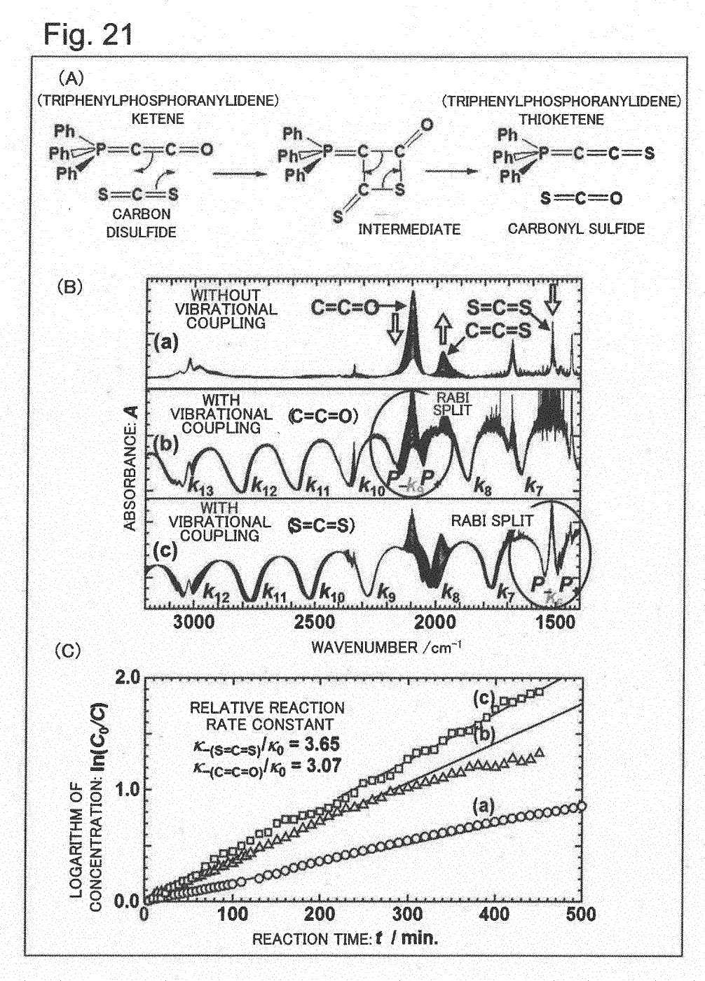

(triphenylphosphoranylidene) ketene (Ph₃P═C═C═ and carbon disulfide (CS₂) as raw materials, the chemical reaction being illustrated in (A) in FIG. 21, will be discussed.

Experimental conditions are as follows.

Every experiment was performed at room temperature (T=300 K), and each of (triphenylphosphoranylidene) ketene and carbon disulfide was metered to be a chloroform solution with a concentration of 1.00 M. For the absence of a vibrational coupling, an experiment was performed in a non-resonant condition by use of a chemical reaction device without mirror planes produced by the means described in Description of Production Method. For the presence of a vibrational strong coupling, a chemical reaction device with mirror planes produced by the means described in Description of Production Method was used, and an optical mode was coupled with a vibrational mode by strictly adjusting a cavity length. Two kinds of vibrational couplings, a C═C═O resonance and an S═C═S resonance, were examined. For the presence of the vibrational coupling of the C═C═O resonance, when the ninth optical mode (k₉=9k₀=2100 cm⁻¹) of a cavity with a cavity length of t=14.85 μm was resonantly coupled with a C═C═O anti-symmetric stretching vibrational mode (vibrational quantum number 0→1 transition: 2100 cm⁻¹) of (triphenylphosphoranylidene) ketene, the coupling strength was Ω_{R}/ω₀=0.0535 and the Q factor was Q 26.92. For the presence of the vibrational coupling of the S═C═S resonance, when the sixth optical mode (k₆=6k₀=1519 cm¹) of a cavity with a cavity length of t=13.72 μm was resonantly coupled with an S═C═S anti-symmetric stretching vibrational mode (vibrational quantum number 0→1 transition: 1519 cm⁻¹) of carbon disulfide, the coupling strength was Ω_{R}/ω₀=0.0359 and the Q factor was Q=29.67. Both vibrational couplings belong to the strong coupling (0.01≤Ω_{R}/ω₀<0.1) expressed by Equation 3. Since activation energy of the reaction in (A) in FIG. 21 is in a range of Eₐ₀=0.8±0.1 eV, a relative reaction rate constant is predicted to be in a range of 3<κ₋/κ₀<4 using Equation 17 or 18.

In order to determine a reaction rate constant, infrared absorption spectra were measured at regular time intervals by use of an FT-1R instrument. For the absence of a vibrational coupling, a temporal change in concentration was directly determined from a temporal change in absorbance for the C═C═O infrared absorption band of (triphenylphosphoranylidene) ketene. Meanwhile, for the presence of a vibrational coupling, an absorbance of an infrared absorption band of (triphenylphosphoranylidene) ketene was extracted by performing waveform separation on the measured infrared spectrum consisting optical and vibrational modes using a suitable spectral function such as the Lorentz function and the inverse Lorentz function, and then the extracted temporal change in absorbance was used for determining a temporal change in concentration. When estimating a reaction rate constant, a unimolecular reaction was assumed, and a reaction profile was analyzed by fitting to the first-order rate equation ln C=−κ1+ In C₀, where C: concentration, C₀: initial concentration, κ: reaction rate constant, and t: time. A reaction rate constant in the vibrational coupling of the C═C═O resonance is denoted as κ_{-(C═C═O)} and a reaction rate constant in the vibrational coupling of the S═C═S resonance is denoted as κ₋₍S═C═s), and respective ratios to a reaction rate constant κ₀ in the case of without a vibrational coupling were derived as relative reaction rates κ_{-(C═C═O)}/κ₀ and κ_{-(S═C═X)}/κ₀.

Experimental result are as follows.

(B) in FIG. 21 illustrates temporal changes of infrared absorption spectra in the chemical reaction illustrated in (A) in FIG. 21, and (a) represents a spectral change without a vibrational coupling, (b) represents a spectral change with a vibrational coupling of the S═C═S resonance, and (c) represents a spectral change with a vibrational coupling of the C═C═O resonance. In (a), normal infrared absorption spectra are observed since any optical modes do not exist, whereas in (b) and (c), spectral features are complicated since absorptions of optical modes (k₆, k₇, k₈, . . . , k₁₃, and the like) and vibrational modes (such as the C═C═O vibration, the S═C═S vibration, and a C═C═S vibration) are superposed on one another. Taking a closer look, as a reaction progresses in (a), absorptions of the C═C═O vibration (2100 cm⁻¹) of (triphenylphosphoranylidene) ketene being a raw material and the S═C═S vibration (1519 cm⁻¹) of carbon disulfide decreases, while an absorption of the C═C═S vibration (1974 cm⁻¹) of (triphenylphosphoranylidene) thioketene being a product increases, as indicated by outlined arrows. As indicated by circles, it is observed in (b) that the C═C═O vibrational mode is vibrationally coupled with the ninth optical mode at 2100 cm⁻¹ in wavenumber, resulting in Rabi-splitting into an upper branch and a lower branch. On the other hand, it is observed in (c) that the S═C═S vibrational mode is vibrationally coupled with the sixth optical mode at 1519 cm⁻¹ in wavenumber, resulting in Rabi-splitting into an upper branch and a lower branch. Further, although superposition with optical and vibrational modes exists in both (b) and (c), their increases and decreases in absorption for vibrationally uncoupled modes are similar to that in (a) and their decreases in absorption for vibrationally coupled modes are also observed.

(C) in FIG. 21 illustrates relations between the reciprocal of concentrations and reaction time determined from temporal changes in absorbance shown in (B) in FIG. 21, and (a), (b), and (c) represent a reaction profile without a vibrational coupling (plotted with circle marks, ∘), a reaction profile with the vibrational coupling of the C═C═O resonance (plotted with triangle marks, Δ), and a reaction profile with the vibrational coupling of the S═C═S resonance (plotted with square marks, □), respectively. Reaction rate constants are determined from slopes of respective fitting lines in (a), (b), and (c) as follows: κ₀=1.92×10⁻⁵ s⁻¹ for the absence of a vibrational coupling, K_{—(C═C═}O)=5.90×10′ su′ for the presence of the vibrational coupling of the C═C═O resonance, and κ_{-(S═C═S)}=7.00×10⁻⁵ s⁻¹ for the presence of the vibrational coupling of the S═C═S resonance. Relative reaction rate constants are determined from these values as follows: κ_{-(S═C═S)}/κ₀=3.65 for the presence of the vibrational coupling of the S═C═S resonance and κ_{-(C═C═O)}/κ₀=3.07 for the Presence of the vibrational coupling of the C═C═O resonance. As such, chemical reaction promotion is actually observed in both cases of the vibrational coupling of the S═C═S resonance and the vibrational coupling of the C═C═O resonance, and both of the relative reaction rate constants are within the range (3<κ₋/κ₀<4) as predicted by use of Equation 17 or 18.

It is thus proven from the experimental results described above that the purpose of opto-electrical field confinement is compatible, with the purpose of performing a chemical reaction in a chemical reaction device produced by the method described in [Description of Production Method], a vibrational coupling promotes a chemical reaction as predicted by use of Equation 17 or 18, and the chemical reaction device produced by the method described in Description of Production Method can actually produce a target chemical material.

### Example 11

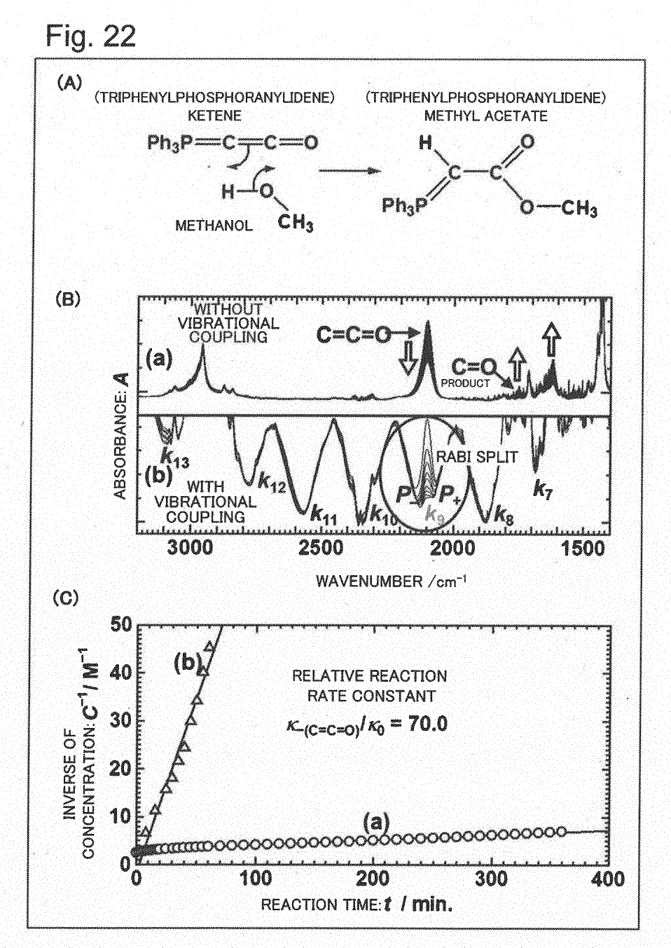

In this example, experimental results proving that (triphenylphosphoranylidene) methyl acetate (Ph₃P═CH—CO—O—CH₃) being a target material can be produced with an accelerated reaction rate by using a vibrational coupling chemical reaction device produced by the means described in Description of Production Method, with respect to a chemical reaction with (triphenylphosphoranylidene) ketene (Ph₃P═C═C═O) and methanol (CH₃OH) as raw materials, the chemical reaction being illustrated in (A) in FIG. 22, will be described.

Experimental conditions are as follows.

Every experiment was performed at room temperature (t=300 K), and each of (triphenylphosphoranylidene) ketene and methanol was metered to be a 1,2-dichloroetharte solution with a concentration of 0.500 M. For the absence of a vibrational coupling, an experiment was performed in a non-resonant condition by use of a chemical reaction device without mirror planes produced by the means described in Description of Production Method. For the presence of a vibrational strong coupling, a chemical reaction device with mirror planes produced by the means described in Description of Production Method was used, and an optical mode was coupled with a vibrational mode by strictly adjusting a cavity length. A vibrational coupling of a C═C═O resonance was examined. Specifically, when the ninth optical mode (k₉=9k₀=2100 cm⁻¹) of a cavity with a cavity length of T=14.95 μm was resonantly coupled with a C═C═O anti-symmetric stretching vibrational mode (vibrational quantum number 0→1 transition: 2100 cm⁻¹) of (triphertylphosphoranylidene) ketene, the coupling strength was Ω_{R}/ω₀=0.0718. The vibrational coupling belong to the strong coupling (0.01≤Ω_{R}/ω₀<0.1) expressed by Equation 3. Since activation energy of the reaction in (A) in FIG. 22 is in a range of Eₐ₀=1.5±0.1 eV, a relative reaction rate constant is predicted to be in a range of 44<κ₋/κ₀<76 using Equation 17 or 18.

In order to determine a reaction rate constant, infrared absorption spectra were measured at regular time intervals by use of an FT-IR instrument. For the absence of a vibrational coupling, a temporal change in concentration was directly determined from a temporal change in absorbance for the C═C═O infrared absorption band of (triphenylphosphoranylidene) ketene. Meanwhile, for the presence of a vibrational coupling, an absorbance of an infrared absorption band of (triphenylphosphoranylidene) ketene was extracted by performing waveform separation on the measured infrared spectrum consisting optical and vibrational modes using a suitable spectral function such as the Lorentz function or the inverse Lorentz function, and then the extracted temporal change in absorbance was used for determining a temporal change in concentration. When estimating a reaction rate constant, a bimolecular reaction was assumed, and a reaction profile was analyzed by fitting to a second-order rate equation C⁻¹=κt^{T} C₀⁻¹ where C: concentration, C₀: initial concentration, κ: reaction rate constant, and t: time. A reaction rate constant in the vibrational coupling of the C═C═O resonance is denoted as κ₋(C═C═O), and a ratio κ_{-(C═C═O}/κ₀ to the reaction rate constant κ₀ in the case of without a vibrational coupling was derived as a relative reaction rate.

Experimental result are as follows.

(B) FIG. 22 illustrates temporal changes of infrared absorption spectra in the chemical reaction illustrated in (A) in FIG. 22, and (a) represents a spectral change without a vibrational coupling and (b) represents a spectral change with a vibrational coupling of the C═C═O resonance. In (a), normal infrared absorption spectra are observed since any optical modes do not exist, whereas in (h), a spectral feature is complicated since absorptions of optical modes (k₇, k₈, . . . , k₁₃) and vibrational modes (such as the C═C═O vibration and a C═O vibration of a product) are superposed on one another. Taking a closer look, as a reaction progresses in (a), an absorption of the C═C═O vibration (2100 cm⁻¹) of (triphenylphosphoranylidene) ketene being a raw material decreases, whereas an absorption of the C═O vibration (near 1750 cm⁻¹) of (triphenylphosphoranylidene) methyl acetate being a product increases, as indicated by outlined arrows. As indicated in a circle, it is observed in (b) that the C═C═O vibration is vibrationally coupled with the ninth optical mode at 2100 cm⁻¹ in wavenumber, resulting in Rabi-splitting into an upper branch and a lower branch. Further, although superposition with optical and vibrational modes exists in (b), its increase and decrease in absorption for vibrationally uncoupled modes is similar to that of (a) and its decrease in absorption for a vibrationally coupled mode is also observed.

(C) in FIG. 22 illustrates relations between the reciprocal of concentrations and reaction time determined from temporal changes in absorbance shown in (B) in FIG. 20. (a) and (b), represent a reaction profile without a vibrational coupling (plotted with circle marks, ∘) and a reaction profile with the vibrational coupling of the C═C═O resonance (plotted with triangle marks, Δ), respectively. Reaction rate constants are determined from slopes of respective fitting lines in (a) and (b) as follows: κ₀=1.74×10⁻⁴ M⁻¹·s⁻¹ for the absence of a vibrational coupling and κ_{-(C═C═O})=1.22×10⁻² M⁻¹·s⁻¹ for the presence of the vibrational coupling of the C═C═O resonance. A relative reaction rate constant determined from these values is κ_{-(C═C═O)}/κ₀=70.0 for the vibrational coupling of the C═C═O resonance. As such, chemical reaction promotion by the vibrational coupling of the C═C═O resonance is actually observed, and the relative reaction rate constant is within the range (44<κ₋/κ₀<76) as predicted by use of Equation 17 or 18.

It is thus proven from the experimental results described above that the purpose of opto-electrical field confinement is compatible with the purpose of performing a chemical reaction in a vibrational coupling chemical reaction device produced by the method described in [Description of Production Method], a vibrational coupling promotes a chemical reaction as predicted by use of Equation 17 or 18, and the vibrational coupling chemical reaction device produced by the method described in [Description of Production Method] can actually produce a target chemical material.

While the preferred example embodiments and exam es of the present invention have been described above, the present invention is not limited thereto. It goes without saying that various modifications may be made within the scope of the invention described in the claims and such modifications are also included in the scope of the present invention.

The example embodiments and the examples described above may also be described in part or in whole as the following supplementary notes but are not limited thereto.

(Supplementary Note 1) A chemical reaction device including an opto-electrical field confinement chemical reaction container structure integrating an opto-electrical field confinement structure forming an optical mode having a frequency identical to or close to a vibrational nmode of a chemical material related to a chemical reaction with a chemical reaction container structure including a space for storing fluid required for the chemical reaction including the chemical material, wherein

a chemical reaction is promoted by vibrationally coupling the optical mode with the vibrational mode.

(Supplementary Note 2) The chemical reaction device according to Supplementary Note 1, wherein

an amount of activation energy of the chemical reaction is reduced by vibrationally coupling the optical mode with the vibrational mode.

(Supplementary Note 3) The chemical reaction device according to Supplementary Note 1 or 2, wherein

the chemical reaction container structure includes an inlet and an outlet of the fluid.

(Supplementary Note 4) The chemical reaction device according to any one of Supplementary Notes 1 to 3, wherein

the chemical reaction device is connected to one or more other chemical reaction devices through the inlet and the outlet.

(Supplementary Note 5) The chemical reaction device according to any

one of Supplementary Notes 1 to 4, wherein the opto-electrical field confinement structure is a Fabry-Pérot cavity including two mirror planes parallel to each other.

(Supplementary Note 6) The chemical reaction device according to Supplementary Note 5, wherein

the Fabry-Pérot cavity is a linear cavity including a structure with a sufficiently long prismatic shape having one or more sets of two mirror planes parallel to each other as sides, or is an accumulation of the linear cavity.

(Supplementary Note 7) The chemical reaction device according to any one of Supplementary Notes 1 to 4, wherein

the opto-electrical field confinement structure is a plasmon-polariton structure.

(Supplementary Note 8) A method for producing a chemical reaction device, the method including:

producing a structure including a mirror plane/substrate by forming a mirror plane on a substrate;

producing a structure including a protective film/mirror plane/substrate by forming a protective film on the mirror plane;

producing a structure including a spacer/protective film/mirror plane/substrate by arranging a spacer defining a cavity length on the protective film;

producing a Fabry-Pérot cavity structure including a substrate/mirror plane/protective film/spacer/protective film/mirror plane/substrate by laying a structure including the protective film/mirror plane; substrate on top of a structure including the spacer/protective film/mirror plane/substrate; and

producing the chemical reaction device according to Supplementary Note 5 or 6 by housing the Fabry-Pérot cavity structure in an enclosure including an inlet, an outlet, and a chamber for storing the Fabry-Pérot cavity structure.

(Supplementary Note 9) A method for producing a chemical reaction device, the method including:

producing an acid-soluble-glass-filled glass tube by filling acid-soluble glass in a glass tube;

producing a thinned acid-soluble-glass-filled glass tube from the acid-soluble-glass-filled glass tube;

producing a thinned acid-soluble-glass-filled glass tube accumulation by aligning one or more of the thinned acid-soluble-glass-filled glass tubes in such a way that tube axes are parallel to one another and fusion-bonding the thinned acid-soluble-glass-filled glass tubes by heating;

producing a re-thinned acid-soluble-glass-filled glass tube accumulation from the thinned acid-soluble-glass-filled glass tube accumulation;

producing a re-thinned glass tube accumulation by dissolving the acid-soluble glass from the re-thinned acid-soluble-glass-filled glass tube accumulation by acid; and

producing an accumulation of the linear cavity according to Supplementary Note 6 by forming a mirror plane inside each re-thinned glass tube constituting the re-thinned glass tube accumulation.

(Supplementary Note 10) The method for producing a chemical reaction device according to Supplementary Note 9, further including

housing an aggregate of the linear cavity in an enclosure including an inlet, an outlet, and a chamber for storing an aggregate of the linear cavity.

(Supplementary Note 11) The method for producing a chemical reaction device according to (Supplementary Note 9 or 10, further including

forming a protective film on the mirror plane after forming the mirror plane inside the each re-thinned glass tube.

(Supplementary Note 12) The method for producing a chemical reaction device according to any one of Supplementary Notes 9 to 11, wherein

the thinned acid-soluble-glass-filled glass tube is produced by drawing the acid-soluble-glass-filled glass tube in a tube-axis direction by heating.

(Supplementary Note 13) The method for producing a chemical reaction device according to any one of Supplementary Notes 9 to 12, wherein

the re-thinned acid-soluble-glass-filled glass tube accumulation is produced by drawing the thinned acid-soluble-glass-filled glass tube accumulation in a tube-axis direction by heating.

### INDUSTRIAL APPLICABILITY

The present invention is applicable to various industrial fields using a chemical reaction, such as chemistry, medical treatment/medicine, iron manufacturing/metallurgy, electronics, automobiles, shipbuilding, transportation, aerospace, and social infrastructure industries. It is expected that the present invention will be utilized in environment-conscious industries such as production of energy storage materials, typified by hydrogen, ammonia, and methanol, for substituting fossil fuel, a catalyst substituting rare metals typified by platinum and rhodium for NOₓ elimination, a processing system decomposing hazardous chemical materials typified by industrial effluents and sooty smoke, and production of ecological materials synthesized from common chemical products and biologically-derived raw materials. Furthermore, it is also expected that the present invention will be used in industrial fields related to social contribution since the present invention is applicable to a purification system performing bactericidal/detoxifying actions and artificial organs typified by an artificial kidney and an artificial liver, by activating a vibrational mode of a biological material constituting a bacterium and a virus and a vibrational mode of a human metabolite, and is also applicable to low-cost production of new antibiotics, generic drugs, or the like, and safe and secure provision of heat sources such as a non-flame-type heat source and a thermoelectric generator unit.

### REFERENCE SIGNS LIST

1 Mirror plane
2 Dielectric
3 Incident light
4 Reflected light
5 Resonant light
6 Transmitted light
7 Fabry-Pérot cavity
8 Free spectral range
9 First optical mode
10 Second optical mode
11 Third optical mode
12 Fourth optical mode
13 Opto-electrical field amplitude
14 Opto-electrical field strength
15 First optical mode
16 Second optical mode
17 Third optical mode
20 Parallelogrammatical linear cavity
<Parallelo-hexagonal linear cavity
22 Parallelo-octagonal linear cavity
23 Elliptical linear cavity
24 Linear cavity enclosure
25 Mirror plane
26 Optical mode
27 Raw material inlet of single linear cavity
28 Product outlet of single linear cavity
29 Single linear cavity
30 Raw material inlet of linear cavity accumulation
31 Product outlet of linear cavity accumulation
32 Linear cavity accumulation
33 Raw material inlet of vibrational coupling chemical reaction device module
34 Chamber in linear cavity accumulation
35 Product outlet of vibrational coupling chemical reaction device module
36 Vibrational coupling chemical reaction device module
40 Single regular-hexagonal linear cavity
41. Optical mode
42 Regular-hexagonal linear cavity accumulation
43 Single isosceles-parallelo-hexagonal linear cavity
44 Optical mode
45 Isosceles-parallelo-hexagonal linear cavity accumulation
46 Single inequilateral-parallelo-hexagonal linear cavity
47 Optical mode
48 Inequilateral-parallelo-hexagonal linear cavity accumulation.
50 Raw material container a
51 Raw material container 13
52 Channel
53 Vibrational coupling chemical reaction device module
54 Product container
55 Basic-type vibrational coupling chemical reaction device unit
56 Valve
57 Reactant container
58 Circulation-type vibrational coupling chemical reaction
device unit
59 Serial-type vibrational coupling chemical reaction device unit
60 Parallel-type vibrational coupling chemical reaction device unit
61 Raw material container c
62 Raw material container d
63 Raw material container e
64 Vibrational coupling chemical reaction device module I
65 Vibrational coupling chemical reaction device module II
66 Vibrational coupling chemical reaction device module III
67 Vibrational coupling chemical reaction device module IV
68 Sequential-type vibrational coupling chemical reaction device unit
69 Vibrational coupling chemical reaction device system
70 Substrate
71 Mirror plane
72 Protective film
73 Spacer
74 Channel
75 Chemical material storage
76 Fabry-Pérot-cavity-type vibrational coupling chemical reaction device
80 Glass tube
81 Acid-soluble glass
82 Acid-soluble-glass-filled glass tube
83 Thinned acid-soluble-glass-filled glass tube
84 Thinned acid-soluble-glass-filled glass tube accumulation
85 Re-thinned acid-soluble-glass-filled glass tube accumulation
86 Re-thinned glass tube accumulation
87 Mirror plane
88 Linear cavity accumulation

1. A chemical reaction device comprising an opto-electrical field confinement chemical reaction container structure integrating an opto-electrical field confinement structure forming an optical mode having a frequency identical to or close to a vibrational mode of a chemical material related to a chemical reaction with a chemical reaction container structure including a space for storing fluid required for the chemical reaction including the chemical material, wherein
a chemical reaction is promoted by vibrationally coupling the optical mode with the vibrational mode.

2. The chemical reaction device according to claim 1, wherein
an amount of activation energy of the chemical reaction is reduced by vibrationally coupling the optical mode with the vibrational mode.

3. The chemical reaction device according to claim 1, wherein
the chemical reaction container structure includes an inlet and an outlet of the fluid.

4. The chemical reaction device according to claim 1, wherein
the chemical reaction device is connected to one or more other chemical reaction devices through the inlet and the outlet.

5. The chemical reaction device according to claim 1, wherein
the opto-electrical field confinement structure is a Fabry-Pérot cavity including two mirror planes parallel to each other.

6. The chemical reaction device according to claim 5, wherein
the Fabry-Pérot cavity is a linear cavity including a structure with a sufficiently long prismatic shape having one or more sets of two mirror planes parallel to each other as sides, or is an accumulation of the linear cavity.

7. The chemical reaction device according to claim 1, wherein
the opto-electrical field confinement structure is a plasmon-polariton structure.

8. A method for producing a chemical reaction device, the method comprising:
producing a structure including a mirror plane/substrate by forming a mirror plane on a substrate;
producing a structure including a protective film/mirror plane/substrate by forming a protective film on the mirror plane;
producing a structure including a spacer/protective film/mirror plane/substrate by arranging a spacer defining a cavity length on the protective film;
producing a Fabry-Pérot cavity structure including a substrate/mirror plane/protective film/spacer/protective film/mirror plane/substrate by laying a structure including the protective film/mirror plane/substrate on top of a structure including the spacer/protective film/mirror plane/substrate; and
producing the chemical reaction device according to claim 5 by housing the Fabry Pérot cavity structure in an enclosure including an inlet, an outlet, and a chamber for storing the Fabry-Pérot cavity structure.

9. A method for producing a chemical reaction device, the method comprising:
producing an acid-soluble-glass-filled glass tube by filling acid-soluble glass in a glass tube;
producing a thinned acid-soluble-glass-filled glass tube from the acid-soluble-glass-filled glass tube;
producing a thinned acid-soluble-glass-filled glass tube accumulation by aligning one or more of the thinned acid-soluble-glass-filled glass tubes in such a way that tube axes are parallel to one another and fusion-bonding the thinned acid-soluble-glass-filled glass tubes by heating;
producing a re-thinned acid-soluble-glass-filled glass tube accumulation from the thinned acid-soluble-glass-filled glass tube accumulation;
producing a re-thinned glass tube accumulation by dissolving the acid-soluble glass from the re-thinned acid-soluble-glass-filled glass tube accumulation by acid; and
producing an accumulation of the linear cavity according to claim 6 by forming a mirror plane inside each re-thinned glass tube constituting the re-thinned glass tube accumulation.

10. The method for producing a chemical reaction device according to claim 9, further comprising
housing an aggregate of the linear cavity in an enclosure including an inlet, an outlet, and a chamber for storing an aggregate of the linear cavity.

11. The method for producing a chemical reaction device according to claim 9, further comprising
forming a protective film on the mirror plane after forming the mirror plane inside the each re-thinned glass tube.

12. The method for producing a chemical reaction device according to claim 9, wherein
the thinned acid-soluble-glass-filled glass tube is produced by drawing the acid-soluble-glass-filled glass tube in a tube-axis direction by heating.

13. The method for producing a chemical reaction device according to claim 9, wherein
the re-thinned acid-soluble-glass-filled glass tube accumulation is produced by drawing the thinned acid-soluble-glass-filled glass tube accumulation in a tube-axis direction by heating.
